(19) United States
(12) Patent Application Publication
(10) Pub. No.: US 2016/0326322 A1
(43) Pub. Date: Nov. 10, 2016

(54) HYRDOGENATED NITRILE RUBBER CONTAINING PHOSPHINE OXIDE OR DIPHOSPHINE OXIDE

(71) Applicant: ARLANXEO DEUTSCHLAND GMBH, Dormagen (DE)

(72) Inventor: WERNER OBRECHT, MOERS (DE)

(21) Appl. No.: 15/109,233

(22) PCT Filed: Dec. 29, 2014
(86) PCT No.: PCT/EP2014/079369

§ 371 Date: Jun. 30, 2016

(30) Foreign Application Priority Data
Dec. 30, 2013 (EP) 13199843.7

(51) Int. Cl. C08J 3/24; C08C 19/02; C08F 236/12

(52) U.S. Cl. CPC C08J 3/24; C08F 236/12; C08C 19/02

(57) ABSTRACT

Novel hydrogenated nitrile rubbers are provided, which include phosphine oxides and/or diphosphine oxides and a specific content of halogens, and which enable access to vulcanizable mixtures and corresponding vulcanizates that possess improved moduli and compression set values. These novel hydrogen nitrile rubbers are obtained by a production process, in which the hydrogenated nitrile rubbers are reacted with at least one specific sulphur compound.

The invention relates to hydrogenated nitrile rubbers which have either zero contents or a reduced contents of phosphines or diphosphines and additionally contain phosphine oxide or diphosphine oxide and have a specific halogen content, to a process for production thereof, to vulcanizable mixtures based on the hydrogenated nitrile rubbers, and to vulcanizates obtained in that way.

Nitrile rubbers are co- and terpolymers of at least one unsaturated nitrile monomer, at least one conjugated diene and optionally one or more copolymerizable monomers. Processes for producing nitrile rubber and processes for hydrogenating nitrile rubber in suitable organic solvents are known from the literature (e.g. Ullmann's Encyclopedia of Industrial Chemistry, VCH Verlagsgesellschaft, Weinheim, 1993, p. 255-261 and p. 320-324).

Hydrogenated nitrile rubber, abbreviated to “HNBR”, is understood to mean rubbers which are obtained from nitrile rubbers, abbreviated to “NBR”, by hydrogenation. Correspondingly, in HNBR, the C═C double bonds of the copolymerized diene units are fully or partly hydrogenated. The hydrogenation level of the copolymerized diene units is typically within a range from 50 to 100%. Those skilled in the art refer to “fully hydrogenated types” even when the residual double bond content (“RDB”) is not more than about 0.9%. The HNBR types commercially available on the market typically have a Mooney viscosity (ML 1+4 at 100° C.) in the range from 10 to 120 Mooney units.

Hydrogenated nitrile rubber is a specialty rubber having a very good heat resistance, excellent resistance to ozone and chemicals and excellent oil resistance. The aforementioned physical and chemical properties of HNBR are combined with very good mechanical properties, especially a high abrasion resistance.

Because of this profile of properties, HNBR has found wide use in a wide variety of different areas of application. HNBR is used, for example, for seals, hoses, drive belts, cable sheaths, roller coverings and damping elements in the automotive sector, and also for stators, well seals and valve seals in the oil production sector, and for numerous parts in the aviation industry, the electrical industry, in mechanical engineering and in shipbuilding.

A major role is played by vulcanizates of hydrogenated nitrile rubber having a high modulus level (measured as the stress value at various elongations) and low compression set, especially after long storage periods at high temperatures. This combination of properties is important in fields of use in which high resilience forces are required to ensure that the rubber articles will function both under static and under dynamic stress, including after long periods and possibly high temperatures. This applies especially to different seals such as O-rings, flange seals, shaft sealing rings, stators in rotor/stator pumps, valve shaft seals, gasket sleeves such as axle boots, hose seals, engine bearings, bridge bearings and well seals (blowout preventers). In addition, vulcanizates having a high modulus are important, for example, for articles under dynamic stress, especially for belts such as drive belts and control belts, for example toothed belts, and also for roller coverings.

The level obtained to date in the mechanical properties of HNBR-based vulcanizates, especially in relation to the modulus level and compression set, is still unsatisfactory.

For the hydrogenation of nitrile rubber with homogeneously soluble rhodium and/or ruthenium hydrogenation catalysts, the addition of phosphines or diphosphines as a cocatalyst has been found to be useful. Preference is given to the use of triphenylphosphine (“TPP”). This use of a cocatalyst has a number of positive effects: a reduction in the pressure needed for the hydrogenation is enabled; in addition, an increase in the hydrogenation rate (space/time yield) and a reduction in the amount of hydrogenation catalyst needed for the hydrogenation can be achieved. On the other hand, residual amounts of the phosphine or diphosphine remaining in the hydrogenated nitrile rubber have adverse effects on the vulcanizate properties, especially the modulus level and compression set.

DE 25 39 132 A describes a process for hydrogenating random acrylonitrile/butadiene copolymers. For the hydrogenation, the complex of a mono- or trivalent rhodium(I) halide is used in combination with 5 to 25% by weight of triphenylphosphine, with use of 10 phr of triphenylphosphine in each of the examples. DE 25 39 132 A does not vary the amount of triphenylphosphine. Nor are any vulcanizates produced on the basis of the hydrogenated nitrile rubbers or characterized with respect to the properties. DE 25 39 132 A does not give any figures for the contents of triphenylphosphine that remain in the worked-up hydrogenated nitrile rubber after the hydrogenation. Nor is there any examination, moreover, of whether and, if so, what influence TPP has on the properties, especially the modulus level and compression set of vulcanizates produced therefrom. Furthermore, there is no indication whatsoever as to the removal of the TPP used in the hydrogenation.

In U.S. Pat. No. 4,965,323, the compression set of HNBR-based vulcanizates which are obtained by peroxidic vulcanization or by sulphur vulcanization is improved by contacting the nitrile rubber after the polymerization or after the hydrogenation with an aqueous alkali solution or the aqueous solution of an amine. In example 1, rubber crumbs that are obtained after removal of the solvent are washed in a separate process step with aqueous sodium carbonate solutions of different concentration. The pH of an aqueous THF solution obtained by dissolving 3 g of the rubber in 100 ml of THF and adding 1 ml of water while stirring is used as a measure of the alkali content. The pH is determined by means of a glass electrode at 20° C. For the production of vulcanizates of the hydrogenated nitrile rubber having low compression set, the pH of aqueous THF solution should be >5, preferably >5.5, more preferably >6. In U.S. Pat. No. 4,965,323, there is no pointer to the dependence of compression set on the amount of TPP used in the hydrogenation, or to improvement of the compression set by removal of TPP after the hydrogenation.

U.S. Pat. No. 4,503,196 describes a process for hydrogenating nitrile rubber using rhodium catalysts of the (H)Rh(L)₃ or (H)Rh(L)₄ type. L represents phosphine or arsine ligands. It is a feature of the hydrogenation process that no additions of the ligands as cocatalysts are required for the hydrogenation, although the hydrogenation is effected at relatively high amounts of catalyst (2.5 to 40% by weight). For the isolation of the hydrogenated nitrile rubber from the chlorobenzene solution, the hydrogenated solution is cooled and the rubber is coagulated by addition of isopropanol. U.S. Pat. No. 4,503,196 does not give any information about the vulcanizate properties of the hydrogenated nitrile rubbers that result in this process. For this reason, U.S. Pat. No. 4,503,196 does not give any teaching about the production of hydrogenated nitrile rubber, by which vulcanizates having a high modulus level and low compression set are obtained.

DE-A-3 921 264 describes the production of hydrogenated nitrile rubber which, after peroxidic crosslinking, gives vulcanizates having low compression set. For this purpose, ruthenium catalysts of a wide variety of different chemical constitutions are used for the hydrogenation, with use of a solvent mixture of a C₃-C₆ ketone and a secondary or tertiary C₃-C₆ alcohol in the hydrogenation. The proportion of the secondary or tertiary alcohol in the solvent mixture is said to be 2 to 60% by weight. According to DE-A-3 921 264, two phases can be formed during the hydrogenation or in the course of cooling of the hydrogenated solution. As a consequence, the desired hydrogenation levels are not attained and/or the hydrogenated nitrile rubber gelates during the hydrogenation. The process described in DE-A-3 921 264 is not broadly applicable, since the phase separation which takes place in the course of the hydrogenation and the gelation depends on various parameters in an unpredictable manner. These include the acrylonitrile content and the molar mass of the nitrile rubber feedstock, the composition of the solvent mixture, the solids content of the polymer solution in the hydrogenation, the hydrogenation level and the temperature in the hydrogenation. In the course of cooling of the polymer solution after the hydrogenation or in the course of storage of the polymer solution too, there may be unexpected phase separation and contamination of the corresponding plant components or vessels.

WO-A-2004/101671 shows that hydrogenated carboxylated nitrile/butadiene rubber containing TPP in molecular dispersion can be used advantageously as a crosslinker for elastomers or plastics and as adhesives. On the basis of WO-A-2004/101671, in which the necessity of the presence of TPP is explicitly pointed out, no teaching as to the improvement of compression set and moduli of vulcanizates can be inferred.

EP-A-1 894 946 describes a process for metathesis degradation of NBR, in which the activity of the metathesis catalyst is enhanced by TPP additions. Based on the metathesis catalyst, 0.01 to 1 equivalent of phosphine, for example TPP, is used. Nitrile rubbers of reduced molecular weight prepared in this way can, according to EP-A-1 894 946, be hydrogenated using methods known from the prior art. The catalyst used here may, for example, be the Wilkinson catalyst in the presence of cocatalysts such as TPP. There is no information about the vulcanizate properties and the optimization thereof, especially with regard to the level of modulus and compression set of the hydrogenated nitrile rubbers obtained in the hydrogenation.

Nor does EP-A-1 083 197 describe any measures for reducing the compression set for vulcanizates which are used for production of roller coverings. The aim is achieved by using the methacrylates of polyhydric alcohols, e.g. trimethylolpropane trimethacrylate, in the production of the rubber mixtures. EP-A-1 083 197 does not give any pointer to improvement of the compression set or moduli by eliminating the harmful influence caused by triphenylphosphine.

EP-A-1 524 277 describes an ultrafiltration process for removing low molecular weight constituents from rubbers. For this purpose, the rubbers are dissolved in an organic solvent and subjected to an ultrafiltration process. The process is suitable both for removal of emulsifser residues from nitrile rubber and for removal of catalyst residues from hydrogenated nitrile rubber. According to Example 2 of EP-A-1 524 277 (Bayer), it is possible with the aid of this method to reduce the phosphorus content of hydrogenated nitrile rubber from 1300 mg/kg to 120 mg/kg, EP-A-1 524 277 does not give any information as to whether this process, which is additionally costly in economic terms, enables an improvement in the modulus level and compression set of vulcanizates of hydrogenated nitrile rubbers.

EP-A-0 134 023 describes a process for hydrogenating NBR with 0.05 to 0.6% by weight, based on rubber solids, of tris(triphenylphosphine)rhodium(I) halide as catalyst, in which not more than 2% by weight, likewise based on rubber solids, of triphenylphosphine is added. The examples in Table 3) show that an increase in the amount of triphenylphosphine to up to 5% by weight leads to a deterioration in important properties of peroxidically vulcanized hydrogenated nitrile rubbers. For instance, there is a decrease in the modulus values at 100%, 200% and 300% elongation, and in the hardness at 23° C. There is an increase in the elongation at break and compression set values after storage at 23° C. for 70 h, at 125° C. for 70 h and at 150° C. for 70 h. In order to limit the harmful influence of TPP, according to the teaching of EP-A-134 023, the amount of TPP used in the hydrogenation is restricted. Disadvantageously, it is then necessary in this hydrogenation, for the purpose of achieving equal hydrogenation times, to use higher amounts of catalyst and hence of costly rhodium metal. EP-A-0 134 023 does not give any teaching as to the removal of the TPP after the hydrogenation.

In U.S. Pat. No. 5,244,965, nitrile rubber is hydrogenated using tetrakis(triphenylphosphine)hydridorhodium in the presence of considerable molar excesses of TPP. Because of suspected adverse effects of triphenylphosphine on the properties of the vulcanized rubber (page 1 lines 26-28: “Furthermore, there is some indication that phosphines cause problems with polymer vulcanization”), TPP is removed after the hydrogenation of the rubber solution. For this purpose, TPP is converted to the corresponding phosphonium salts with addition of equimolar amounts of organic halogen compounds suitable for formation of triphenylphosphonium salts, especially methyl bromide, ethyl bromide, benzyl chloride or benzyl bromide, at temperatures of 70° C.-120° C. within a period of 4-8 h. In the course of cooling of the polymer solution down to 20° C. to 40° C., the phosphonium salts precipitate out and are subsequently separated mechanically from the polymer solution by filtration or by sedimentation. It is shown that triphenylphosphine oxide is present both in the hydrogenated nitrile rubber produced in accordance with the invention and in the corresponding comparative experiment, which has been produced without additions of organic halides. The process described in U.S. Pat. No. 5,244,965 is disadvantageous from an economic point of view, since long tank occupation times are required for the conversion of the TPP to the triphenylphosphonium salt. Moreover, the separation of the phosphonium salt from the high-viscosity polymer solution by sedimentation or filtration is complex in terms of process technology. Secondly, it is not advantageous that the mixture has to be cooled and also diluted in order to separate out the triphenylphosphonium salt formed. Triphenylphosphonium halide additionally crystallizes in an irreproducible manner. It is often obtained in very finely divided form, which complicates the removal from the solution and causes an incomplete removal from the polymer solution, such that relatively large residual amounts of the triphenylphosphonium halides inevitably remain in the hydrogenated nitrile rubber. This becomes clear in Example 2, Experiments 1) and 2) (Table 1) of U.S. Pat. No. 5,344,965. According to Example 2, for each of Experiments 1) and 2), 5.5 g (20.87 mmol) of TPP are used per 100 g of rubber; the further addition of TPP likewise described in Example 2 is incomprehensible in quantitative terms and cannot be taken into account its a quantitative assessment. According to Example 2, Experiment 1), 20.87 mmol of triphenylphosphine are reacted with 4 ml of methyl bromide. Given a density of 3.97 g/cm³, this corresponds to 15.88 g or 167.3 mmol of methyl bromide (molar mass of methyl bromide: 94.94 g/mol); in other words, in Experiment 1, a good 8-fold molar excess of methyl bromide based on TPP is used. Given quantitative conversion of TPP to triphenylmethylphosphonium bromide (molar mass: 356.8 g/mol), the result is a theoretical yield of 7.5 g of triphenylmethylphosphoninm bromide. Since, according to Experiment 1), only 3.2 g of triphenylmethylphosphonium bromide are isolated, this corresponds to a yield of 43%. Taking account of the further TPP addition, which reacts with the excess of methyl bromide, the overall yield of isolated triphenylphosphonium bromide according to Example 2, Experiment 1) is well below 40%. According to Example 2, Experiment 2, based on 5.5 g (20.87 mmol) of TPP, 3 ml of ethyl bromide (density: 1.46 g/cm³), corresponding to 4.38 g (40.2 mmol), are used. Likewise without taking account of an unquantifiable further TPP addition, 7.8 g of triphenylethylphosphonium bromide (molar mass: 371.3 g/mol) are theoretically obtained from 5.5 g of TPP. The yield of 3.7 g described in Example 2, Experiment 2) thus corresponds at most to 47.4% of the theoretical yield. Because of the poor separation efficiency of the triphenylphosphonium bromide in the two experiments in Example 2), in the method for removing TPP described in U.S. Pat. No. 5,244,965, considerable amounts of triphenylphosphonium halides remain in the hydrogenated nitrile rubber, which lead to a deterioration in the vulcanizate properties, especially the corrosivity of seals produced therefrom. In U.S. Pat. No. 5,244,965, no positive influence of the TPP removal on the vulcanizate properties is detected.

In U.S. Pat. No. 5,244,965, Example 3, Table 2, figures are also given for contents of triphenylphosphine and triphenylphosphine oxide (“TPP═O”) in the hydrogenated nitrile rubber, which are summarized in the following table:

| | TPP used in | | TPP in the | TPP = O in the |
|---|---|---|---|---|
| | hydrogenation | | HNBR isolated | HNBR isolated |
| Experiment | [% by wt.] | Reagent | [% by wt.] | [% by wt.] |
| 3-1 | 5.5 | C₂H₅Br | 0.75 | 1.41 |
| 3-2 | 5.5 | benzyl | undetectable | 0.94 |
| | | bromide | | |
| 3-3 | 5.5 | — | 1.33 | 2.17 |

In U.S. Pat. No. 5,244,965, it remains unclear whether the removal or removability of the triphenylphosphonium salts is connected to the formation of triphenylphosphine oxide, how triphenylphosphine oxide is formed and whether this can be influenced. Furthermore, it remains unclear what influence TPP, triphenylphosphine oxide, phosphonium halides and residual amounts of the organic halides used for the removal have on the vulcanizate properties of hydrogenated nitrile rubbers. Overall, it is not possible to infer from the teaching of U.S. Pat. No. 5,244,965 how vulcanizates of the hydrogenated nitrile rubber having high modulus values and having a low compression set are to be produced.

In spite of extensive literature relating to production of hydrogenated nitrile rubbers, there are no hydrogenated nitrile rubbers available to date that firstly give vulcanizates having a good modulus level and good compression set values and can nevertheless at the same time be produced via hydrogenation processes having short reaction times using phosphine- or diphosphine-based cocatalysts with small amounts of catalyst. There are no known nitrile rubbers to date in which the adverse effects of the phosphine or diphosphine cocatalysts used in the hydrogenation on the respective vulcanizate properties, especially on the modulus level and compression set values after storage at high temperatures, can be avoided.

### The Problem Addressed by the Present Invention

The problem by the present invention was thus that of providing hydrogenated nitrile rubbers which give rise to vulcanizates having very good moduli and good compression set values, the latter especially after storage at high temperatures. The problem addressed by the present invention was additionally that of providing hydrogenated nitrile rubbers which simultaneously feature low halogen contents. The problem addressed by the present invention was also that of providing an economic process for production of such hydrogenated nitrile rubbers, in which the phosphine or diphosphine present as a cocatalyst in the hydrogenation is rendered harmless in a suitable manner after the hydrogenation, without having to remove any great amounts of halides or entrapment thereof into the hydrogenated nitrile rubber.

### Solution

It has been found that, surprisingly, the improved properties of vulcanizates based on hydrogenated nitrile rubbers in the form of very good modulus values and improved compression set values, especially after storage at relatively high temperature, can be achieved when the hydrogenated nitrile rubber has a zero or reduced phosphine or diphosphine content, a particular phosphine oxide or diphosphine oxide content and a very low total halogen content. These hydrogenated nitrile rubbers can be obtained in an economic manner by admixing the phosphine or diphosphine used in the hydrogenation with particular sulphur compounds after the hydrogenation. Unexpectedly, phosphine oxides or diphosphine oxides are formed rather than phosphine sulphides or diphosphine sulphides. It is additionally surprising that the phosphine oxide content does not have any adverse effect on the vulcanizate properties, but actually gives vulcanizates having very good modulus and compression set values.

The present invention provides hydrogenated nitrile rubbers containing
i) a content of phosphines, diphosphines or mixtures thereof, preferably triphenylphosphine, within the range from 0 to 1.0% by weight, preferably from 0 to 0.9% by weight, more preferably from 0 to 0.85% by weight, based on the hydrogenated nitrile rubber,
ii) a content of phosphine oxides, diphosphine oxides or mixtures thereof, preferably triphenylphosphine oxide, in the range from 0.25 to 6% by weight, preferably from 0.3 to 5% by weight, more preferably from 0.35 to 4% by weight, based on the hydrogenated nitrile rubber, and
iii) a total halogen content in the range from 25 to 10 000 ppm, preferably from 30 to 8000 ppm, more preferably 35 to 1000 ppm, very preferably front 38 to 900 ppm, especially preferably from 40 to 850 ppm.

The present invention further provides vulcanizable mixtures of these hydrogenated nitrile rubbers and processes for producing vulcanizates based thereon, and also the vulcanizates obtainable therewith, especially in the form of shaped bodies.

The present invention further provides a process for producing the inventive hydrogenated nitrile rubbers having
i) a content of phosphines, diphosphates or mixtures thereof, preferably triphenylphosphine, within the range from 0 to 1.0% by weight, preferably from 0 to 0.9% by weight, more preferably from 0 to 0.85% by weight, based on the hydrogenated nitrile rubber,
ii) a content of phosphine oxides, diphosphine oxides or mixtures thereof, preferably triphenylphosphine oxide, in the range from 0.25 to 6% by weight, preferably from 0.3 to 5% by weight, more preferably from 0.35 to 4% by weight, based on the hydrogenated nitrile rubber, and
iii) a total halogen content in the range from 25 to 10 000 ppm, preferably from 30 to 8000 ppm, more preferably 35 to 1000 ppm, very preferably from 38 to 900 ppm, especially preferably from 40 to 850 ppm.
   by reacting a hydrogenated nitrile rubber having a content of phosphines, diphosphines or mixtures thereof within a range of 0.25-5% by weight, preferably within the range of 0.3-4.5% by weight, more preferably within the range of 0.4-4.25% by weight and especially within the range of 0.5-4% by weight, based on the hydrogenated nitrile rubber, with at least one sulphur compound which does not have two sulphur atoms bonded directly to one another.

Where the term “substituted” is used in the context of this application, this means that a hydrogen atom on a given radical or atom is replaced by one of the groups specified in each case, with the proviso that the valency of the given atom is not exceeded and the substitution leads to a stable compound.

Because of the multitude of chemical formulae used, radicals given the same name or abbreviation are present in various formulae, but have, for the respective formula, only the general, preferred, more preferred or especially preferred meanings mentioned in each case in connection with this formula. If exceptions from the aforementioned principal are to apply, this is mentioned explicitly. Apart from this topic of radicals given the same abbreviation in different formulae, it is possible within the context of this application and invention to combine all the definitions given, in general terms or given within areas of preference, for parameters, definitions or elucidations with one another in any desired manner, i.e. including between the respective areas and areas of preference, and they are considered to be disclosed within this scope.

### Inventive Hydrogenated Nitrile Rubber

The inventive hydrogenated nitrile rubber has
i) a content of phosphines, diphosphines or mixtures thereof, preferably triphenylphosphine, within the range from 0 and to 1.0% by weight, preferably from 0 to 0.9% by weight, more preferably from 0 to 0.85% by weight, based on the hydrogenated nitrile rubber,
ii) a content of phosphine oxides, diphosphine oxides or mixtures thereof, preferably triphenylphosphine oxide, in the range from 0.25 to 6% by weight, preferably from 0.3 to 5% by weight, more preferably from 0.35 to 4% by weight, based on the hydrogenated nitrile rubber, and
iii) a total halogen content in the range from 25 to 10 000 ppm, preferably from 30 to 8000, more preferably 35 to 1000 ppm, very preferably from 38 to 900 ppm, especially preferably from 40 to 850 ppm.

The inventive hydrogenated nitrile rubber typically has a high hydrogenation degree, customarily in the range from 80 to 100%, preferably from 90 to 100%, more preferably from 92 to 100%, even more preferably from 94 to 100%. Alternatively preferred the inventive hydrogenated nitrile rubber is fully hydrogenated and has a hydrogenation degree of greater than or equal to 99.1%.

The content of the phosphine/diphosphine component (i) as well as of the phosphine oxide/diphosphine oxide component (ii) is determined by means of gas chromatography in accordance with the method described in the example section with regard to the determination of the content of triphenylphosphane (“TPP”) and triphenylphosphane oxide (“TPPO”). The total halogen content is determined according to DIN 51408, Teil 2.

The phosphine component (i) typically has the general formula (1-a)

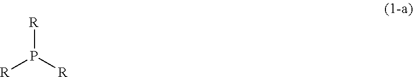

where
R′ are the same or different and are each alkyl, alkenyl, alkadienyl, alkoxy, aryl, heteroaryl, cycloalkyl, cycloalkenyl, cycloalkadienyl, halogen or trimethylsilyl,
   and the diphosphine component (i) typically has the general formula (1-b)

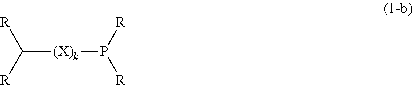

in which
R′ are the same or different and have the same definitions as in the general formula (1-a),
k is 0 or 1 and
X is a straight-chain or branched alkanediyl, alkenediyl or alkynediyl group.

The R′ radicals in both of these formulae (1-a) and (1-b) may be substituted or mono- or polysubstituted.

Such phosphines or diphosphates of the general formulae (1-a) and (1-b) are preparable by methods known to those skilled in the art or else are commercially available.

Alkyl radicals in the R′ radicals of the phosphines or diphosphines of the general formulae (1-a) and (1-b) are typically understood to mean straight-chain or branched C₁-C₃₀-alkyl radicals, preferably C₁-C₂₄-alkyl radicals, more preferably C₁-C₁₈-alkyl radicals. C₁-C₁₈-Alkyl comprises, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, o-octyl, n-nonyl, n-decyl, n-undecyl, n-dodecyl, n-tridecyl, n-tetradecyl, n-hexadecyl and n-octadecyl.

Alkenyl radicals in the R′ radicals of the phosphines or diphosphines of the general formulae (1-a) and (1-b) are typically understood to mean C₃-C₃₀-alkenyl radicals, preferably C₂-C₂₀alkenyl radicals. More preferably, an alkenyl radical is a vinyl radical or an allyl radical.

Alkadienyl radicals in the R radicals of the phosphines or diphosphines of the general formulae (1-a) and (1-b) are typically understood to mean C₄-C₃₀-alkadienyl radicals, preferably C₄-C₂₀-alkadienyl radicals. More preferably, an alkadienyl radical is butadienyl or pentadienyl.

Alkoxy radicals in the R′ radicals of the phosphines or diphosphines of the general formulae (1-a) and (1-b) are typically understood to mean C₁-C₂₀-alkoxy radicals, preferably C₁-C₁₀-alkoxy radicals, more preferably methoxy, ethoxy, n-propoxy, isopropoxy, n-butoxy, sec-butoxy, tert-butoxy, n-pentoxy and n-hexoxy.

Aryl radicals in the R′ radicals of the phosphines or diphosphines of the general formulae (1-a) and (1-b) are typically understood to mean C₅-C₂₄-aryl radicals, preferably C₆-C₁₄-aryl radicals, more preferably C₆-C₁₂-aryl radicals. Examples of C₅-C₂₄-aryl are phenyl, o-, p- or m-tolyl, naphthyl, phenanthrenyl, anthracenyl and fluorenyl.

Heteroaryl radicals in the R″ radicals of the phosphines or diphosphines of the general formulae (1-a) and (1-b) have the same definition as given above for aryl radicals, except that one or more of the skeleton carbon atoms are replaced by a heteroatom selected from the group of nitrogen, sulphur and oxygen. Examples of such heteroaryl radicals are pyridinyl, oxazolyl, benzofuranyl, dibenzofuranyl and quinolinyl.

All the aforementioned alkyl, alkenyl, alkadienyl and alkoxy radicals may be unsubstituted or mono- or polysubstituted, for example by C₅-C₂₄-aryl radicals, preferably phenyl (in the case of alkyl radicals, this results, for example, in arylalkyl, preferably a phenylalkyl radical), halogen, preferably fluorine, chlorine or bromine, CN, OH, NH₂ or NR″₂ radicals where R″ in turn is C₁-C₃₀-alkyl or C₅-C₂₄-aryl.

Both the aryl radicals and the heteroaryl radicals are either unsubstituted or mono- or polysubstituted, for example by straight-chain or branched C₁-C₃₀-alkyl (resulting in what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or N(R″)₂ radicals, where R″ in turn is straight-chain or branched C₁-C₃₀-alkyl or C₅-C₂₄-aryl, or by further C₅-C₂₄-aryl or -heteroaryl radicals, which results in bisaryl radicals, preferably biphenyl or binaphthyl, heteroaryl aryl radicals, aryl heteroaryl radicals or bisheteroaryl radicals. These C₅-C₂₄-aryl or -heteroaryl substituents too are again in turn either unsubstituted or mono- or polysubstituted by all the aforementioned substituents.

Cycloalkyl radicals in the R′ radicals of the phosphines or diphosphines of the general formulae (1-a) and (1-b) are typically understood to mean a C₃-C₂₀-cycloalkyl radical, preferably a C₃-C₈-cycloalkyl radical, more preferably cyclopentyl and cyclohexyl.

Cycloalkenyl radicals in the R′ radicals of the phosphines or diphosphines of the general formulae (1-a) and (1-b) are the same or different, have one C═C double bond in the ring skeleton and are typically C₅-C₈ cycloalkenyl, preferably cyclopentenyl and cyclohexenyl.

Cycloalkadienyl radicals in the R′ radicals of the phosphines or diphosphines of the general formulae (1-a) and (1-b) are the same or different, have two C═C double bonds in the ring skeleton and are typically C₅-C₈ cycloalkadienyl, preferably cyclopentadienyl or cyclohexadienyl.

The aforementioned cycloalkyl, cycloalkenyl and cycloalkadienyl radicals too are either unsubstituted or mono- or polysubstituted, for example by straight-chain or branched C₁-C₃₀-alkyl (the result is then what are called alkylaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or NR″₂ radicals, where R″ in turn is straight-chain or branched C₁-C₃₀-alkyl or C₅-C₂₄-aryl, or by C₅-C₂₄-aryl or -heteroaryl radicals, which are in turn either unsubstituted or mono- or polysubstituted by all the aforementioned substituents.

The halogen radicals in the R′ radicals of the phosphines or diphosphines of the general formulae (1-a) and (1-b) are the same or different and are each fluorine, chlorine or bromine.

Particularly preferred phosphines of the general formula (1-a) are trialkyl-, tricycloalkyl-, triaryl-, trialkaryl-, triaralkyl-, diarylmonoalkyl-, diarylmonocycloalkyl-, dialkylmonoaryl-, dialkylmonocycloalkyl- or dicycloalkylmonoarylphosphines, where all the aforementioned radicals in turn are either unsubstituted or mono- or polysubstituted by the aforementioned substituents.

Especially preferred phosphines are those of the general formula (1-a) in which the R radicals are the same or different and are each phenyl, cyclohexyl, cyclohexenyl, cyclopentyl, cyclopentadienyl, phenylsulphonate or cyclohexylsulphonate.

Most preferably, the phosphines of the general formula (1-a) present in the inventive hydrogenated nitrile rubber are PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(iso-Pr)₃, P(CHCH₃(CH₂CH₃))₃, P(cyclopentyl)₃, P(cyclohexyl)₃, P(neopentyl)₃, P(C₆H₅CH₂)(C₆H₅)₂, P(NCCH₂CH₂)₂(C₆H₅), P[(CH₃)C]₂Cl, P[(CH₃)₃C]₂(CH₃), P(tert-Bu)₂(biph), P(C₆H₁₁)₂Cl, P(CH₃)(OCH₂CH₃)₂, P(CH₂═CHCH₂)₃, P(C₄H₃O)₃, P(CH₂OH)₃, P(m-CH₃OC₆H₄)₃, P(C₆F₅)₃, P[(CH₃)₃Si]₃, P[(CH₃O)₃C₆H₂]₃, where Ph is phenyl, Tol is tolyl, biph is biphenyl, Bu is butyl and Pr is propyl. Triphenylphosphine is especially preferred.

In the diphosphines of the general formula (1-b), k is 0 or 1, preferably 1.

X in the general formula (1-b) is a straight-chain or branched alkanediyl, alkenediyl or alkynediyl group, preferably a straight-chain or branched C₁-C₂₀-alkanediyl, C₂-C₂₀-alkenediyl or C₂-C₂₀-alkynediyl group, more preferably a straight-chain or branched C₁-C₈-alkanediyl, C₂-C₆-alkenediyl or C₂-C₅-alkynediyl group.

C₁-C₈-Alkanediyl is a straight-chain or branched alkanediyl radical having 1 to 8 carbon atoms. Particular preference is given to a straight-chain or branched alkanediyl radical having 1 to 6 carbon atoms, especially having 2 to 4 carbon atoms. Preference is given to methylene, ethylene, propylene, propane-1,2-diyl, propane-2,2-diyl, butane-1,3-diyl, butane-2,4-diyl, pentane-2,4-diyl and 2-methylpentane-2,4-diyl.

C₂-C₆Alkenediyl is a straight-chain or branched alkenediyl radical having 2 to 6 carbon atoms. Preference is given to a straight-chain or branched alkenediyl radical having 2 to 4, more preferably 2 to 3, carbon atoms. Preferred examples include: vinylene, allylene, prop-1-ene-1,2-diyl and but-2-ene-1,4-diyl.

C₂-C₆Alkynediyl is a straight-chain or branched alkynediyl radical having 2 to 6 carbon atoms. Preference is given to a straight-chain or branched alkynediyl radical having 2 to 4, more preferably 2 to 3, carbon atoms. Preferred examples include: ethynediyl and propynediyl.

Particularly preferred diphosphines of the general formula (1-b) are Cl₂PCH₂CH₂PCl₂, (C₆H₁₁)₂PCH₂P(C₆H₁₁), (CH₃)₂PCH₂CH₂P(CH₃)₂, (C₆H₅)₂PCCP(C₆H₅)₂, (C₆H₅)₂PCH═CHP(C₆H₅)₂, (C₆F₅)₂P(CH₂)₂P(C₆F₅)₂, (C₆H₅)₂P(CH₂)₂P(C₆H₅)₂, (C₆H₅)₂P(CH₂)₃P(C₆H₅)₂, (C₆H₅)₂P(CH₂)₄P(C₆H₅)₂, (C₆H₅)₂P(CH₂)₅P(C₆H₅)₂, (C₆H₅)₂PCH(CH₃)CH(CH₃)P(C₆H₅)₂ and (C₆H₅)₂PCH(CH₃)CH₂P(C₆H₅)₂.

Particular diphosphines likewise usable in accordance with the invention are also published in Eur. J. 2008, 14, 9491-9494. Examples include:

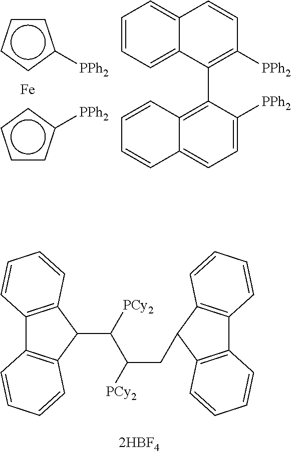

The phosphine sulphide or diphosphine sulphide component (ii) in the inventive hydrogenated nitrile rubber typically comprises sulphides of the above-defined phosphines or diphosphines.

In particular component (i) represents a phosphine, particularly preferred triphenylphosphine, and correspondingly component (ii) represents in particular a phosphine oxide, particularly preferred triphenylphosphine oxide.

### Repeating Units of the Hydrogenated Nitrile Rubber

The inventive hydrogenated nitrile rubbers have repeating units of at least one α,β-unsaturated nitrile monomer and at least one conjugated diene monomer. They may additionally have repeating units of one or more further copolymerizable monomers.

The inventive hydrogenated nitrile rubber comprises fully or partly hydrogenated nitrile rubbers. The hydrogenation level may be within a range from at least 50% and up to 100%, or from 75% to 100%. Typically the inventive hydrogenated nitrile rubber has a high hydrogenation degree, customarily from 80% to 100%, preferably from 90% to 100%, more preferably from 92 to 100% and most preferably from 94 to 100%. Those skilled in the art refer to “fully hydrogenated types” which shall also be encompassed by the present invention even when the residual C═C double bond content (also abbreviated to “RDB”) is not more than about 0.9%, meaning that the hydrogenation level is greater than or equal to 99.1%,

The repeating units of the at least one conjugated diene are preferably based on (C₄-C₆) conjugated dienes or mixtures thereof. Particular preference is given to 1,2-butadiene, 1,3-butadiene, isoprene, 2,3-dimethylbutadiene, piperylene and mixtures thereof. Especially preferred are 1,3-butadiene, isoprene and mixtures thereof. Even more preferred is 1,3-butadiene.

The α,β-unsaturated nitrile used for production of the inventive nitrile rubbers may be any known α,β-unsaturated nitrile, preference being given to (C₃-C₅)-α,β-unsaturated nitrites such as acrylontrile, methacrylonitrile, ethacrylonitrile or mixtures thereof. Particular preference is given to acrylonitrile.

If one or more further copolymerizahle monomers are used, these may, for example, be aromatic vinyl monomers, preferably styrene, α-methylstyrene and vinylpyridine, flourinated vinyl monomers, preferably fluoroethyl vinyl ether, fluoropropyl vinyl ether, o-fluoromethylstyrene, vinyl pentafluorobenzoate, difluoroethylene and tetrafluoroethylene, or else copolymerizable antiageing monomers, preferably N-(4-anilinophenyl)acrylamide, N-(4-anilinophenyl)methacrylamide, N-(4-anilinophenyl)cinnamides N-(4-anilinophenyl)crotonamide, N-phenyl-4-(3-vinylbenzyloxy)aniline and N-phenyl-4-(4-vinylbenzyloxy)aniline, and also nonconjugated dienes, such as 4-cyanocyclohexene and 4-vinylcyclohexene, or else alkynes such as 1- or 2-butyne.

In addition, the copolymerizable termonomers used may be monomers containing hydroxyl groups, preferably hydroxyalkyl (meth)acrylates. It is also possible to use correspondingly substituted (meth)acrylamines.

Examples of suitable hydroxyalkyl acrylate monomers are 2-hydroxyethyl (meth)acrylate, 2-hydroxypropyl (meth)acrylate, 3-hydroxypropyl (meth)acrylate, 3-chloro-2-hydroxypropyl (meth)acrylate, 3-phenoxy-2-hydroxypropyl (meth)acrylate, glyceryl mono(meth)acrylate, hydroxybutyl (meth)acrylate, 3-chloro-2-hydroxypropyl (meth)acrylate, hydroxyhexyl (meth)acrylate, hydroxyoctyl (meth)acrylate, hydroxymethyl(meth)acrylamide, 2-hydroxypropyl (meth)acrylate, 3-hydroxypropyl(meth)acrylamide, di(ethylene glycol) itaconate, di(propylene glycol) itaconate, bis(2-hydroxypropyl) itaconate, bis(2-hydroxyethyl) itaconate, bis(2-hydroxyethyl) fumarate, bis(2-hydroxyethyl) maleate and hydroxymethyl vinyl ketone.

In addition, the copolymerizahle termonomers used may be monomers containing epoxy groups, preferably glycidyl (meth)acrylates.

Examples of monomers containing epoxy groups are diglycidyl itaconate, glycidyl p-styrenecarboxylate, 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidylmethyl methacrylate, glycidylmethyl methacrylate, glycidyl acrylate, (3′,4′-epoxyheptyl)-2-ethyl acrylate, (3′,4′-epoxyheptyl)-2-ethyl methacrylate, 6′,7″-epoxyheptyl acrylate, 6′,7′-epoxyheptyl methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Alternatively, further copolymerizable monomers used may be copolymerizable termonomers containing carboxyl groups, for example α,β-unsaturated monocarboxylic acids, esters thereof, α,βunsaturated dicarboxylic acids, mono- or diesters thereof or the corresponding anhydrides or amides thereof.

The α,β-unsaturated monocarboxylic acids used may preferably be acrylic acid and methacrylic acid.

It is also possible to use esters of the α,βunsaturated monocarboxylic acids, preferably the alkyl esters and alkoxyalkyl esters thereof. Preference is given to the alkyl esters, especially C₁-C₁₈ alkyl esters, of the α,β-unsaturated monocarboxylic acids, particular preference to alkyl esters, especially C₁-C₁₈ alkyl esters of acrylic acid or of methacrylic acid, especially methyl acrylate, ethyl acrylate, propyl acrylate, n-butyl acrylate, tert-butyl acrylate, 2-ethylhexyl acrylate, n-dodecyl acrylate, methyl methacrylate, ethyl methacrylate, butyl methacrylate and 2-ethylhexyl methacrylate. Preference is also given to alkoxyalkyl esters of the α,β-unsaturated monocarboxylic acids, particular preference to alkoxyalkyl esters of acrylic acid or of methacrylic acid, especially C₂-C₁₂-alkoxyalkyl esters of acrylic acid or of methacrylic acid, even more preferably methoxymethyl acrylate, ethoxyethyl (meth)acrylate and methoxyethyl (meth)acrylate. it is also possible to use mixtures of alkyl esters, for example those mentioned above, with alkoxyalkyl esters, for example in the form of those mentioned above. It is also possible to use cyanoalkyl acrylate and cyanoalkyl methacrylates in which the number of carbon atoms in the cyanoalkyl group is 2-12, preferably α-cyanoethyl acrylate, β-cyanoethyl acrylate and cyanobutyl methacrylate. It is also possible to use hydroxyalkyl acrylates and hydroxyalkyl methacrylate in which the number of carbon atoms of the hydroxyalkyl groups is 1-12, preferably 2-hydroxyethyl acrylate, 2-hydroxyethyl methacrylate and 3-hydroxypropyl acrylate; it is also possible to use acrylates or methacrylates containing fluorine-substituted benzyl groups, preferably fluorobenzyl acrylate and fluorobenzyl methacrylate. It is also possible to use acrylates and methacrylates containing fluoroalkyl groups, preferably trifluoroethyl acrylate and tetrafluoropropyl methacrylate. It is also possible to use α,β-unsaturated carboxylic esters containing amino groups, such as dimethylaminomethyl acrylate and diethylaminoethyl acrylate.

Further monomers used may be α,β-unsaturated dicarboxylic acids, preferably maleic acid, fumaric acid, crotonic acid, itaconic acid, citraconic acid and mesaconic acid.

It is additionally possible to use α,β-unsaturated dicarboxylic anhydrides, preferably maleic anhydride, itaconic anhydride, citraconic anhydride and mesaconic anhydride.

It is additionally possible to use mono- or diesters of α,β-unsaturated dicarboxylic acids.

These α,β-unsaturated dicarboxylic mono- or diesters may, for example, be alkyl, preferably C₁-C₁₀-alkyl, especially ethyl, n-propyl, isopropyl, n-butyl, tert-butyl, n-pentyl or n-hexyl, alkoxyalkyl, preferably C₂-C₁₂-alkoxyalkyl, more preferably C₃-C₈-alkoxyalkyl, hydroxyalkyl, preferably C₁-C₁₂-hydroxyalkyl, more preferably C₂-C₈-hydroxyalkyl, cycloalkyl, preferably C₅-C₁₂-cycloalkyl, more preferably C₆-C₁₂-cycloalkyl, alkylcycloalkyl, preferably C₆-C₁₂-alkylcycloalkyl, more preferably C₇-C₁₀-alkylcycloalkyl, aryl, preferably C₆-C₁₄-aryl, mono- or diesters, where any diesters may also be mixed esters.

Particularly preferred alkyl esters of α,β-unsaturated monocarboxylic acids are methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate, 2-propylheptyl acrylate and lauryl (meth)acrylate. In particular, n-butyl acrylate is used.

Particularly preferred alkoxyalkyl esters of the α,β-unsaturated monocarboxylic acids are methoxyethyl (meth)acrylate, ethoxyethyl (meth)acrylate and methoxyethyl (meth)acrylate. In particular, methoxyethyl acrylate is used.

Other esters of the α,62 unsaturated monocarboxylic acids used are additionally, for example, polyethylene glycol (meth)acrylate, polypropylene glycol (meth)acrylate, N-(2-hydroxyethyl)acrylamides, N-(2-hydroxymethyl)acrylamides and urethane (meth)acrylate.

Examples of α,β-unsaturated dicarboxylic monoesters include
monoalkyl maleates, preferably monomethyl maleate, monoethyl maleate, monopropyl maleate and mono-n-butyl maleate;
monocycloalkyl maleates, preferably monocyclopentyl maleate, monocyclohexyl maleate and monocycloheptyl maleate;
monoalkylcycloalkyl maleates, preferably monomethylcyclopentyl maleate and monoethylcyclohexyl maleate;
monoaryl maleates, preferably monophenyl maleate;
monobenzyl maleates, preferably monobenzyl maleate;
monoalkyl fumarates, preferably monomethyl fumarate, monoethyl fumarate, monopropyl fumarate and mono-n-butyl fumarate;
monocycloalkyl fumarates, preferably monocyclopentyl fumarate, monocyclohexyl fumarate and monocycloheptyl fumarate;
monoalkylcycloalkyl fumarates, preferably monomethylcyclopentyl fumarate and monoethylcyclohexyl fumarate;
monoaryl fumarates, preferably monophenyl fumarate;
monobenzyl fumarates, preferably monobenzyl fumarate;
monoalkyl citraconates, preferably monomethyl citraconate, monoethyl citraconate, monopropyl citraconate and mono-n-butyl citraconate;
monocycloalkyl citraconates, preferably monocyclopentyl citraconate, monocyclohexyl citraconate and monocycloheptyl citraconate;
monoalkylcycloalkyl citraconates, preferably monomethylcyclopentyl citraconate and monoethylcyclohexyl citraconate;
monoaryl citraconates, preferably monophenyl citraconate;
monobenzyl citraconates, preferably monobenzyl citraconate;
monoalkyl itaconates, preferably monomethyl itaconate, monoethyl itaconate, monopropyl itaconate and mono-n-butyl itaconate;
monocycyloalkyl itaconates, preferably monocyclopentyl itaconate, monocyclohexyl itaconate and monocycloheptyl itaconate;
monoalkylcycloalkyl itaconates, preferably monomethylcyclopentyl itaconate and monoethylcyclohexyl itaconate;
monoaryl itaconates, preferably monophenyl itaconate;
monobenzyl itaconates, preferably monobenzyl itaconate;
monoalkyl mesaconates, preferably monoethyl mesaconate.

The α,β-unsaturated dicarboxylic diesters used may be the analogous diesters based on the aforementioned monoester groups, where the ester groups may also be chemically different groups.

Useful further copolymerizable monomers are also free-radically polymerizable compounds containing at least two olefinic double bonds per molecule. Examples of polyunsaturated compounds are acrylates, methacrylates or itaconates of polyols, for example ethylene glycol diacrylate, diethylene glycol dimethacrylate, triethylene glycol diacrylate, butanediol 1,4-diacrylate, propane-1,2-diol diacrylate, butane-1,3-diol dimethacrylate, neopentyl glycol diacrylate, trimethylolpropane di(meth)acrylate, trimethylolethane di(meth)acrylate, glyceryl di- and triacrylate, pentaerythrityl di-, tri- and tetraacrylate or -methacrylate, dipentaerythrityl tetra-, penta- and hexaacrylate or -methacrylate or -itaconate, sorbityl tetraacrylate, sorbityl hexamethacrylate, diacrylates or dimethacrylates of 1,4-cyclohexanediol, 1,4-dimethylolcyclohexane, 2,2-bis(4-hydroxyphenyl)propane, of polyethylene glycols or of oligoesters or oligourethanes with terminal hydroxyl groups. The polyunsaturated monomers used may also be acrylamides, for example methylenebisacrylamide, hexamethylene-1,6-bisacrylamide, diethylenetriaminetrismethacrylamide, bis(methacrylamidopropoxy)ethane or 2-acrylamidoethyl acrylate. Examples of polyunsaturated vinyl and allyl compounds are divinylbenzene, ethylene glycol divinyl ether, diallyl phthalate, allyl methacrylate, diallyl maleate, triallyl isocyanurate or triallyl phosphate.

The proportions of conjugated diene and α,β-unsaturated nitrile in the hydrogenated nitrile rubbers to be used in the process of the invention or the inventive hydrogenated nitrile rubbers may vary within wide ranges. The proportion of, or of the sum total of, the conjugated diene(s) is typically in the range from 20 to 95% by weight, preferably in the range from 45 to 90% by weight, more preferably in the range from 50 to 85% by weight, based on the overall polymer. The proportion of, or of the sum total of, the α,β-unsaturated nitrile(s) is typically in the range from 5 to 80% by weight, preferably 10 to 55% by weight, more preferably 15 to 50% by weight, based on the overall polymer. The proportions of the repeating units of conjugated diene and α,β-unsaturated nitrile in the hydrogenated nitrile rubbers to be used in accordance with the invention or the inventive hydrogenated nitrile rubbers add up to 100% by weight in each case.

The additional monomers may be present in amounts of 0 to 40% by weight, preferably 0 to 30% by weight, more preferably 0 to 26% by weight, based on the overall polymer. In this case, corresponding proportions of the repeating units of the conjugated diene(s) and/or of the repeating units of the α,β-unsaturated nitrile(s) are replaced by the proportions of these additional monomers, where the proportions of all the repeating units of the monomers must also add up to 100% by weight in each case.

If esters of (meth)acrylic acid are used as additional monomers, this is typically done in amounts of 1 to 25% by weight. If α,β-unsaturated mono- or dicarboxylic acids are used as additional monomers, this is typically done in amounts of less than 10% by weight.

Preference is given to hydrogenated inventive nitrile rubbers having repeating units derived from acrylonitrile and 1,3-butadiene. Preference is further given to inventive hydrogenated nitrile rubbers having repeating units of acrylonitrile, 1,3-butadiene and one or more further copolymerizable monomers, Preference is likewise given to hydrogenated nitrile rubbers having repeating units of acrylonitrile, 1,3-butadiene and one or more α,β-unsaturated mono- or dicarboxylic acids or esters or amides thereof, and especially repeating units of an alkyl ester of an α,β-unsaturated carboxylic acid, most preferably of methyl (meth)acrylate, ethyl (meth)acrylate, propyl (meth)acrylate, n-butyl (meth)acrylate, t-butyl (meth)acrylate, hexyl (meth)acrylate, 2-ethylhexyl (meth)acrylate, octyl (meth)acrylate or lauryl (meth)acrylate.

In a preferred embodiment, the inventive hydrogenated nitrile rubbers are essentially filler-free, “Essentially filler-free” in the context of this application means that the inventive hydrogenated nitrile rubbers contains less than 5% by weight of fillers, based on 100% by weight of hydrogenated nitrile rubber.

In a particularly preferred embodiment, the inventive hydrogenated nitrile rubbers contain, based on 100% by weight of hydrogenated nitrile rubber, less than 5% by weight of fillers selected from the group consisting of carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form), silicates and mixtures of the above.

The nitrogen content is determined in the inventive hydrogenated nitrile rubbers to DIN 53 625 according to Kjeldahl. Due to the content of polar comonomers, the nitrile rubbers are typically ≧85% by weight soluble in methyl ethyl ketone at 20° C.

The glass transition temperatures of the inventive hydrogenated nitrile rubbers are within the range of −70° C. to +10° C., preferably within the range of −60° C. to −0° C.

The hydrogenated nitrile rubbers have Mooney viscosities ML 1+4 at 100° C. of 10 to 150 Mooney units (MU), preferably of 20 to 100 MU.

The Mooney viscosity of the hydrogenated nitrile rubbers is determined in a shearing disc viscometer to DIN 53523/3 or ASTM D 1646 at 100° C.

In an alternative embodiment the inventive hydrogenated nitrile rubber has
i) a content of phosphates, diphosphines or mixtures thereof, preferably triphenylphosphine, within the range from greater 0 to 1.0% by weight, preferably from 0.1 to 0.9% by weight, more preferably from 0.15 to 0.85% by weight, based on the hydrogenated nitrile rubber,
ii) a content of phosphine oxides, diphosphine oxides or mixtures thereof, preferably triphenylphosphine oxide, in the range from 0.25 to 6% by weight, preferably from 0.3 to 5% by weight, more preferably from 0.35 to 4% by weight, based on the hydrogenated nitrile rubber, and
iii) a total halogen content in the range from 25 to 10 000 ppm, preferably from 30 to 8000 ppm, more preferably from 45 to 7000 ppm.

In said alternative embodiment the hydrogenation degree of the hydrogenated nitrile rubber is in the range from 80 to 100%, preferably from 90 to 100%, more preferably from 92 to 200%, even more preferably from 94 to 100%.

### Process for Producing the Inventive Hydrogenated Nitrile Rubbers

The inventive hydrogenated nitrile rubbers having
i) a content of phosphines, diphosphines or mixtures thereof, preferably triphenylphosphine, within the range from 0 to 1.0% by weight, preferably from 0 to 0.9% by weight, more preferably from 0 to 0.85% by weight, based on the hydrogenated nitrile rubber,
ii) a content of phosphide oxides, diphosphine oxides or mixtures thereof, preferably triphenylphosphine oxide, in the range from 0.25 to 6% by weight, preferably from 0.3 to 5% by weight, more preferably from 0.35 to 4% by weight, based on the hydrogenated nitrile rubber, and
iii) a total halogen content in the range from 25 to 10 000 ppm, preferably from 30 to 8000 ppm, more preferably 35 to 1000 ppm, very preferably from 38 to 900 ppm, especially preferably from 40 to 850 ppm
   can be produced by reacting a hydrogenated nitrile rubber having a content of phosphines, diphosphines or mixtures thereof within a range of 0.25-5% by weight, preferably within the range of 0.3-4.5% by weight, more preferably within the range of 0.4-4.25% by weight and especially within the range of 0.5-4% by weight, based on the hydrogenated nitrile rubber, with at least one sulphur compound which does not have two sulphur atoms bonded directly to one another.

This analogously applies to the preparation of the alternative inventive hydrogenated nitrile rubbers which differ from the ones described in the preceding paragraph only in that (i) the content of phosphines, diphosphines or mixtures thereof is in the range from greater than 0 to 1 % by weight, preferably from 0.1% by weight to 0.9% by weight, and more preferably from 0.15 to 0.85% by weight, based on the hydrogenated nitrile rubber.

The inventive reaction of the phosphine- and/or diphosphine-containing hydrogenated nitrile rubber with at least one sulphur compound which does not have two sulphur atoms bonded directly to one another can be conducted in various variants.

The following method has been found to be useful:
(1) a nitrile rubber is first subjected to a catalytic hydrogenation in organic solution and in the presence of a phosphine and/or diphosphine as defined above, the phosphine and/or diphosphine
   (a) being present as a ligand in the hydrogenation catalyst without further addition of phosphine and/or diphosphine as a cocatalyst or (b) being present as a ligand in the hydrogenation catalyst and additionally being added as a cocatalyst, or (c) being added as a cocatalyst, but with no phosphine or diphosphine present as ligand(s) in the hydrogenation catalyst, and
   (2) then the hydrogenated nitrile rubber obtained, before, during or after the isolation, preferably before or during the isolation, especially in the course of a steam distillation, or alternatively preferably after isolation, is contacted with and reacted with at least one sulphur compound which does not have two sulphur atoms bonded directly to one another in a separate mixing operation.

### Step 1

It has typically been found to be useful to produce the hydrogenated nitrile rubber having a content of phosphines, diphosphines or mixtures thereof in the range of 0.25-5% by weight, preferably of 0.3-4.5% by weight, more preferably of 0.4-4.25% by weight and especially of 0.5-4% by weight, based on the hydrogenated nitrile rubber, in a first step by hydrogenation.

### Hydrogenation Catalyst

In the catalytic hydrogenation reaction of the process according to the invention, at least one phosphine or diphosphine is present;

In a first embodiment, this phosphine or diphosphine is present as a ligand in the hydrogenation catalyst used. No separate addition of a phosphine or diphosphine is required.

In a second embodiment, a phosphine or diphosphine is added as what is called a cocatalyst alongside the phosphine or diphosphine ligand-containing hydrogenation catalyst in the hydrogenation reaction.

In a third embodiment, any desired hydrogenation catalyst that does not contain any phosphine or diphosphine can be used, and the phosphine or diphosphine is added as a cocatalyst.

In a preferred embodiment, the hydrogenation is performed using at least one catalyst having at least one phosphine or diphosphine ligand.

Preference is additionally given to hydrogenation using at least one catalyst having at least one phosphine or diphosphine ligand, and additionally in the presence of at least one phosphine or diphosphine as a cocatalyst.

In all embodiments, the hydrogenation catalysts are typically based on the noble metals rhodium, ruthenium, osmium, palladium, platinum or iridium, preference being given to rhodium, ruthenium and osmium. The catalysts specified hereinafter are usable in all the embodiments.

It is possible to use rhodium complex catalysts of the general formula (A)

Rh(X)ₙ(L)ₘ (A)

where
X are the same or different and are hydrogen, halogen, pseudohalogen, SnCl₃ or carboxylate,
n is 1, 2 or 3, preferably 1 or 3,
L are the same or different and represent mono- or bidentate ligands based on phosphorus, arsenic or antimony,
m is 2, 3 or 4 if L represents monodentate ligands, or is 1 or 1.5 or 2 or 3 or 4 if L represents bidentate ligands.

In the general formula (A), X are the same or different and are preferably hydrogen or chlorine.

L in the general formula (A) is preferably a phosphine or diphosphine corresponding to the general formulae (I-a) and (I-b) shown above, including the general, preferred and particularly preferred definitions given there.

Particularly preferred catalysts of the general formula (A) are tris(triphenylphosphine)rhodium(I) chloride, tris(triphenylphosphine)rhodium(III) chloride, tris(dimethyl sulphoxide)rhodium(III) chloride, hydridorhodiumtetrakis(triphenylphosphine) and the corresponding compounds in which triphenylphosphine has been replaced wholly or partly by tricyclohexylphosphine.

It is also possible to use ruthenium complex catalysis. These are described, for example, in DE-A 39 21 264 and EP-A-0 298 386. They typically have the general formula (B)

RuXₙ[L¹)ₘ(L²)_{5-z}] (B)

in which
X are the same or different and are hydrogen, halogen, SnCl₃, CO, NO or R⁶—COO,
L¹ are the same or different and are hydrogen, halogen, R6—COO, NO, CO or a cyclopentadienyl ligand of the following general formula (2):

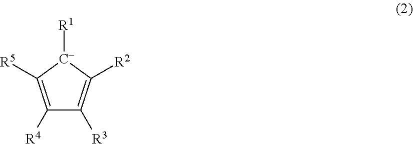

in which
R¹ to R⁵ are the same or different and are each hydrogen, methyl, ethyl, propyl, butyl, hexyl or phenyl or, alternatively, two adjacent radicals from R¹ to R⁵ may also be bridged, so as to result in an indenyl or fluorenyl system,
L² is a phosphine, diphosphine or arsine and
n is 0, 1 or 2,
m is 0,1, 2 or 3,
z is 1, 2, 3 or 4, and
R⁶ is a radical which has 1 to 20 carbon atoms and may be branched or unbranched, bridged or unbridged and/or partly aromatic, and is preferably C₁-C₄ alkyl.

Examples of L¹ ligands in the general formula (B) of the cyclopentadienyl ligand type of the general formula (2) include cyclopentadienyl, pentamethylcyclopentadienyl, ethyltetramethylcyclopentadienyl, pentaphenylcyclopentadienyl, dimethyltriphenylcyclopentadienyl, indenyl and fluorenyl. The benzene rings in the L¹ ligands of the indenyl and fluorenyl type may be substituted by C₁-C₆-alkyl radicals, especially methyl, ethyl and isopropyl, C₁-C₄-alkoxy radicals, especially methoxy and ethoxy, aryl radicals, especially phenyl, and halogens, especially fluorine and chlorine. Preferred L¹ ligands of the cyclopentadienyl type are the respectively unsubstituted cyclopentadienyl, indenyl and fluorenyl radicals.

In the L¹ ligand in the general formula (B) of the (R⁶—COO) type, R⁶ includes, for example, straight-chain or branched, saturated hydrocarbyl radicals having 1 to 20, preferably 1 to 12 and especially 1 to 6 carbon atoms, cyclic saturated hydrocarbyl radicals having 5 to 12 and preferably 5 to 7 carbon atoms, and also aromatic hydrocarbyl radicals having 6 to 18 and preferably 6 to 10 carbon atoms, or aryl-substituted alkyl radicals having preferably a straight-chain or branched C₁-C₆ alkyl radical and a C₆-C₁₈ aryl radical, preferably phenyl.

The above-elucidated R⁶ radicals in (R⁶—COO) in the ligand L¹ of the general formula (B) may optionally be substituted by hydroxyl, C₁-C₆-alkoxy, C₁-C₆-carbalkoxy, fluorine, chlorine or di-C₁-C₄-alkylamino, the cycloalkyl, aryl and aralkyl radicals additionally by C₁-C₆-alkyl; alkyl, cycloalkyl and aralkyl groups may contain keto groups. Examples of the R⁶ radical are methyl, ethyl, propyl, isopropyl, tert-butyl, cyclohexyl, phenyl, benzyl and trifluoromethyl. Preferred R⁶ radicals are methyl, ethyl and tert-butyl.

The L² ligand in the general formula (B) is preferably a phosphine or diphosphine according to the general formulae (1-a) and (1-b) shown above, including the general, preferred and particularly preferred definitions given there, or is an arsine of the general formula (3)

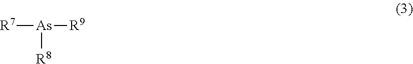

Preferred ligands L² of the general formula (3) are triphenylarsine, ditolylphenylarsine, tris(4-ethoxyphenyl)arsine, diphenylcyclohexylarsine, dibutylphenylarsine and diethylphenylarsine.

Preferred ruthenium catalysts of the general formula (B) are selected from the group which follows, where “Cp” represents cyclopentadienyl, i.e. C₅H₅′, “Ph” represents phenyl, “Cy” represents cyclohexyl and “dppe” represents 1,2-bis(diphenylphosphino)ethane: RuCl₂(PPh₃)₃; RuHCl(PPh₃)₃; RuH₂(PPh₃)₃; RuH₂(PPh₃)₄; RuH₄(PPh₃)₃; RuH(CH₃COO)(PPh₃)₃; RuH(C₂H₅COO)(PPh₃)₃; RuH(CH₃COO)₂(PPh₃)₂; RuH(NO)₂(PPh₃)₂; Ru(NO)₂(PPh₃)₂; RuCl(Cp)(PPh₃)₂; RuH(Cp)(PPh₃)₂; Ru(SnCl₃)(Cp)(PPh₃)₂; RuCl(μ⁵-C⁹H₇)(PPh₃)₂; RuH(μ⁵-C₉H₇)(PPh₃)₂; Ru(SnCl₃)(μ⁵-C₉H₃)₂)(PPh₃)₂; RuCl(μ⁵-C₁₃H₉)(PPh₃)₂; RuH(μ⁵-C₁₃H₉)(PPh₃)₂; Ru(SnCl₃)(μ⁵-C₁₃H₉)(PPh₃)₂; RuCl(μ⁵-C₉H₇)(dppe); RuHCl(CO)(PCy₃); RuH(NO)(CO)(PCy₃)₃; RuHCl(CO)₂(PPh₃)₂; RuCl₂(CO)(dppe) RuHCl(CO)(PCy₃), RuHCl(CO)(dppe)₂, RuH(CH₃COO)(PPh₃)₃; RuH(CH₃COO)₂(PPh₃)₂; and RuH(CH₃COO)(PPh₃)₃.

Suitable catalysts are also those of the general formula (C)

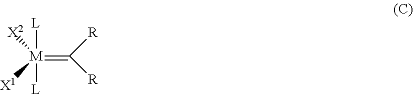

in which
M is osmium or ruthenium,
X¹ and X² are the same or different and are two ligands, preferably anionic ligands,
L are identical or different ligands, preferably uncharged electron donors,
   R are the same or different and are hydrogen, alkyl, preferably C₁-C₃₀-alkyl, cycloalkyl, preferably C₃-C₂₀-cycloalkyl, alkenyl, preferably C₂-C₂₀-alkenyl, alkynyl, preferably C₂-C₂₀-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄arylthio, alkylsulphonyl, preferably C₁-C₂₀-alkylsulphonyl, or alkylsulphinyl, preferably C₁-C₂₀-alkylsulphinyl, where all these radicals may each optionally be substituted by one or more alkyl, halogen, alkoxy, aryl or heteroaryl radicals, or alternatively both R radicals, with incorporation of the common carbon atom to which they are bonded, are bridged to form a cyclic group which may be aliphatic or aromatic in nature, is optionally substituted and may contain one or more heteroatoms.

In one embodiment of the catalysts of the general formula (C), one R radical is hydrogen and the other R radical is C₁-C₂₀-alkyl, C₃-C₁₀-cycloalkyl, C₂-C₂₀-alkenyl, C₁-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl or C₁-C₂₀-alkylsulphinyl, where all these radicals may each be substituted by one or more alkyl, halogen, alkoxy, aryl or heteroaryl radicals.

In the catalysis of the general formula (C), X¹ and X² are the same or different and are two ligands, preferably anionic ligands.

X¹ and X² may, for example, be hydrogen, halogen, pseudohalogen, straight-chain or branched C₁-C₃₀-alkyl, C₆-C₂₄-aryl, C₁-C₂₀alkoxy, C₆-C₂₄-aryloxy, C₃-C₂₀-alkyldiketonate, C₆-C₂₄-aryldiketonate, C₁-C₂₀-carboxylate, C₁-C₂₀-alkylsulphonate, C₆-C₂₄-arylsulphonate, C₁-C₂₀-alkylthiol, C₆-C₂₄-arylthiol, C₁-C₂₀-alkylsulphonyl, C₁-C₂₀-alkylsulphinyl, mono- or dialkylamide, mono- or dialkylcarbamate, mono- or dialkylthiocarbamate, mono- or dialkyldithiocarbamate or mono- or dialkylsulphonamide radicals.

The aforementioned X¹ and X² radicals may also be substituted by one or more further radicals, for example by halogen, preferably fluorine, C₁-C₁₀-alkyl, C₂-C₁₀-alkoxy or C₆-C₂₄-aryl, where these radicals too may optionally in turn be substituted by one or more substituents selected from the group comprising halogen, preferably fluorine, C₁-C₅-alkyl C₁-C₅-alkoxy and phenyl.

In a further embodiment, X¹ and X² are the same or different and are each halogen, especially fluorine, chlorine, bromine or iodine, benzoate, C₁-C₅-carboxylate, C₁-C₅-alkyl, phenoxy, C₁-C₅-alkoxy, C₁-C₅-alkylthiol, C₆-C₂₄-arylthiol, C₆-C₂₄-aryl or C₁-C₅-alkylsulphonate.

In a further embodiment, X¹ and X² are identical and are each halogen, especially chlorine, CF₃COO, CH₃COO, CFH₂COO, (CH₃)₃CO, (CF₃)₂(CH₃)CO, (CF₃)(CH₃)₂CO, PhO (phenoxy), MeO (methoxy), EtO (ethoxy), tosylate (p-CH₃-C₆H₄-SO₃), mesylate (CH₃SO₃) or CF₃SO₃ (trifluoromethanesulphonate).

In the general formula (C), L are identical or different ligands and are preferably uncharged electron donors.

The two L ligands may, for example, each independently be a phosphine, sulphonated phosphine, phosphate, phosphinite, phosphonite, arsine, stibine, ether, amine, amide, sulphoxide, carboxyl, nitrosyl, pyridine, thioether, an imidazoline or an imidazolidine ligand.

Preferably, the two L ligands are each independently a C₆-C₂₄-aryl-, C₁-C₁₀-alkyl- or C₃-C₂₀-cycloalkylphosphine ligand, a sulphonated C₆-C₂₄-aryl- or sulphonated C₁-C₁₀-alkylphosphine ligand, a C₆-C₂₄-aryl- or C₁-C₁₀-alkylphosphinite ligand, a C₆-C₂₄-aryl- or C₁-C₁₀-alkylphosphonite ligand, a C₆-C₂₄-aryl- or C₁-C₁₀-alkylphosphite ligand, a C₆-C₂₄-aryl- or C₁-C₁₀-alkylarsine ligand, a C₆-C₂₄-aryl- or C₁-C₁₀-alkylamine ligand, a pyridine ligand, a C₆-C₂₄-aryl or C₁-C₁₀-alkyl sulphoxide ligand, a C₆₋C₂₄-aryl or C₁-alkyl ether ligand or a C₆-C₂₄- or C₁-C₁₀-alkylamide ligand, all of which may each be substituted by a phenyl group which is in turn either unsubstituted or substituted by one or more halogen, C₁C₅-alkyl or C₁-C₅-alkoxy radical(s).

The term “phosphine” includes, for example, PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄-SO₃Na)₃, P(CH₂C₆H₄-SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃, where “Ph” represents phenyl and “Tol” represents tolyl.

The term “phosphinite” includes, for example, triphenylphosphinite, tricyclohexylphosphinite, triisopropylphosphinite and methyldiphenylphosphinite.

The term “phosphite” includes, for example, triphenylphosphite, tricyclohexylphosphite, tri-tert-butylphosphite, triisopropylphosphite and methyldiphenylphosphite.

The term “stibine” includes triphenylstibine, tricyclohexylstibine and trimethylstibine.

The term “sulphonate” includes, for example, trifluoromethanesulphonate, tosylate and mesylate.

The term “sulphoxide” includes, for example, (CH₃)₂S(═O) and (C₆H₅)₂═O.

The term “thioether” includes, for example, CH₃SCH₃, C₆H₅SCH₃, CH₃OCH₂CH₂SCH₃ and tetrahydrothiophene.

The term “pyridine” shall be understood in the context of this application as an umbrella term for all pyridine-based ligands, as specified, for example, by Grubbs in WO-A-03/011455. These include pyridine, and pyridine having mono- or polysubstitution in the form of the picolines (α-, β- and γ-picoline), lutidines (2,3-, 2,4-, 2,5-, 2,6-, 3,4- and 3,5-lutidine), collidine (2,4,6-trimethylpyridine), trifluoromethylpyridine, phenylpyridine, 4-(dimethylamino)pyridine, chloropyridines, bromopyridines, nitropyridines, quinoline, pyrimidine, pyrrole, imidazole and phenylimidazole.

If one or both of the L ligands in formula (C) is an imidazoline and/or imidazolidine radical (also referred to collectively hereinafter as “Im” ligand(s)), the latter typically has a structure of the general formula (4a) or (4b)

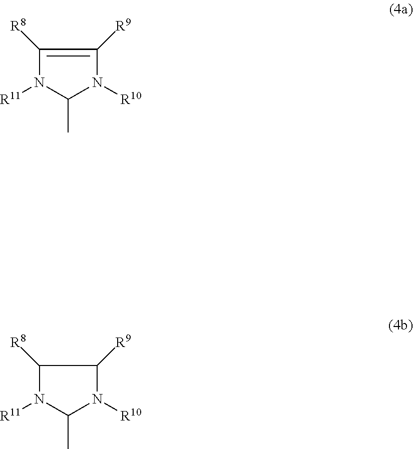

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆₋C₂₄-aryl, C₁-C₂₀-carboxylate, C₁-C₂₀-alkoxy, C₂-C₂₀-alkenyloxy, C₂-C₂₀-alkynyloxy, C₆-C₂₀-aryloxy, C₂-C₂₀-alkoxycarbonyl, C₁-C₂₀-alkylthio, C₆-C₂₀-arylthio, C₁-C₂₀-alkylsulfonyl, C₁-C₂₀-alkylsulphonate, C₆-C₂₀-arylsulphonate or C₁-C₂₀-alkylsulphinyl.

Optionally, one or more of the R⁸, R⁹, R¹⁰, R¹¹ radicals may each independently be substituted by one or more substituents, preferably straight-chain or branched C₁-C₁₀-alkyl, C₃-C₈-cycloalkyl, C₁-C₁₀-alkoxy or C₆-C₂₄-aryl, where these aforementioned substituents may in turn be substituted by one or more radicals, preferably selected from the group of halogen, especially fluorine, chlorine or bromine, C₁-C₅-alkyl, C₁-C₅-alkoxy and phenyl.

Merely for clarification, it should be added that the structures shown in the general formulae (4a) and (4b) in the contest of this application are equivalent to the structures (4a′) and (4b′) frequently also encountered in the literature for this radical, which emphasize the carbene character of the radical. This also applies analogously to the corresponding preferred structures (5a)-(5f) shown below. These radicals are all referred to collectively hereinafter as “Im” radical.

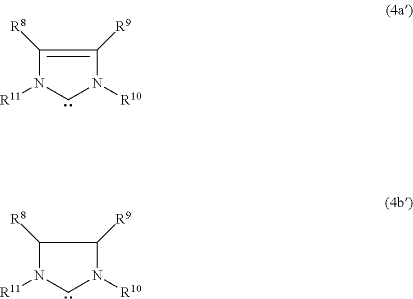

In a preferred embodiment of the catalysts of the general formula (C), R⁸ and R⁹ are each independently hydrogen, C₆-C₂₄-aryl, more preferably phenyl, straight-chain or branched C₁-C₁₀-alkyl, more preferably propyl or butyl, or form, together with the carbon atoms to which they are bonded, a cycloalkyl or aryl radical, where all the aforementioned radicals may optionally be substituted in turn by one or more further radicals selected from the group comprising straight-chain or branched C₁-C₁₀-alkyl, C₁C₁₀-alkoxy, C₆-C₂₄-aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

In a preferred embodiment of the catalysts of the general formula (C), the R¹⁰ and R¹¹ radicals are additionally the same or different and are each straight-chain or branched C₁-C₁₀-alkyl, more preferably methyl, isopropyl or neopentyl, C₃-C₁₀-cycloalkyl, preferably adamantyl, C₆-C₂₄-aryl, more preferably phenyl, C₁-C₁₀-alkylsulphonate, more preferably methanesulphonate, C₆-C₁₀-arylsulphonate, more preferably p-toluenesulphonate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen, especially fluorine, chlorine and bromine.

More particularly, the R¹⁰ and R¹¹ radicals may be the same or different and are each isopropyl, neopentyl, adamantyl, mesityl (2,4,6-trimethylphenyl), 2,6-difluorophenyl, 2,4,6-trifluorophenyl or 2,6-diisopropylphenyl.

Particularly preferred Im radicals have the structures (5a) to (5f) below, where Ph in each case is a phenyl radical, Bu is a butyl radical and Mes in each case is a 2,4,6-trimethylphenyl radical, or Mes alternatively in all cases is 2,6-diisopropylphenyl.

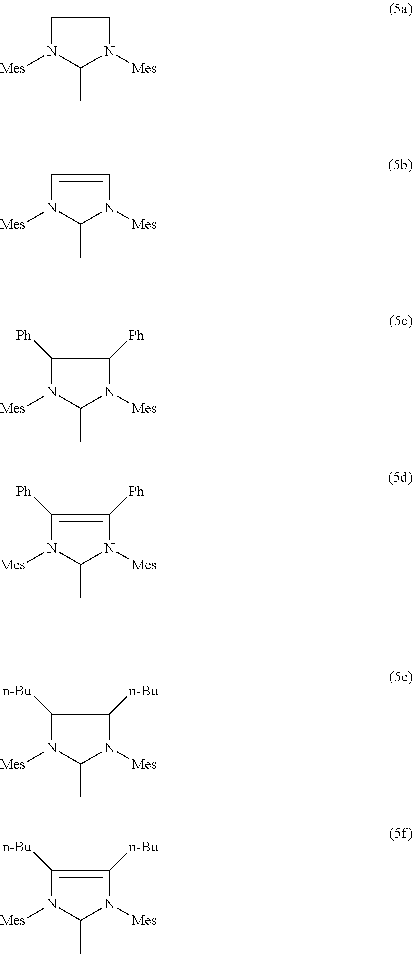

A wide variety of different representatives of the catalysts of the formula (C) is known in principle, for example from WO-A-96/04289 WO-A97/06185.

As an alternative to the preferred Im radicals, one or both L ligands in the general formula (C) are preferably also identical or different trialkylphosphine ligands in which at least one of the alkyl groups is a secondary alkyl group or a cycloalkyl group, preferably isopropyl, isobutyl, sec-butyl, neopentyl, cyclopentyl or cyclohexyl.

More preferably, in the general formula (C), one or both L ligands are a trialkylphosphine ligand in which at least one of the alkyl groups is a secondary alkyl group or a cycloalkyl group, preferably isopropyl, isobutyl, see-butyl, neopentyl, cyclopentyl or cyclohexyl.

Particular preference is given to catalysts which are covered by the general formula (C) and have the structures (6) (Grubbs (I) catalyst) and (7) (Grubbs (II) catalyst), where Cy is cyclohexyl

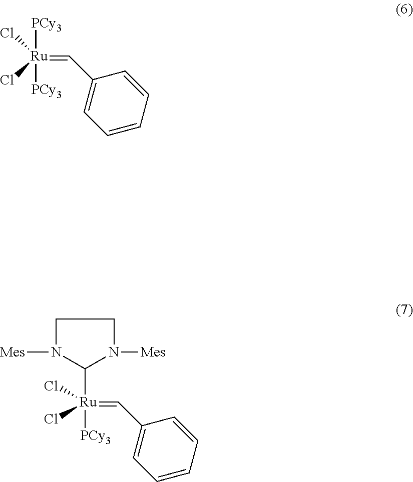

Suitable catalysts are also preferably those of the general formula (C1)

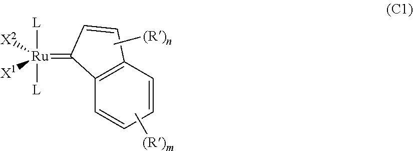

in which
X¹, X² and L may have the same general, preferred and particularly preferred definitions as in the general formula (C),
n is 0, 1 or 2,
m is 0, 1, 2, 3 or 4 and
R′ are the same or different and are each alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each be substituted by one or more alkyl, halogen, alkoxy, aryl or heteroaryl radicals.

Preferred catalysts covered by the formula (C1) may, for example, be those of the formulae (8a) and (8b), where Mes is 2,4,6-trimethylphenyl and Ph is phenyl,

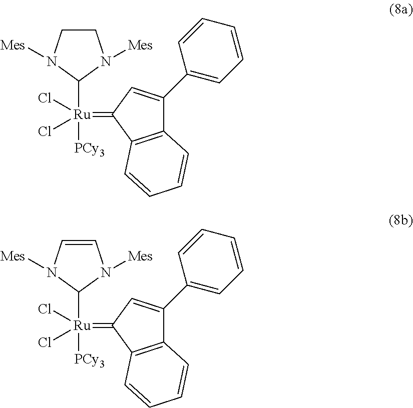

These catalysts are known, for example, from WO-A-2004/112951. Catalyst (8a) is also referred to as the Nolan catalyst.

Suitable catalysts are also preferably those of the general formula (D)

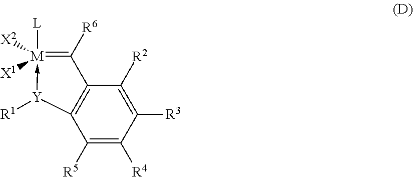

in which
M is ruthenium or osmium,
X¹ and X² are identical or different ligands, preferably anionic ligands,
Y is oxygen (O), sulphur (S), an N-R¹ radical or a P-R¹ radical, where R¹ is as defined below,
R¹ is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
R², R³, R⁴ and R⁵ are the same or different and are each hydrogen or organic or inorganic radicals,
R⁶ is hydrogen or an alkyl, alkenyl, alkynyl or aryl radical and
L is a ligand as defined for the formula (C).

The catalysts of the general formula (D) are known in principle and are described, for example, by Hoveyda et al. in US 2002/0107138 A1 and Angew. Chem. Int. Ed. 2003, 42, 4592, and by Grela in WO-A-2004/035596, Eur. J. Org. Chem 2003, 963-966 and Angew. Chem. Int. Ed. 2002, 41, 4038, and also in J. Org. Chem. 2004, 69, 6894-96 and Chem. Eur. J 2004, 10, 777-784, and also in US 2007/043180. The catalysts are commercially available or can be prepared according to the references cited.

In the catalysts of the general formula (D), L is a ligand which typically has an electron donor function and may assume the same general, preferred and particularly preferred definitions as L in the general formula (C). In addition, L in the general formula (D) is preferably a P(R⁷)₃ radical where R⁷ are independently C₁-C₆ alkyl, C₃-C₈-cycloalkyl or aryl, or else an optionally substituted imidazoline or imidazolidine radical (“Im”).

C₁-C₆-Alkyl is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl comprises cyclopropyl, cyclobutyl, cyclopentyl, cyclohexyl, cycloheptyl and cyclooctyl.

Aryl comprises an aromatic radical having 6 to 24 skeleton carbon atoms, preferably mono-, bi- or tricyclic carbocyclic aromatic radicals having 6 to 10 skeleton carbon atoms, especially phenyl, biphenyl, naphthyl, phenanthrenyl or anthracenyl.

The imidazoline or imidazolidine radical (Im) has the same general, preferred and particularly preferred structures as the catalysts of the general formula (C).

Particularly suitable catalysts of the general formula (D) are those in which the R¹⁰ and R¹¹ radicals are the same or different and are each straight-chain or branched C₁-C₁₀-alkyl, more preferably isopropyl or neopentyl, C₃-C₁₀-cycloalkyl, preferably adamantyl, C₆-C₂₄ -aryl, more preferably phenyl, C₁-C₁₀-alkylsulphonate, more preferably methanesulphonate, or C₆-C₁₀-arylsulphonate, more preferably p-toluenesulphate.

Optionally, the aforementioned radicals as definitions of R¹⁰ and R¹¹ are substituted by one or more further radicals selected from the group comprising straight-chain or branched C₁-C₅-alkyl, especially methyl, C₁-C₅-alkoxy, aryl and a functional group selected from the group of hydroxyl, thiol, thioether, ketone, aldehyde, ester, ether, amine, imine, amide, nitro, carboxylic acid, disulphide, carbonate, isocyanate, carbodiimide, carboalkoxy, carbamate and halogen.

More particularly, the R¹⁰ and R¹¹ radicals may be the same or different and are each isopropyl, neopentyl, adamantyl or mesityl.

Particularly preferred imidazoline, or imidazolidine radicals (Im) have the structures (5a-5f) already specified above, where Mes in each case is 2,4,6-trimethylphenyl.

In the catalysts of the general formula (D), X¹ and X² have the same general, preferred and particularly preferred definitions as the catalysts of the general formula (C).

In the general formula (D), the R¹ radical is an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals.

Typically, the R¹ radical is a C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C20-alkynyloxy, C₆-C₂₄-aryloxy, C₂-C₂₀-alkoxycarbonyl, C₁-C₂₀-alkylamino, C₁-C₂₀alkylthio, C₆-C₂₄-arylthio, C₁-C₂₀-alkylsulphonyl or C₁-C₂₀-alkylsulphinyl radical, all of which may each optionally be substituted by one or more alkyl, halogen, alkoxy, aryl or heteroaryl radicals.

Preferably, R¹ is a C₃-C₂₀-cycloalkyl radical, a C₆-C₂₄-aryl radical or a straight-chain or branched C₁-C₃₀-alkyl radical, where the latter may optionally be interrupted by one or more double or triple bonds or else one or more heteroatoms, preferably oxygen or nitrogen. More preferably, R¹ is a straight-chain or branched C₁-C₁₂-alkyl radical.

The C₃-C₂₀-cycloalkyl radical comprises, for example, cyclopropyl, cyclobutyl, cyclopentyl, cyclohexyl, cycloheptyl and cyclooctyl.

The C₁-C₁₂-alkyl radical may, for example, be methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, n-hexyl, n-heptyl, n-octyl, n-decyl or n-dodecyl. More particularly, R¹ is methyl or isopropyl.

The C₆-C₂₄-aryl radical is an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

In the general formula (D), the R², R³, R⁴ and R⁵ radicals are the same or different and may each be hydrogen or organic or inorganic radicals.

In a suitable embodiment, R², R³, R⁴, R⁵ are the same or different and are each hydrogen, halogen, nitro, CF₃, alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radicals, all of which may each optionally be substituted by one or more alkyl, alkoxy, halogen, aryl or heteroaryl radicals.

Typically, R², R³, R⁴, R⁵ are the same or different and are each hydrogen, halogen, preferably chlorine or bromine, nitro, CF₃, C₁-C₃₀-alkyl, C₃-C₂₀-cycloalkyl, C₂-C₂₀-alkenyl, C₂-C₂₀-alkynyl, C₆-C₂₄-aryl, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylamino, C₁-C₂₀-alkylthio, C₆-C₂₄-arylthio, C₁-C₂₀-alkylsulphonyl or C₆-C₂₀-alkylsulphinyl radicals, all of which may each optionally be substituted by one or more C₁-C₃₀-alkyl, C₁-C₂₀-alkoxy, halogen, C₆-C₂₄-aryl or heteroaryl radicals.

In a particularly proven embodiment, R², R³, R⁴, R⁵ are the same or different and are each nitro, straight-chain or branched C₁-C₃₀-alkyl, C₅-C₂₀-cycloalkyl, straight-chain or branched C₁-C₂₀-alkoxy radicals or C₆-C₂₄-aryl radicals, preferably phenyl or naphthyl. The C₁-C₃₀-alkyl radicals and C₁-C₂₀-alkoxy radicals may optionally be interrupted by one or more double or triple bonds or else one or more heteroatoms, preferably oxygen or nitrogen.

In addition, two or more of the R², R³, R⁴ or R⁵ radicals may also be bridged via aliphatic or aromatic structures. R³ and R⁴ may, for example, including the carbon atoms to which they are bonded in the phenyl ring of the formula (D), form a fused-on phenyl ring so as to result overall in a naphthyl structure.

In the general formula (D), the R⁶ radical is hydrogen or an alkyl, alkenyl, alkynyl or aryl radical. Preferably, R⁶ is hydrogen or a C₁-C₃₀-alkyl, a C₂-C₂₀-alkenyl, a C₂C₂₀-alkynyl or a C₆₋-C₂₄-aryl radical. More preferably, R⁶ is hydrogen.

Other suitable catalysts are catalysts of the general formula (D1)

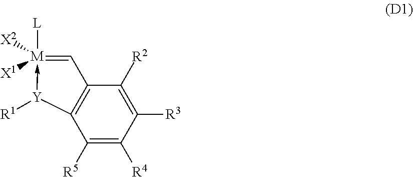

in which M, L, X¹, X², R¹, R², R³, R⁴ and R⁵ may each have the general, preferred and particularly preferred definitions given for the general formula (D).

The catalysts of the general formula (D1) are known in principle, for example, from US 2002/0107138 A1(Hoveyda et al.) and can be obtained by preparation processes specified therein.

Particularly suitable catalysts are those of the general formula (D1) where
M is ruthenium,
X¹ and X² are both halogen, especially both chlorine,
R¹ is a straight-chain or branched C₁-C₁₂ alkyl radical,
R², R³, R⁴, R⁵ each have the general and preferred definitions given for the general formula (D) and
L has the general and preferred definitions given for the general formula (D),

Especially suitable catalysts are those of the general formula (D1) where
M is ruthenium,
X¹ and X² are both chlorine,
R¹ is an isopropyl radical,
R², R³, R⁴, R⁵ are all hydrogen and
L is an optionally substituted imidazolidine radical of the formula (4a) or (4b),

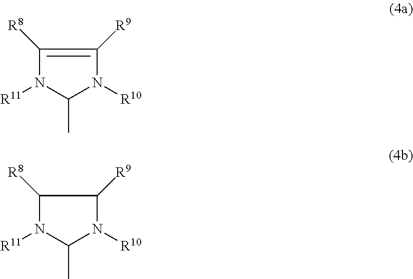

in which
R⁸, R⁹, R¹⁰, R¹¹ are the same or different and are each hydrogen, straight-chain or branched C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀-alkylthio, C₆-C₂₄-arylthio, C₁-C₂₀-alkylsulphonyl, C₁-C₂₀-alkylsulphonate, C₆-C₂₄-arylsulphonate or C₁-C₂₀-alkylsulphinyl, where the aforementioned radicals may each be substituted by one or more substituents, preferably straight-chain or branched C₁-C₂₀-alkyl, C₃-C₈-cycloalkyl, C₁-C₁₀-alkoxy or C₆-C₂₄-aryl, where these aforementioned substituents too may in turn be substituted by one or more radicals, preferably selected from the group of halogen, especially chlorine or bromine, C₁-C₅-alkyl, C₁-C₅-alkoxy and phenyl.

A very particularly suitable catalyst is one which is covered by the general structural formula (D1) and has the formula (9), where each Mes is 2,4,6-trimethylphenyl.

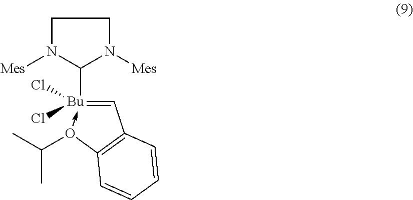

This catalyst (9) is also referred to in the literature as “Hoveyda catalyst”.

Further suitable catalysts are those which are covered by the general structural formula (D1) and have one of the following formulae; (10), (11), (12), (13), (14), (15), (16) and (17), where each Mes is 2,4,6-trimethylphenyl.

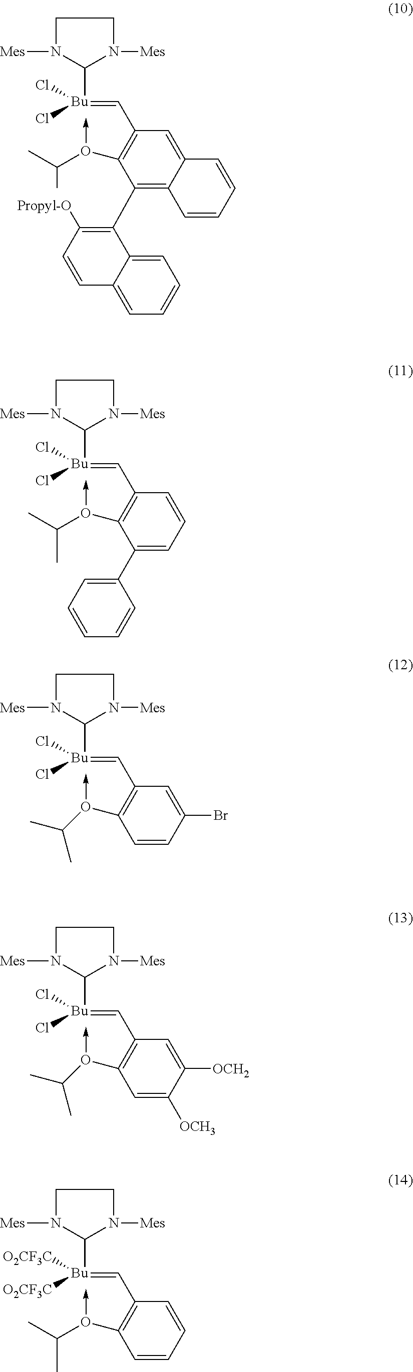

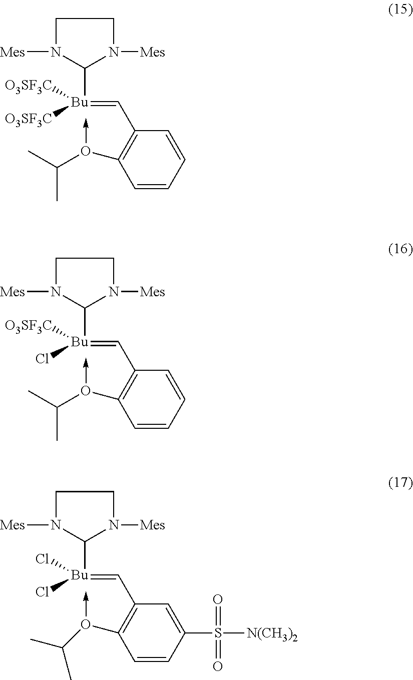

A further suitable catalyst is a catalyst of the general formula (D2)

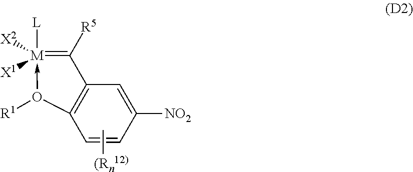

in which
M, L, X¹, X², R¹ and R⁶ each have the general and preferred definitions given for the formula (D),
R¹² are the same or different and have the general and preferred definitions given for R², R³, R⁴ and R⁵ in formula (D), excluding hydrogen, and
n is 0, 1, 2 or 3.

The catalysts of the general formula (D2) are known in principle, for example, from WO-A-2004/035596 (Grela) and can be obtained by preparation processes specified therein.

Particularly suitable catalysts are those of the general formula (D2) in which
M is ruthenium,
X¹ and X² are both halogen, especially both chlorine,
R¹ is a straight-chain or branched C₁-C₁₂ alkyl radical,
R¹² is as defined for the general formula (D2),
n is 0, 1, 2 or 3,
R⁶ is hydrogen and
L is as defined for the general formula (D).

Especially suitable catalysts are those of the general formula (D2) in which
M is ruthenium,
X¹ and X² are both chlorine,
R¹ is an isopropyl radical,
n is 0 and
L is an optionally substituted imidazolidine radical of the formula (4a) or (4b) in which R⁸, R⁹, R¹⁰, R¹¹ are the same or different and are each as defined for the especially preferred catalysts of the general formula (D1).

Particularly suitable catalysts are those of the structures (18) (“Grela catalyst”) and (19) below, where each Mes is 2,4,6-trimethylphenyl.

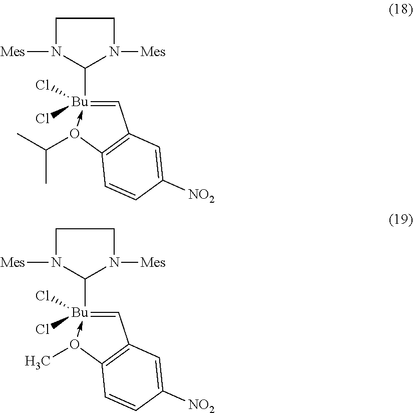

Another suitable catalyst is a dendritic catalyst of the general formula (D3)

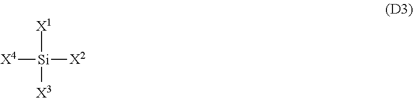

in which X¹, X², X³ and X⁴ each have a structure of the general formula (20) bonded to the silicon of the formula (D3) via the methylene group shown on the right and

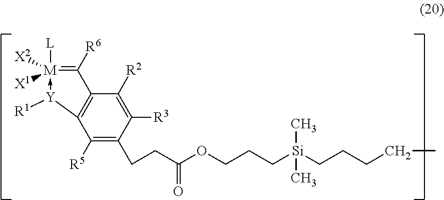

in which
M, L, X¹, X², R¹, R², R³, R⁵ and R⁶ may each have the general and preferred definitions given for the general formula (D).

The catalysts of the general formula (D3) are known from US 2002/0107138 A1 and can be prepared according to the details given therein.

Another suitable catalyst is a catalyst of the formula (D4)

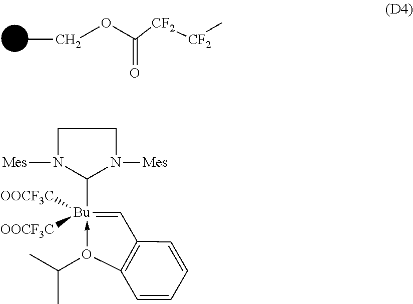

in which the symbol represents a support.

The support is preferably a poly(styrene-divinylbenzene) copolymer (PS-DVB).

The catalysts according to formula (D4) are known in principle from Chem. Eur. J. 2004 10, 777-784 and are obtainable by preparation methods described therein.

All the aforementioned catalysts of the (D), (D1), (D2), (D3) and (D4) types can either be used as such in the hydrogenation reaction or else they can be applied to a solid support and immobilized. Suitable solid phases or supports are those materials which are firstly inert with respect to the metathesis reaction mixture and secondly do not impair the activity of the catalyst. The catalyst can be immobilized using, for example, metals, glass, polymers, ceramic, organic polymer beads or else inorganic sol-gels, carbon black, silica, silicates, calcium carbonate and barium sulphate.

Other suitable catalysts are catalysts of the general formula (E)

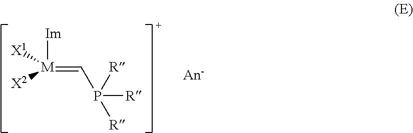

where
M is ruthenium or osmium,
X¹ and X² are the same or different and are each anionic ligands,
R″ are the same or different and are each organic radicals,
Im is an optionally substituted imidazoline or imidazolidine radical and
An is an anion.

The catalysts of the general formula (E) are known in principle (see, for example, Angew. Chem. Int. Ed. 2004, 43, 6161-6165).

X¹ and X² in the general formula (E) may have the same general, preferred and particularly preferred definitions as in the formulae (C) and (D).

The Im radical typically has a structure of the general formula (4a) or (4b) which has already been specified for the catalyst type of the formulae (C) and (D) and may also have any of the structures specified there as preferred, especially those of the formulae (5a)-(5f).

The R″ radicals in the general formula (E) are the same or different and are each a straight-chain or branched C₁-C30-alkyl, C₅-C₃₀-cycloalkyl or aryl radical, where the C₁-C₃₀-alkyl radicals may optionally be interrupted by one or more double or triple bonds or else one or more heteroatoms, preferably oxygen or nitrogen.

Aryl comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The R″ radicals in the general formula (E) are preferably the same and are each phenyl, cyclohexyl, cyclopentyl, isopropyl, o-tolyl, o-xylyl or mesityl.

Other suitable catalysts are catalysts of the general formula (F)

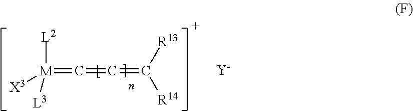

in which
M is ruthenium or osmium,
R¹³ and R¹⁴ are each independently hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₂₀ -alkylthio, C₁-C₂₀-alkylsulphonyl or C₁-C₂₀-alkysulphinyl,
X³is an anionic ligand,
L² is an uncharged π-bonded ligand, no matter whether mono- or polycyclic,
L³ is a ligand from the group of the phosphines, sulphonated phosphines, fluorinated phosphines, functionalized phosphines having up to three aminoalkyl, ammonioalkyl, alkoxyalkyl, alkoxycarbonylalkyl, hydrocarbonylalkyl, hydroxyalkyl or ketoalkyl groups, phosphites, phosphinites, phosphonites, phosphinamines, arsines, stibines, ethers, amines, amides, imines, sulphoxides, thioethers and pyridines,
Y′ is a noncoordinating anion and
n is 0, 1, 2, 3, 4 or 5,

Other suitable catalysts are catalysts of the general formula (G)

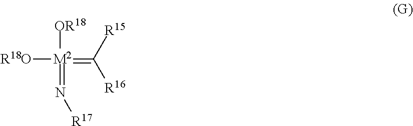

in which
M² is molybdenum,
R¹⁵ and R¹⁶ are the same or different and are each hydrogen, C₁-C₂₀-alkyl, C₂-C₂₀-alkenyl, C₂-C₂₀-alkynyl, C₆-C₂₄-aryl, C₁-C₂₀-carboxylate, C₁-C₂₀-alkoxy, C₂₋C₂₀-alkenyloxy, C₂-C20-alkynyloxy, C₆-C₂₄-aryloxy, C₂-C₂₀-alkoxycarbonyl, C₁-C₂₀-alkylthio, C₁-C₂₀-alkylsulphonyl or C₁-C₂₀-alkylsulphinyl,
R¹⁷ and R¹⁸ are the same or different and are each a substituted or halogen-substituted C₁-C₂₀-alkyl, C₆-C₂₄-aryl, C₆-C₃₀-aralkyl radical or silicone-containing analogues thereof.

Further suitable catalysts are catalysts of the general formula (H)

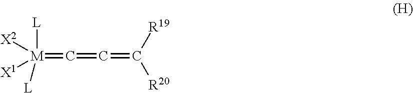

in which
M is ruthenium or osmium,
X¹ and X² are the same or different and are each anionic ligands which may assume all definitions of X¹ and X² given in the general formulae (C) and (D),
L represents identical or different ligands which may assume all definitions of L given in the general formulae (C) and (D),
R¹⁹ and R²⁰ are the same or different and are each hydrogen or substituted or unsubstituted alkyl.

Further suitable catalysts are catalysts of the general formula (K), (N) or (Q)

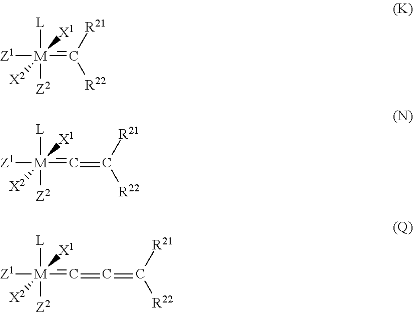

where
M is osmium or ruthenium,
X¹ and X² are the same or different and are two ligands, preferably anionic ligands,
L is a ligand, preferably an uncharged electron donor,
Z¹ and Z² are the same or different and are each uncharged electron donors,
R²¹ and R²² are each independently hydrogen, alkyl, cycloalkyl, alkenyl, alkynyl, aryl, carboxylate, alkoxy, alkenyloxy, alkynyloxy, aryloxy, alkoxycarbonyl, alkylamino, alkylthio, alkylsulphonyl or alkylsulphinyl, each of which is substituted by one or more radicals selected from alkyl, halogen, alkoxy, aryl and heteroaryl.

The catalysts of the general formulae (K), (N) and (Q) are known in principle, for example from WO 2003/011455 A1, WO 2003/087167 A2, Organometallics 2001, 20, 5314 and Angew. Chem. Int. Ed. 2002, 41, 4038. The catalysts are commercially available or else can be synthesized by the preparation methods specified in the aforementioned references.

In the catalysts of the general formulae (K), (N) and (Q), Z¹ and Z² are the same or different and are each uncharged electron donors. These ligands are typically weakly coordinating. They are typically optionally substituted heterocyclic groups. These may be five- or six-membered monocyclic groups having 1 to 4, preferably 1 to 3 and more preferably 1 or 2 heteroatoms or bi- or polycyclic structures composed of 2, 3, 4 or 5 of such five- or six-membered monocyclic groups, where each of the aforementioned groups may optionally be substituted by one or more alkyl, preferably C₁-C₁₀-alkyl, cycloalkyl, preferably C₃-C₈-cycloalkyl, alkoxy, preferably C₁-C₁₀-alkoxy, halogen, preferably chlorine or bromine, aryl, preferably C₆-C₂₄-aryl, or heteroaryl, preferably C₃-C₂₃-heteroaryl radicals, each of which may again be substituted by one or more groups, preferably selected from the group consisting of halogen, especially chlorine or bromine, C₁-C₅-alkyl, C₁-C₅-alkoxy and phenyl.

Examples of Z¹ and Z² include nitrogen-containing heterocycles such as pyridines, pyridazines, bipyridines, pyrimidines, pyrazines, pyrazolidines, pyrrolidines, piperazines, indazoles, quinolines, purines, acridines, bismidazoles, picolylimines, imidazolidines and pyrroles.

Z¹ and Z² may also be bridged to one another to form a cyclic structure. In this case, Z¹ and Z²are a single bidentate ligand.

In the catalysts of the general formulae (K), (N) and (Q), L may assume the same general, preferred and particularly preferred definitions as L in the general formulae (C) and (D).

In the catalysis of the general formulae (K), (M) and (Q), R²¹ and R²² are the same or different and are each alkyl, preferably C₁-C₃₀-alkyl, more preferably C₁-C₂₀-alkyl, cycloalkyl, preferably C₃-C₂₀-cycloalkyl, more preferably C₃-C₈-cycloalkyl, alkenyl, preferably C₂-C₂₀-alkenyl, more preferably C₂-C₁₆-alkenyl, alkynyl, preferably C₂-C₂₀-alkynyl, more preferably C₂-C₁₆-alkynyl, aryl, preferably C₆-C₂₄-aryl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₆-C₃₀-alkylamino, alkylthio, preferably C₁-C30-alkylthio, arylthio, preferably C₆-C₂₄-arylthio, alkylsulphonyl, preferably C₁-C₂₀-alkylsulphonyl, or alkylsulphinyl, preferably C₁-C₂₀-alkylsulphinyl, where the aforementioned substituents may be substituted by one or more alkyl, halogen, alkoxy, aryl or heteroaryl radicals.

In the catalysts of the general formulae (K), (N) and (Q), X¹ and X² are the same or different and may have the same general, preferred and particularly preferred definitions as specified above for X¹ and X² in the general formula (C).

Particularly suitable catalysts are those of the general formulae (K), (N) and (Q) in which
M is ruthenium,
X¹ and X² are both halogen, especially chlorine,
R¹ and R² are the same or different and are each five- or six-membered monocyclic groups having 1 to 4, preferably 1 to 3 and more preferably 1 or 2 heteroatoms or bi- or polycyclic structures composed of 2, 3, 4 or 5 of such five- or six-membered monocyclic groups, where each of the aforementioned groups may be substituted by one or more alkyl, preferably C₁-C₁₀-alkyl, cycloalkyl, preferably C₃-C₈-cycloalkyl, alkoxy, preferably C1-C₁₀-alkoxy, halogen, preferably chlorine or bromine, aryl, preferably C₆-C₂₄-aryl, or heteroaryl, preferably C₅-C₂₃ heteroaryl radicals,
R²¹ and R²² are the same or different and are each C₁-C₃₀-alkyl, C₃-C₂₀-cycloalkyl, C₂-C₂₀-alkenyl, C₂-C₂₀-alkynyl, C₆-C₂₄-aryl, C₁-C₂₀-carboxylates, C₁-C₂₀-alkoxy, C₂-C₂₀-alkenyloxy, C₂-C₂₀-alkynyloxy, C₆-C₂₄-aryloxy, C₂-C₂₀-alkoxycarbonyl, C₁-C₃₀-alkylamino, C₁-C₃₀-alkylthio, C₆-C₂₄-arylthio, C₁-C₂₀-alkylsulphonyl, C₁-C₂₀-alkylsulphinyl, and
L has a structure of the general formula (4a) or (4b) already described above, especially of the formulae (5a) to (5f).

A very particularly suitable catalyst is one which is covered by the general formula (K) and has the structure (21)

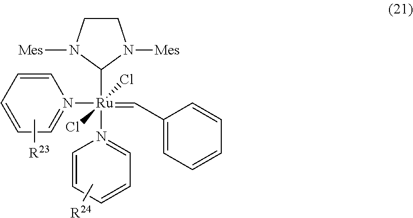

in which
R²³ and R²⁴ are the same or different and are each H, halogen, straight-chain or branched C₁-C₂₀-alkyl, C₁-C₂₀-heteroalkyl, C₁-C₁₀-haloalkyl, C₁-C₁₀-alkoxy, C₆-C₂₄-aryl, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, dialkylamino, trialkylsilyl and trialkoxysilyl.

The aforementioned C₁-C₂₀-alkyl, C₁-C₂₀-heteroalkyl, C₁-C₁₀-haloalkyl, C₁-C₁₀-alkoxy, C₆-C₂₄-aryl radicals, preferably phenyl, formyl, nitro, nitrogen heterocycles, preferably pyridine, piperidine and pyrazine, carboxyl, alkylcarbonyl, halocarbonyl, carbamoyl, thiocarbamoyl, carbamido, thioformyl, amino, trialkylsilyl and trialkoxysilyl, may again each be substituted by one or more halogen, preferably fluorine, chlorine or bromine, C₁-C₅-alkyl, C₁-C₅-alkoxy or phenyl radicals.

A particularly suitable catalyst is one where R²³ and R²⁴ are each hydrogen (“Grubbs III catalyst”).

Also very particularly suitable are catalysts of the structure (22a) or (22b) where R²³ and R²⁴ have the same definitions as in the formula (21), except for hydrogen.

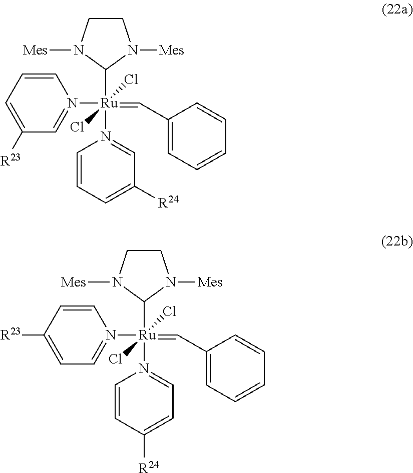

Suitable catalysts covered by the general formulae (K), (N) and (Q) have the structural formulae (23) to (34) below, where each Mes is 2,4,6-trimethylphenyl.

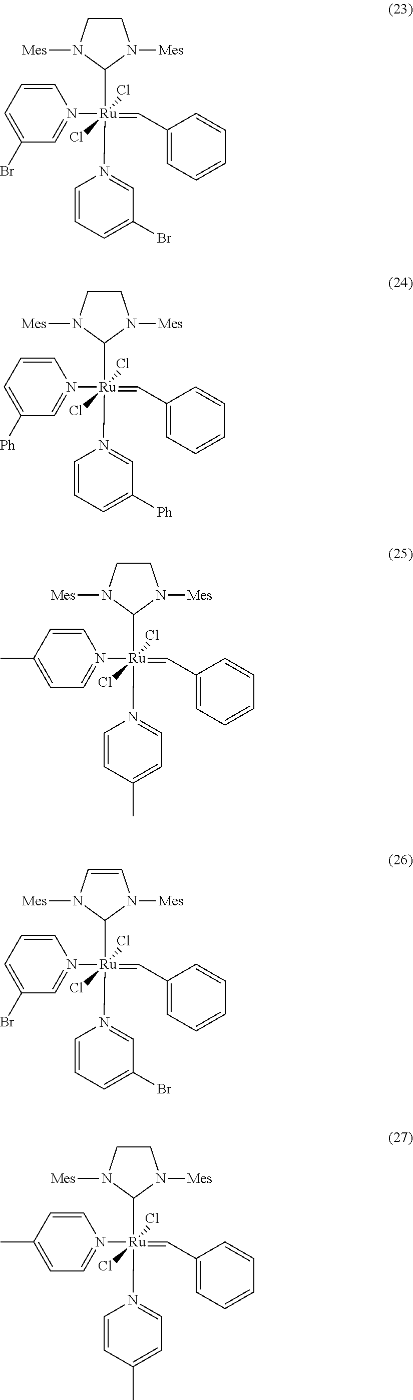

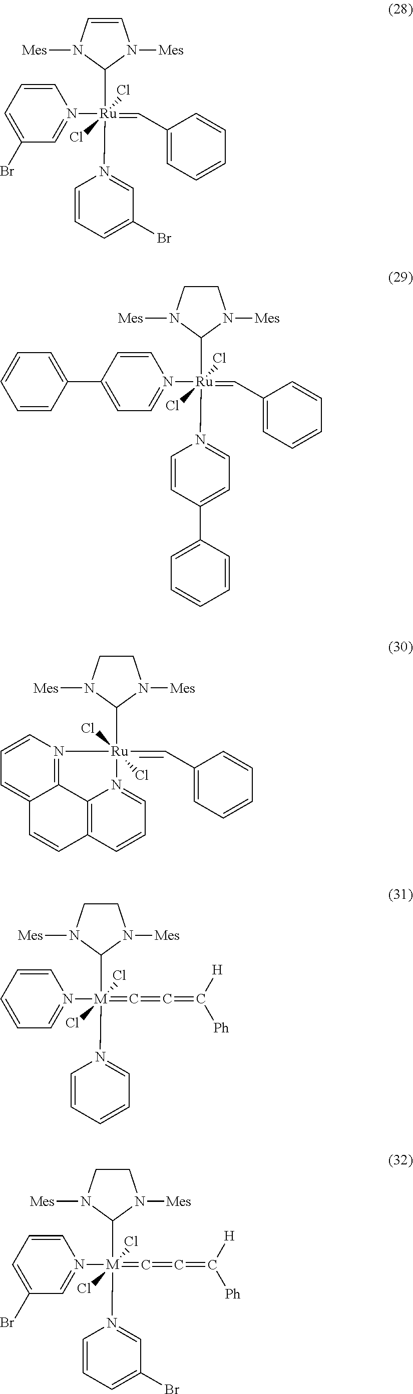

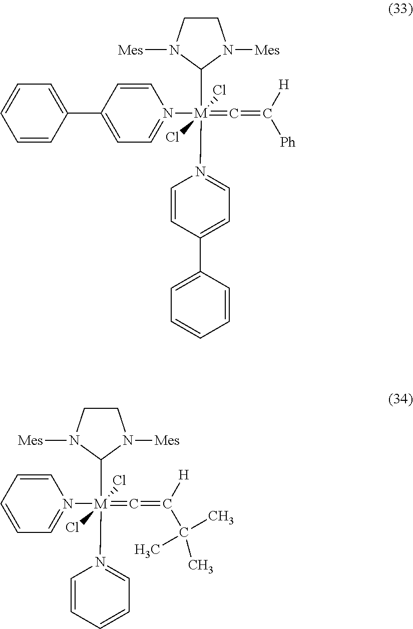

Also suitable are catalysts (R) having the general structural element (R1), where the carbon atom identified by “*” is bonded to the catalyst base skeleton via one or more doable bonds,

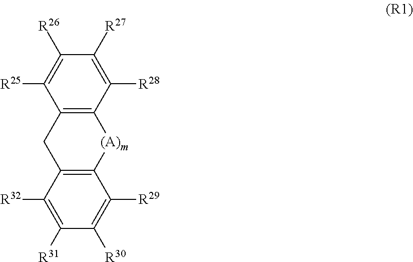

and in which
R²⁵-R³² are the same or different and mean each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃′), —OSO₃′, —PO₃′ or OPO₃′ mean, or are each alkyl, cycloalkyl, alkenyl, alkynyl, aryl, carboxylate, alkoxy, alkenyloxy, alkynyloxy, aryloxy, alkoxycarbonyl, alkylamino, alkylthio, arylthio, alkylsulphonyl, alkylsulphinyl, dialkylamino, alkylsilyl or alkoxysilyl, where all these radicals may each optionally be substituted by one or more alkyl, halogen, alkoxy, aryl or heteroaryl radicals, or alternatively two directly adjacent radicals in each case from the group of R²⁵-R³², including the ring carbon atoms to which they are bonded, are bridged to form a cyclic group, preferably an aromatic system, or alternatively R⁸ is optionally bridged with another ligand of the ruthenium- or osmium-carbene complex catalyst,
m is 0 or 1 and
A is oxygen, sulphur, C(R³³R³⁴), N-R³⁵, —C(R³⁶)═C(R³⁷)—, —C(R³⁶)(R³⁸)—C(R³⁷)(R³⁹)—, in which R³³-R³⁹ are the same or different and may each have the same definitions as the R²⁵-R³² radicals.

The inventive catalysts have the structural element of the general formula (R1), where the carbon atom identified by “*” is bonded to the catalyst base skeleton via one or more double bands. When the carbon atom identified by “*” is bonded to the catalyst base skeleton via two or more double bonds, these double bonds may be cumulated or conjugated.

Catalysts (R) of this kind are described in EP-A-2 027 920. The catalysts (R) with a structural element of the general formula (R1) include, for example, those of the following general formulae (R2a) and (R2b)

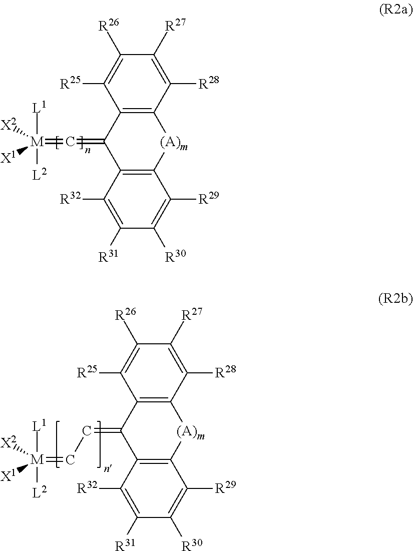

in which
M is ruthenium or osmium,
X¹ and X² are the same or different and are two ligands, preferably anionic ligands,
L¹ and L² are identical or different ligands, preferably uncharged electron donors, where L² may alternatively also be bridged to the R⁸ radical,
n is 0, 1, 2 or 3, preferably 0, 1 or 2,
n′ is 1 or 2, preferably 1, and
R²⁵-R³² , m and A each have the same definitions as in the general formula (R1).

In the catalysts of the general formula (R2a), the structural element of the general formula (R1) is bonded to the central metal of the complex catalyst via a double bond (n=0) or via 2, 3 or 4 cumulated double bonds (in the case that n=1, 2 or 3). In the inventive catalysts of the general formula (R2b), the structural element of the general formula (R1) is bonded to the metal of the complex catalyst via conjugated double bonds. In both cases, thesis is a doable bond in the direction of the central metal of the complex catalyst on the carbon atom identified by “*”.

The catalysts of the general formulae (R2a) and (R2b) thus include catalysts in which the following general structural elements (R3)-(R9)

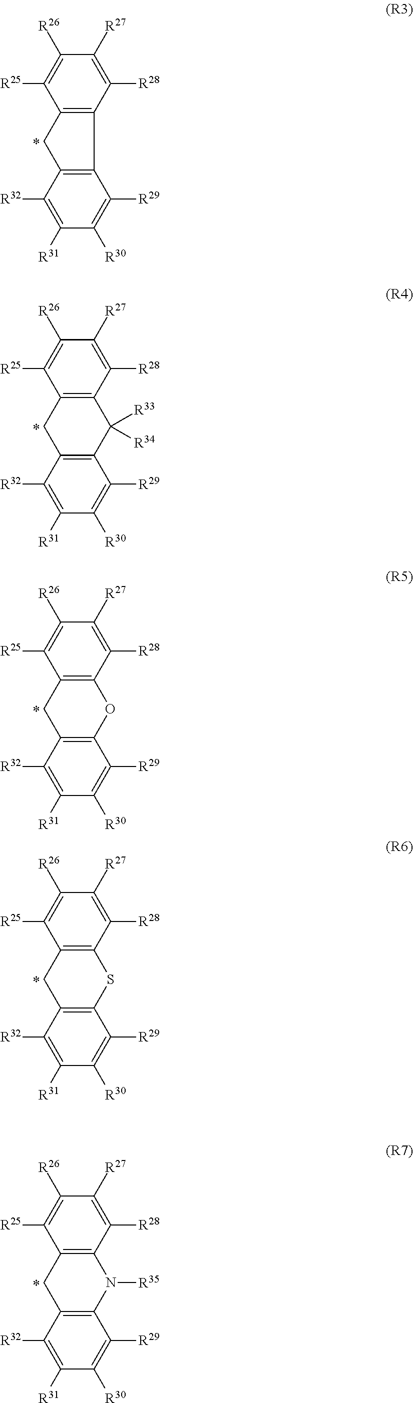

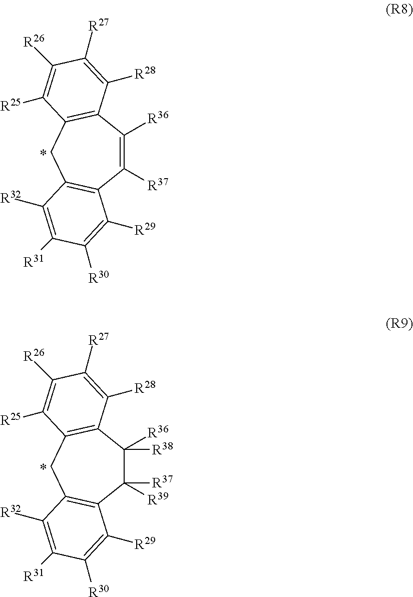

are bonded via the carbon atom identified by “*”, via one or more double bonds, to the catalyst base skeleton of the general formula (R10a) or (R10b)

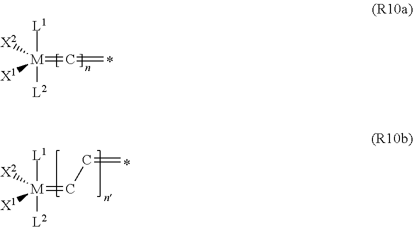

where X¹ and X², L¹ and L², n, n′ and R²⁵-R³⁹ are each as defined for the general formulae (R2a) and (R2b).

Typically, these ruthenium- or osmium-carbene catalysts are pentacoordinated.

In the structural element of the general formula (R1),
R¹⁵-R³² are the same or different and are each hydrogen, halogen, hydroxyl, aldehyde, keto, thiol, CF₃, nitro, nitroso, cyano, thiocyano, isocyanato, carbodiimide, carbamate, thiocarbamate, dithiocarbamate, amino, amido, imino, silyl, sulphonate (—SO₃′), —OSO₃′, —PO₃′ or OPO₃′, or are alkyl, preferably C₁-C₂₀-alkyl, especially C₁-C₆-alkyl, cycloalkyl, preferably C₃-C₂₀-cycloalkyl, especially C₃-C₈-cycloalkyl, alkenyl, preferably C₂C₂₀-alkenyl, alkynyl, preferably C₂-C₂₀-alkynyl, aryl, preferably C₆-C₂₄-aryl, especially phenyl, carboxylate, preferably C₁-C₂₀-carboxylate, alkoxy, preferably C₁-C₂₀-alkoxy, alkenyloxy, preferably C₂-C₂₀-alkenyloxy, alkynyloxy, preferably C₂-C₂₀-alkynyloxy, aryloxy, preferably C₆-C₂₄-aryloxy, alkoxycarbonyl, preferably C₂-C₂₀-alkoxycarbonyl, alkylamino, preferably C₁-C₃₀-alkylamino, alkylthio, preferably C₁-C₃₀-alkylthio, arylthio, preferably C₆-C₂₄-arylthio, alkylsulphonyl, preferably C₁-C₂₀-alkylsulphonyl, alkylsulphinyl, preferably C₁-C₂₀-alkylsulphinyl, dialkylamino, preferably di(C₁-C₂₀-alkyl)amino, alkylsilyl, preferably C₁-C₂₀-alkylsilyl, or alkoxysilyl, preferably C₁-C₂₀-alkoxysilyl, radicals, where all these radicals may optionally each be substituted by one or more alkyl, halogen, alkoxy, aryl or heteroaryl radicals, or alternatively also any two directly adjacent radicals from the group of R²⁵-R³², with inclusion of the ring carbon atoms to which they are bonded, may form a cyclic group by bridging, preferably an aromatic system, or alternatively R⁸ is optionally bridged with another ligand of the ruthenium- or osmium-carbene complex catalyst,
m is 0 or 1 and
A is oxygen, sulphur, C(R³³)(R³⁴), N—R³⁵, —C(R³⁶)═C(R³⁷)— or —C(R³⁶)(R³⁸)—C(R³⁷)(R³⁹)—, in which R³³-R³⁹ are the same or different and may each have the same preferred definitions as the R¹-R⁸ radicals.

C₁-C₆-Alkyl in the structural element of the general formula (R1) is, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl and n-hexyl.

C₃-C₈-Cycloalkyl in the structural element of the general formula (R1) is, for example, cyclopropyl, cyclobutyl, cyclopentyl, cyclohexyl, cycloheptyl and cyclooctyl.

C₆-C₂₄-Aryl in the structural element of the general formula (R1) comprises an aromatic radical having 6 to 24 skeleton carbon atoms. Preferred mono-, bi- or tricyclic carbocyclic aromatic radicals having 6 to 10 skeleton carbon atoms include, for example, phenyl, biphenyl, naphthyl, phenanthrenyl or anthracenyl.

The X¹ and X² radicals in the structural element of the general formula (R1) have the same general, preferred and particularly preferred definitions which are specified for catalysts of the general formula (C).

In the general formulae (R2a) and (R2b) and analogously (R10a) and (R10b), the L¹ and L² radicals are identical or different ligands, preferably uncharged electron donors, and may have the same general, preferred and particularly preferred definitions which are specified for the catalysts of the general formula (C).

Preference is given to catalysts of the general formula (R2a) or (R2b) with a general structural unit (N1) where
M is ruthenium,
X¹ and X² are both halogen,
n is 0, 1 or 2 in the general formula (R2a) or
n′ is 1 in the general formula (R2b)
L¹ and L² are the same or different and have the general or preferred definitions specified for the general formulae (R2a) and (R2b),
R²⁵-R³² are the same or different and have the general or preferred definitions specified for the general formulae (R2a) and (R2b),
m is either 0 or 1, and, when m=1,
A is oxygen, sulphur, C(C₁-C₁₀-alkyl)₂, —C(C₁-C₁₀-alkyl)₂, —C(C₁-C₁₀-alkyl)₂—, —C(C₁-C₁₀-alkyl)═C(C₁-C₁₀-alkyl)— or —N(C₁-C₁₀-alkyl).

Very particular preference is given to catalysts of the formula (R2a) or (R2b) with a general structural unit (R1) where
M is ruthenium,
X¹ and X² are both chlorine,
n is 0, 1 or 2 in the general formula (R2a) or
n′ is 1 in the general formula (R2b)
L¹ is an imidazoline radical of the formulae (5a) to (5f),
L²is a sulphonated phosphine, phosphate, phosphinite, phosphorate, arsine, stibine, ether, amine, amide, sulphoxide, carboxyl, nitrosyl, or pyridine radical, an imidazoline or imidazoline radical of the formulae (5a) to (5f) or a phosphine ligand, especially PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(isopropyl)₃, P(CHCH₃(CH₂CH₃))₃, P(cyclopentyl)₃, P(cyclohexyl)₃, P(neopentyl)₃ and P(neophenyl)₃,
R²⁵-R³² have the general or preferred definitions specified for the general formulae (R2a) and (R2b),
m is either 0 or 1, and, when m=1,
A is oxygen, sulphur, C(C₁-C₁₀-alkyl)₂, —C(C₁-C₁₀-alkyl)₂—C(C₁-C₁₀-alkyl)₂—, —C(C₁-C₁₀-alkyl)═C(C₁-C₁₀-alkyl)— or —N(C₁-C₁₀-alkyl).

In the case that the R²⁵ radical is bridged with another ligand of the catalyst of the formula R, for example for the catalysts of the general formulae (R2a) and (R2b), this gives rise to the following structures of the general formulae (R13a) and (R13b)

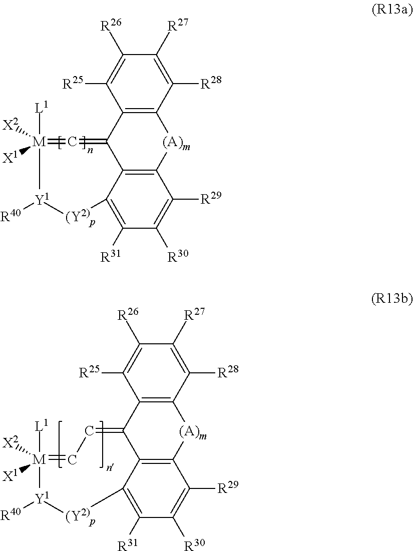

in which
Y¹ is oxygen, sulphur, an N—R⁴¹ radical or a P—R⁴¹ radical, where R⁴¹ is as defined below,
R⁴⁰ and R⁴¹ are the same or different and are each an alkyl, cycloalkyl, alkenyl, alkynyl, aryl, alkoxy, alkenyloxy, alkynyloxy, aryloxy, alkoxycarbonyl, alkylamino, alkylthio, arylthio, alkylsulphonyl or alkylsulphinyl radical, all of which may each optionally be substituted by one or more alkyl, halogen, alkoxy, aryl or heteroaryl radicals,
p is 0 or 1 and
Y² when p=1 is —(CH₂)ᵣ— where r=1, 2 or 3, —C(═O)—CH₂—, —C(═O)—, —N═CH—, —N(H)—C(═O)—, or else alternatively the overall structural unit “—Y¹(R⁴⁰)—(Y²)ₚ—” is (—N(R⁴⁰)═CH—CH₂—), (—N(R⁴⁰, R⁴¹)═CH—CH₂—), and
   where M, X¹, X², L¹, R²⁵-R³², A, m and n have the same definitions as in the general formulae (R10a) and (R10b).

Examples of catalysts of the general formula (R) include the following structures (35) to (45):

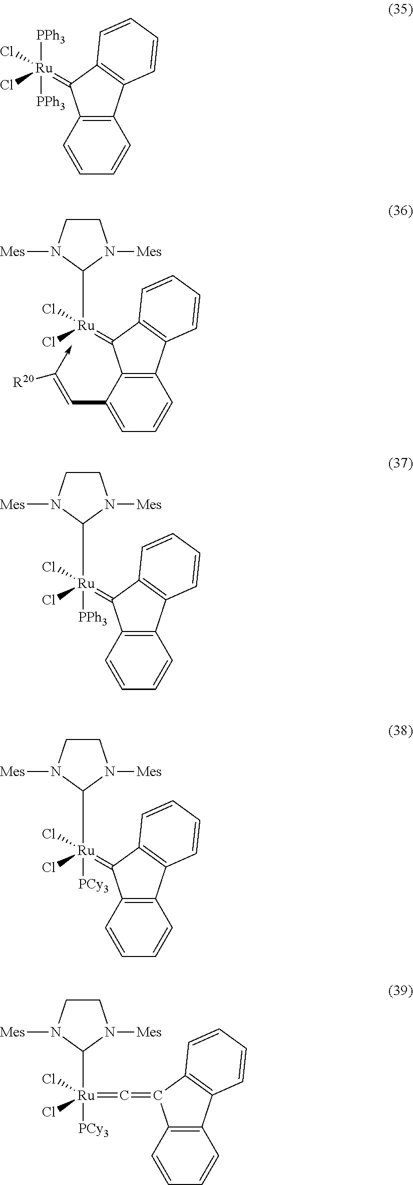

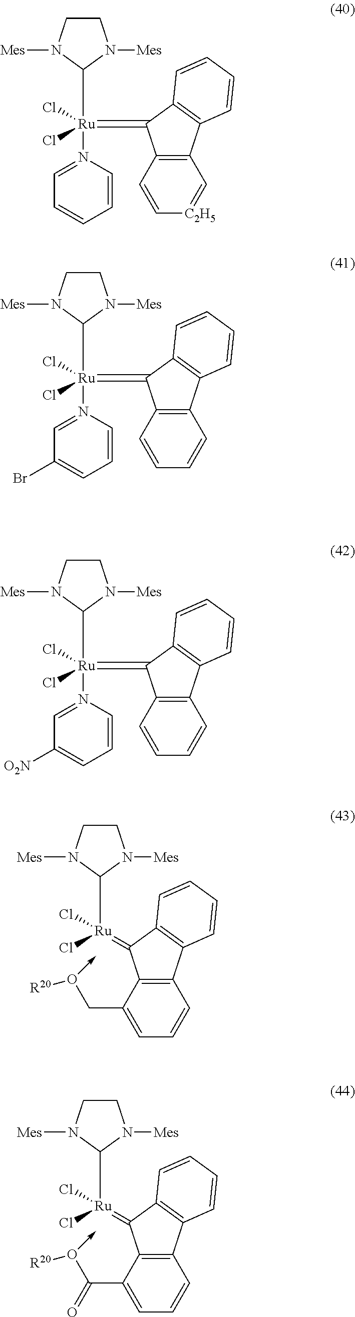

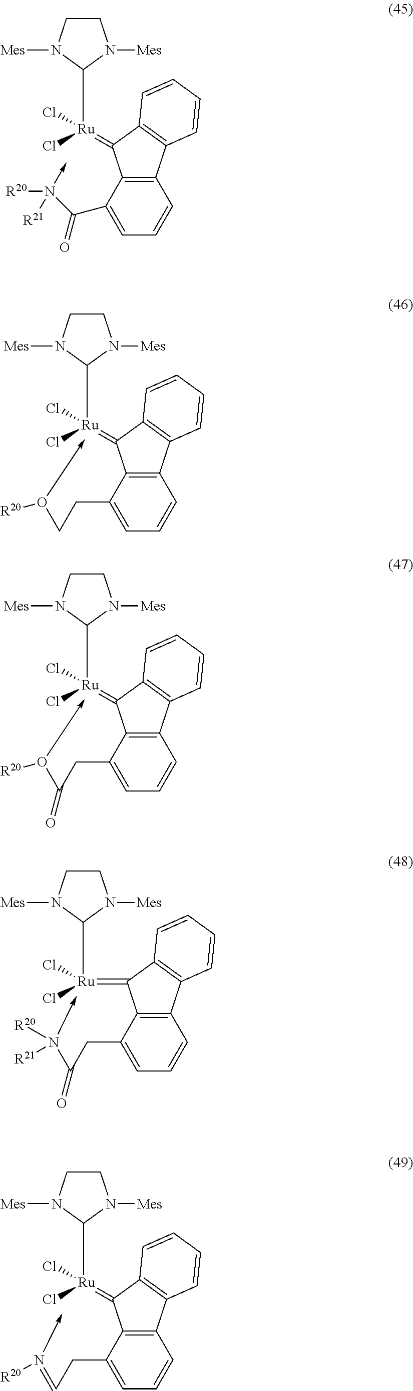

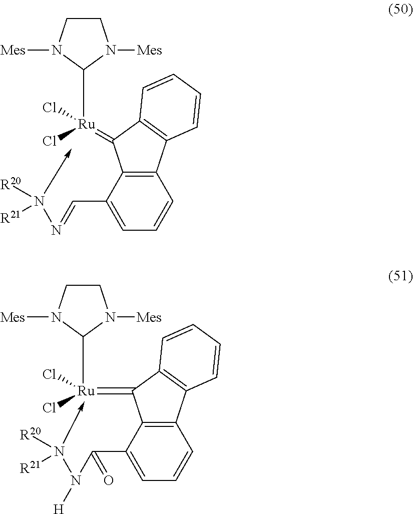

The preparation of catalysts of the general formula (R) is known from EP-A-2 027 920.

Additionally suitable are catalysts according to the general formula (T)

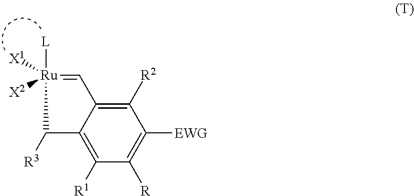

in which
X¹ and X² are the same or different and are each anionic ligands, or alternatively are joined to one another via carbon-carbon and/or carbon-heteroatom bonds,
Y is an uncharged two-electron donor selected from O, S, N and P,
R are H, halogen, alkyl, alkoxy, aryl, aryloxy, alkylcarbonyl, arylcarbonyl, alkoxycarbonyl, aryloxycarbonyl, heteroaryl, carboxyl (RCO₂′), cyano, nitro, amido, amino, aminosulphonyl, N-heteroarylsulphonyl, alkylsulphonyl, arylsulphonyl, alkylsulphinyl, arylsulphinyl, alkylthio, arylthio or sulphonamide,
R¹ and R² are each H, Br, I, alkyl, alkoxy, aryl, aryloxy, alkylcarbonyl, arylcarbonyl, alkoxycarbonyl, aryloxycarbonyl, carboxyl, amido, amino, heteroaryl, alkylthio, arylthio, or sulphonamido,
R³ are alkyl, aryl, heteroaryl, alkylcarbonyl, arylcarbonyl, thiocarbonyl, or aminocarbonyl,
EWG is an electron-withdrawing group selected from the group consisting of aminosulphonyl, amidosulphonyl, N-heteroarylsulphonyl, arylsulphonyl, arylsulphinyl, arylcarbonyl, alkylcarbonyl, aryloxycarbonyl, aminocarbonyl, amido, sulphonamido, chlorine, fluorine, H, or haloalkyl and
L is an electron-donating ligand which can be joined to X¹ via carbon-carbon and/or carbon-heteroatom bonds.

These catalysts of the general formal a (T) axe known from US 2007/0043180.

Preference is given to catalysts of the general formula (T) in which X¹ and X² are selected from an ionic ligand in the form of halides, carboxylates and aryl oxides. More preferably, X¹ and X² are both halides, especially both chlorides. In the general formula (T), Y is preferably oxygen. R is preferably H, halogen, alkoxycarbonyl, aryloxycarbonyl, heteroaryl, carboxyl, amido, alkylsulphonyl, arylsulphonyl, alkylthio, arylthio or sulphonamido. More particularly, R is H, Cl, F or a C₁₋₈ alkoxycarbonyl group. R¹ and R² are the same or different and are preferably each H, alkoxy, aryl, aryloxy, alkoxycarbonyl, amido, alkylthio, arylthio or a sulphonamido group. More particularly, R¹ H or an alkoxy group and R² is hydrogen. In the general formula (T), R³ is preferably an alkyl, aryl, heteroaryl, alkylcarbonyl or arylcarbonyl group. More preferably, R³ is isopropyl, sec-butyl and methoxyethyl. In the general formula (T), EWG is preferably an aminosulphonyl, amidosulphonyl, N-heteroarylsulphonyl, arylsulphonyl, aminocarbonyl, arylsulphonyl, alkylcarbonyl, aryloxycarbonyl, halogen or haloalkyl group. More preferably, EWG is a C₁-C₁₂ N-alkylaminosulphonyl, C₂₋₁₂ N-heteroarylsulphonyl, C₁₋₁₂ aminocarbonyl, C₆₋₁₂ arylsulphonyl, C₁₋₁₂ alkylcarbonyl, C₆₋₁₂ arylcarbonyl, C₆₋₁₂ aryloxycarbonyl, Cl, F or trifluoromethyl group. In the general formula (T), L is an electron-donating ligand selected from phosphines, amino, aryl oxides, carboxylates and heterocyclic carbene radicals which may be bonded to X¹ via carbon-carbon and/or carbon-heteroatom bonds.

A particularly suitable catalyst is one of the general formula (T) in which L is a heterocyclic carbene ligand or a phosphine (P(R⁸)₂(R⁹) having the following structures:

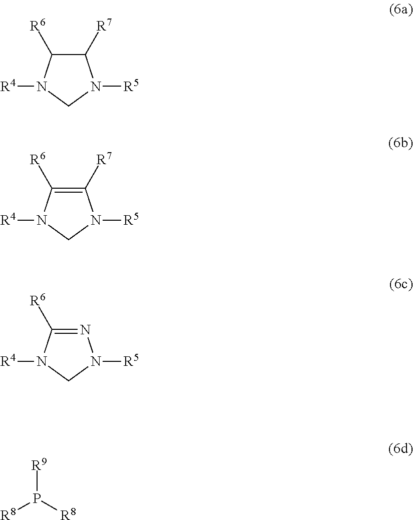

in which
R⁴ and R⁵ are the same or different and are each C₆₋₁₂ aryl and
R⁶ and R⁷ are the same or different and are each H, halogen, alkyl, alkoxy, aryl, aryloxy, alkylcarbonyl, arylcarbonyl, alkoxycarbonyl, aryloxycarbonyl, heteroaryl, carboxyl, cyano, nitro, amido, amino, alkylsulphonyl, arylsulphonyl, alkylsulphinyl, arylsulphinyl, alkylthio or sulphonamido and
R⁸ and R⁹ are the same or different and are each C₁₋₈ alkyl or C₆₋₁₂ aryl.

Additionally suitable are bimetallic complexes of the general formula (U)

M¹ₐM²_{b}Xₘ(L¹)ₙ (U)

in which
M¹ is rhodium (Rh) or ruthenium (Ru),
M² ruthenium (Ru) or a lanthanide,
   where, when M¹ is rhodium (Rh), M² is ruthenium (Ru) or a lanthanide and, when M¹ is ruthenium (Ru), M² is a lanthanide,
X are the same or different and are each H, Cl or Br,
L¹ is an organophosphine (PR¹R²R³), diphosphine (R¹R²(CH₂)ₙPR³R⁴), organoarsine (AsR¹R²R³) or other organic compounds containing nitrogen, sulphur, oxygen atoms or mixtures thereof, where R¹, R², R³ and R⁴ are the same or different and are each C₁-C₆ alkyl, C₆-C₁₂ cycloalkyl, aryl, C₃-C₁₂ aralkyl or aryloxy groups,

1≦a≦4,

1≦b≦2,

3≦m≦6 and

6≦n≦15.

These catalysts of the general formula (U) are known in principle from U.S. Pat. No. 6,084,033.

Particularly suitable catalysts are those of the general formula (U) in which M¹ is rhodium and M² is ruthenium. Other particularly suitable catalysts are those of the general formula (U) in which M² is a lanthanide, especially Ce or La. In particularly suitable catalysts of the general formula (U), X are the same or different and are each H or Cl. Particularly suitable catalysts of the general formula (U) are those in which L¹ is selected from trimethylphosphine, triethylphosphine, triphenylphosphine, triphenoxyphosphine, tri(p-methoxyphenyl)phosphine, diphenylethylphosphine, 1,4-di(diphenylphosphano)butane, 1,2-di(diphenylphosphano)ethane, triphenylarsine, dibutylphenylarsine, diphenylethylarsine, triphenylamine, triethylamine, N,N-dimethylaniline, diphenyl thioether, dipropyl thioether, N,N′-tetramethylethylenediamine, acetylacetone, diphenyl ketones and mixtures thereof.

Further catalysts which can be used are described in U.S. Pat. No. 3,700,637, DE-A-25 39 132, EP-A 134 023, DE-A 35 41 689, DE 3540918, EP-A-0 298 386, DE-A 3529252, DE-A 3433 392, U.S. Pat. No. 4,464,515, U.S. Pat. No. 4,503,196 and EP-A-1 720 920.

Amount of hydrogenation catalyst:

For the hydrogenation of the nitrile rubber, the hydrogenation catalyst can be used within a wide range of amounts. Typically, the catalyst is used in an amount of 0.001 to 1.0% by weight, preferably from 0.01 to 0.5% by weight, especially 0.05 to 0.3% by weight, based on the nitrile rubber to be hydrogenated.

Other hydrogenation conditions:

The practical performance of the hydrogenation is well known to those skilled in the art, for example from U.S. Pat. No. 6,683,136A,

Solvent:

The hydrogenation is typically effected in a solvent, preferably art organic solvent. Suitable organic solvents are, for example, acetone, methyl ethyl ketone, ethyl acetate, tetrahydrofuran, 1,3-dioxane, benzene, toluene, methylene chloride, chloroform, monochlorobenzene and dichlorobenzene. Monochlorobenzene has been found to be particularly useful, since it is a good solvent both for nitrile rubbers having different nitrile contents and for the corresponding resulting hydrogenated nitrile rubbers.

Nitrile rubber concentration:

For the hydrogenation, nitrile rubber is typically dissolved in at least one solvent. The concentration of the nitrile rubber in the hydrogenation is generally in the range of 1-30% by weight, preferably in the range of 5-25% by weight, more preferably in the range of 7-20% by weight.

The pressure in the hydrogenation is typically within the range from 0.1 bar to 250 bar, preferably from 5 bar to 200 bar, more preferably from 50 bar to 150 bar. The temperature is typically within the range from 0° C. to 180° C., preferably from 20° C. to 160° C., more preferably from 50 C. to 150° C. The reaction time is generally 2 to 10 h.

In the course of the hydrogenation, the double bonds present in the nitrile rubber used are hydrogenated to the desired extent as already disclosed in the preceding parts of the application.

The hydrogenation is monitored online by determining the hydrogen absorption or by Raman spectroscopy (EP-A-0 897 933) or IR spectroscopy (U.S. Pat. No. 6,522,488). A suitable IR method for offline determination of the hydrogenation level is additionally described by D. Brück in Kautsehuke+Gummi, Kunststoffe, Vol. 42, (1989), No. 2, p. 107-110 (part 1) and in Katsfschuke+Gummi, Kunststoffe, Vol. 42. (1989), No. 3, p. 194-197.

On attainment of the desired hydrogenation level, the reactor is decompressed. Residual amounts of hydrogen are typically removed by nitrogen purging.

Before the isolation of the hydrogenated nitrile rubber from the organic phase, the hydrogenation catalyst can be removed. A preferred process for rhodium recovery is described, for example, in U.S. Pat. No. 4,985,540.

If the hydrogenation in the process according to the invention is effected with addition of a phosphine or diphosphine, these are typically used in amounts of 0.1 to 10% by weight, preferably of 0.25 to 5% by weight, more preferably 0.5 to 4% by weight, even more preferably 0.75 to 3.5% by weight and especially 1 to 3% by weight, based on the nitrile rubber to be hydrogenated.

Based on 1 equivalent of the hydrogenation catalyst, the phosphine or diphosphine, in a tried and tested manner, is used in an amount in the range from 0.1 to 10 equivalents, preferably in the range from 0.2 to 5 equivalents and more preferably in the range from 0.3 to 3 equivalents.

The weight ratio of the added phosphine or diphosphine to the hydrogenation catalyst is typically (1-100):1, more preferably (3-30):1, especially (5-15):1.

On completion of the hydrogenation, a hydrogenated nitrile rubber having a Mooney viscosity (ML 1+4@100° C.), measured to ASTM Standard D 1646, in the range of 1-50 is obtained. This corresponds roughly to a weight-average molecular weight M_{w} in the range of 2000-400 000 g/mol. Preferably, the Mooney viscosity (ML 1+4@100° C.) is in the range from 5 to 30. This corresponds roughly to a weight-average molecular weight M_{w} in the range of about 20 000-200 000. The hydrogenated nitrile rubbers obtained also have a polydispersity PDI=M_{w}/Mₙ, where M_{w} is the weight-average and Mₙ the number-average molecular weight, in the range of 1 -5 and preferably in the range of 1.5-3.

It is also possible to subject the nitrile rubber to a metathesis reaction before the hydrogenation, in order to lower the molecular weight of the nitrile rubber. The metathesis of nitrile rubbers is sufficiently well known to those skilled in the art. If a metathesis is effected, it is also possible to conduct the subsequent hydrogenation in situ, i.e. in the same reaction mixture in which the metathesis degradation has also been effected beforehand and without the need to isolate the degraded nitrile rubber. The hydrogenation catalyst is simply added to the reaction vessel.

### Step 2

In step 2, the phosphine- or diphosphine-containing hydrogenated nitrile rubber obtained in the hydrogenation is contacted with the sulphur compound which does not have two sulphur atoms bonded directly to one another. This results in formation of the phosphine oxide or diphosphine oxide from the phosphine or diphosphine and hence in reduction extending as far as the complete removal of the amount of phosphine or diphosphine.

The phosphine- or diphosphine-containing hydrogenated nitrile rubber may either be in dissolved form or in solid form on contact with the sulphur compound. The two following alternative embodiments, for example, have been found to be useful:

In a first embodiment, the sulphur compound can be added after the end of the hydrogenation and before or during the isolation of the hydrogenated nitrile rubber from the hydrogenation reaction mixture. Suitable methods for the isolation of the hydrogenated nitrile rubber from the organic solution are the vaporization of the organic solvent by the action of heat or of reduced pressure or by steam distillation. Preference is given to effecting a steam distillation. In this case, the subsequent removal of the rubber crumbs from the aqueous dispersion is effected by sieving and final mechanical and/or thermal drying. Preference is given to steam distillation. Depending on the pressure employed, the latter is conducted at a reaction temperature of typically 80 to 120 C., preferably about 100° C.

It has been found to be useful to add the sulphur compound in organic or aqueous solution before or during the isolation of the hydrogenated nitrile rubber.

If the sulphur compound is oil-soluble, the sulphur compound is added to the hydrogenation reaction mixture in dissolved form, in which case the solvent for the solution of the sulphur compound is appropriately identical to the solvent in which the phosphine- or diphosphine-containing hydrogenated nitrile rubber is present.

If the sulphur compound is water-soluble, it is added to the hydrogenation reaction mixture as an aqueous solution and mixed well therewith.

Optionally, the addition of the sulphur compound may be preceded by a catalyst recovery.

In a second embodiment, the phosphine- or diphosphine-containing hydrogenated nitrile rubber can be admixed and converted in the solid state with at least one above-defined sulphur compound. In this form, it can be obtained by isolation from the hydrogenation reaction mixture. In that case, the phosphine- or diphosphine-containing hydrogenated nitrile rubber is in a substantially solvent-free state. Useful equipment for this embodiment has been found to be roll mills, internal mixers or extruders. Preference is given to using a roll mill or an internal mixer. A typical, commercially available roll mill is thermostatable and has two contra-rotating rolls. The sulphur compound is incorporated with selection of a suitable roll temperature, for example in the range of 10-30° C., preferably at 20° C.±3° C., and of a suitable rotation speed, preferably in the range of 25 to 30 min⁻¹, of a suitable roll nip, for example in the region of a few millimetres, and of a suitable rolling time, which is generally a few minutes. The milled rubber sheet obtained is subsequently typically cut and folded over and optionally applied to the roll once again.

In this embodiment, the sulphur compound is typically also used in solid form.

The reaction of the phosphines or diphosphines with the sulphur compound to give phosphine oxides or diphosphine oxides is effected at suitable temperatures depending on the reactivity of the sulphur compound used. The reaction temperatures are preferably within the range from 10° C. to 150° C., more preferably within the range from 80° C. to 120° C. and especially within the range from 90° C. to 110° C. The reaction time for the reaction is typically within the range from 1 min to 5 h and can be determined by the person skilled in the art depending on the temperature selected.

The amounts of sulphur compound (as defined hereinafter) are guided by the amount of the phosphine/diphosphine which has been used in the hydrogenation. For substantial conversion of the phosphine/diphosphine, the molar ratio of sulphur compound (as defined hereinafter) to phosphine/diphosphine should be at least 0.5:1, preferably (0.5-2):1.

### Sulphur Compound

In the process according to the invention, at least one sulphur compound which does not have two sulphur atoms bonded directly to one another is used.

Suitable examples are the sulphur compounds of the general structural formulae (1)-(10)

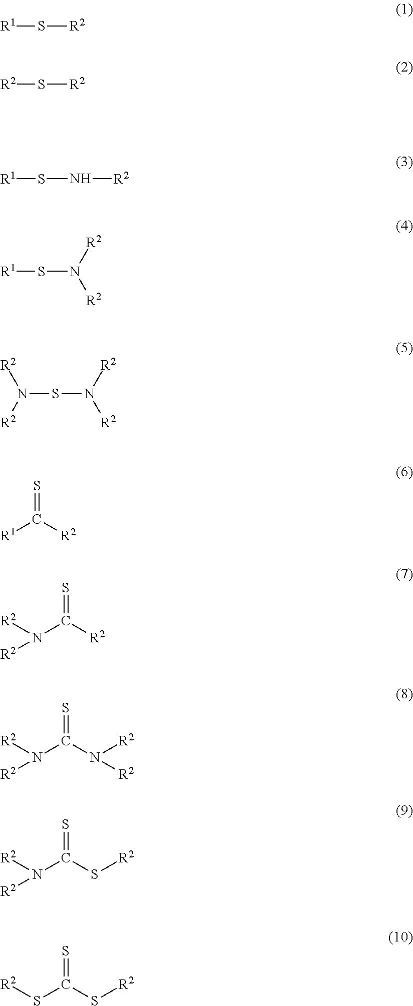

in which
R¹ may be a linear or branched, aliphatic, cycloaliphatic or aromatic radical which may contain up to 10 heteroatoms selected from the group consisting of nitrogen, oxygen, sulphur and phosphorus, with the proviso that, when sulphur is present as heteroatom, it does not directly adjoin any further sulphur atom in the compound,

R² is the same or different and is hydrogen, an alkali metal, alkaline earth metal, ammonium or substituted ammonium, phosphonium or substituted phosphonium, or a linear, branched, aliphatic, cycloaliphatic or aromatic radical which may contain up to 10 heteroatoms selected from the group consisting of nitrogen, oxygen, sulphur and phosphorus, likewise with the proviso that, when sulphur is present as heteroatom, it does not directly adjoin any further sulphur atom in the compound, or alternatively

R¹ and R² or else two R² may form a cyclic system incorporating the atoms to which they are bonded.

If R² assumes definitions such as alkali metal or alkaline earth metal where there is no covalent bond to the next atom in the sulphur compound but instead an ionic bond, the formulae represented above by the covalent bonds should also cover such ionic bonding conditions.

Preference is given to sulphur compounds of the general structural formulae (1) to (10) in which
R¹ is alkyl, more preferably C₁-C₁₈-alkyl, alkenyl, more preferably vinyl or allyl, alkadienyl, more preferably butadienyl or pentadienyl, alkoxy, more preferably methoxy, ethoxy, n-propoxy, isopropoxy, n-butoxy, sec-butoxy, tert-butoxy, n-pentoxy and n-hexoxy, aryl, more preferably C₆-C₁₂-aryl, heteroaryl, more preferably pyridinyl, oxazolyl, benzofuranyl, dibenzofuranyl and quinolinyl, cycloalkyl, more preferably C₃-C₈-cycloalkyl, cycloalkenyl, more preferably C₅-C₈ cycloalkenyl, or cycloalkadienyl, more preferably cyclopentadienyl or cyclohexadienyl, and
R² is hydrogen, alkyl, more preferably C₁-C₁₈-alkyl, alkenyl, more preferably vinyl or allyl, alkadienyl, more preferably butadienyl or pentadienyl, alkoxy, more preferably methoxy, ethoxy, n-propoxy, isopropoxy, n-butoxy, sec-butoxy, tert-butoxy, n-pentoxy and n-hexoxy, aryl, more preferably C₆-C₁₂-aryl, heteroaryl, more preferably pyridinyl, oxazolyl, benzofuranyl, dibenzofuranyl and quinolinyl, cycloalkyl, more preferably C₃-C₈-cycloalkyl, cycloalkenyl, more preferably C₅-C₈ cycloalkenyl, or cycloalkadienyl, more preferably cyclopentadienyl or cyclohexadienyl.

All the aforementioned R¹ and R² radicals may be mono- or polysubstituted.

With regard to the R¹ and R² radicals, the following definitions are typically possible and are preferred:

Alkyl is typically a straight-chain or branched C₁-C₃₀-alkyl radical, preferably C₁-C₃₀alkyl radical, more preferably C₁-C₁₈-alkyl radical. C₁-C₁₈-Alkyl includes, for example, methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, 1,1-dimethylpropyl, 1,2-dimethylpropyl, n-hexyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, n-octyl, n-nonyl, n-decyl, n-undexyl, n-dodecyl, n-tridecyl, n-tetradecyl, n-hexadecyl and n-octadecyl.

All the aforementioned alkyl radicals may be mono- or polysubstituted, for example by C₅-C₂₄-aryl radicals, preferably phenyl, halogen, more preferably fluorine, chlorine or bromine, CN, OH, NH₂ or NR′₂ radicals, where R′ in turn may be C₁-C₃₀-alkyl or C₅-C₂₄-aryl.

Alkenyl as a definition of R¹ and R² in the general formulae (1)-(10) is typically C₃-C₃₀-alkenyl, preferably C₂-C₂₀-alkenyl. The alkenyl radical is especially preferably a vinyl radical or an allyl radical.

Alkadienyl as a definition of R¹ and R² in the general formulae (1)-(10) is typically C₄-C₃₀-alkadienyl, preferably C₄-C₂₀-alkadienyl. The alkadienyl radical is especially preferably butadienyl or pentadienyl

Alkoxy as a definition of R¹ and R² in the general formulae (1)-(10) is typically C₁-C₂₀-alkoxy, preferably C₁-C₁₀-alkoxy, more preferably methoxy, ethoxy, n-propoxy, isopropoxy, n-butoxy, sec-butoxy, tert-butoxy, n-pentoxy and n-hexoxy.

Aryl as a definition of R¹ and R² in the general formulae (1)-(10) is typically a C₅-C₂₄-aryl radical, preferably a C₆-C₁₄-aryl radical, especially preferably a C₆-C₁₂-aryl radical. Examples of C₅-C₂₄-aryl are phenyl, o-, p-, m-tolyl, naphthyl, phenanthrenyl, anthracenyl and fluorenyl.

All the aforementioned radicals may, provided that this leads to chemically stable compounds, also be mono- or polysubstituted, for example by straight-chain or branched C₁-C₃₀-alkyl (in the case of an aryl radical, the result is then what are called alkaryl radicals), halogen, preferably fluorine, chlorine or bromine, sulphonate (SO₃Na), straight-chain or branched C₁-C₃₀-alkoxy, preferably methoxy or ethoxy, hydroxyl, NH₂ or NR′₂ radicals where R′ may in turn be straight-chain or branched C₁-C₃₀-alkyl or C₅-C₂₄-aryl, or by further C₅-C₂₄-aryl radicals, such that one or more of the R″ radicals may then be a biphenyl or binaphthyl radical which may optionally be mono- or polysubstituted in turn by all the aforementioned substituents.

Heteroaryl as a definition of R¹ and R² in the general formulae (1)-(10) is as defined for an aryl, except that one or more of the skeleton carbon atoms are replaced by a heteroatom selected from the group of nitrogen, sulphur and oxygen. Examples of such heteroaryl radicals are pyridinyl, oxazolyl, benzofuranyl, dibenzofuranyl and quinolinyl.

Cycloalkyl as a definition of R¹ and R² in the general formulae (1)-(10) is preferably a C₃-C₂₀-cycloalkyl radical, more preferably a C₃-C₈-cycloalkyl radical and especially preferably cyclopentyl and cyclohexyl.

Cycloalkenyl as a definition of R¹ and R² in the general formulae (1)-(10) is a ring skeleton having a C═C double bond, preferably C₅₋-C₈ cycloalkenyl, more preferably cyclopentenyl or cyclohexenyl

Cycloalkadienyl as a definition of R¹ and R² in the general formulae (1)-(10) is a ring skeleton having two C═C double bonds, preferably C₅-C₈ cycloalkadienyl, more preferably cyclopentadienyl or cyclohexadienyl.

Examples of sulphur compounds of this kind tor use in accordance with the invention are n-butyl mercaptan, tert-butyl mercaptan, n-hexyl mercaptan, n-dodecyl mercaptan, tert-dodecyl mercaptan, benzyl mercaptan, dibenzyl sulphide, 2-mercaptobenzothiazole, 2-morpholinobenzothiazole, N-cyclohexyl-2-benzothiazylsulphenamide, N,N-dicyclohexylbenzothiazylsulphenamide, N-tert-butyl-2-benzothiazylsulphenamide and N-cyclohexylthiophthalimide.

Preference is given to the sulphur compounds shown in the following images:

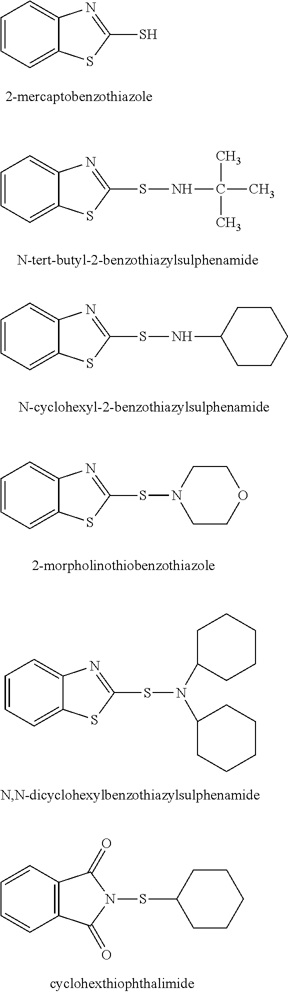 [SMILES: Sc1nc2ccccc2s1 ; CC(C)(C)NSc1nc2ccccc2s1 ; c1ccc2sc(SNC3CCCCC3)nc2c1 ; c1ccc2sc(SN3CCOCC3)nc2c1 ; c1ccc2sc(SN(C3CCCCC3)C3CCCCC3)nc2c1 ; O=C1c2ccccc2C(=O)N1SC1CCCCC1]

### Amount of the Stalphur Compound

The amount of sulphur compound used is calculated on the basis of the amount of phosphine or diphosphine present in the hydrogenation of the nitrile rubber. The molar amount of sulphur compound (calculated as S) is preferably 5 to 300%, preferably 50 to 150%, more preferably 75 to 125%, of the molar amount of the phosphine or diphosphine present in the hydrogenation beforehand.

In % by weight, the sulphur compound, again calculated as sulphur, is preferably added after the hydrogenation in an amount of 5 to 25% by weight, preferably 7 to 20% by weight, especially 10 to 15% by weight, based on 100% by weight of the phosphine or diphosphine present beforehand in the hydrogenation.

The process according to the invention converts the phosphines or diphosphines to phosphine oxides or diphosphine oxides preferably to an extent of at least 50%, more preferably to an extent of at least 80%, especially to an extent of at least 95%. It is possible to conduct the conversion of the phosphine/diphosphine virtually quantitatively or even quantitatively.

Correspondingly, the content of phosphines or diphosphines, based on the sum total of (i) phosphine oxides or diphosphine oxides and (is) phosphine or diphosphine in the hydrogenated nitrile rubber, is preferably less than 50 mol %, more preferably less than 20 mol %, especially less than 5 mol %. Complete removal is also possible.

The determination of the triphenylphosphine (TPP) and triphenylphosphine oxide (TPP═O) content in the hydrogenated nitrile rubber is effected by the methodology specified in the examples.

Even without addition of sulphur compounds after the hydrogenation, small traces of phosphine oxides may form in individual cases, but these are well below 0.25% by weight, based on the hydrogenated nitrile rubber. As is also apparent from the examples, it is only the controlled addition of sulphur compounds to the hydrogenated nitrile rubber that leads to the advantages of the invention through the conversion of phosphines or diphosphines to phosphine oxides and diphosphine oxides.

The invention further provides vulcanizable mixtures comprising at least one inventive hydrogenated nitrile rubber and at least one crosslinking system. In addition, these vulcanizable mixtures may also comprise one or more further typical rubber additives.

These vulcanizable mixtures are produced by mixing at least one inventive hydrogenated nitrile rubber (i) with at least one crosslinking system (ii) and optionally one or more further additives.

The crosslinking system comprises at least one crosslinker and optionally one or more crosslinking accelerators.

Typically, the inventive hydrogenated nitrile rubber is first mixed with all the additives selected, and the crosslinking system composed of at least one crosslinker and optionally a crosslinking accelerator is the last to be mixed in.

Useful crosslinkers include, for example, peroxidic crosslinkers such as bis(2,4-dichlorobenzyl) peroxide, dibenzoyl peroxide, bis(4-chlorobenzoyl) peroxide, 1,1-bis(t-butylperoxy)-3,3,5-trimethylcyclohexane, tert-butyl perbenzoate, 2,2-bis(t-butylperoxy)butene, 4,4-di-tert-butyl peroxynonylvalerate, dicumyl peroxide, 2,5-dimethyl-2,5-di(t-butylperoxy)hexane, tert-butyl cumyl peroxide, 1,3-bis(t-butylperoxyisopropyl)benzene, di-t-butyl peroxide and 2,5-dimethyl-2,5-di(t-butylperoxy)-3-hexyne.

It may be advantageous to use, as well as these peroxidic crosslinkers, also further additions which can help to increase the crosslinking yield: suitable examples thereof include triallyl isocyanurate, triallyl cyanurate, trimethylolpropane tri(meth)acrylate, triallyltrimellitate, ethylene glycol dimethacrylate, butanediol dimethacrylate, trimethylolpropane trimethacrylate, zinc diacrylate, zinc dimethacrylate, 1,2-polybutadiene or N,N′-m-phenylenedimaleimide.

The total amount of the crosslinker(s) is typically in the range from 1 to 20 phr, preferably in the range from 1.5 to 15 phr and more preferably in the range from 2 to 10 phr, based on the fully or partly hydrogenated nitrile rubber.

The crosslinkers used may also be sulphur in elemental soluble or insoluble form, or sulphur donors. Useful sulphur donors include, for example, dimorpholyl disulphide (DTDM), 2-morpholinodithiobenzothiazole (MBSS), caprolactam disulphide, dipentamethylenethiuram tetrasulphide (DPTT) and tetramethylthiuram disulphide (TMTD).

It is also possible to use further additions which can help to increase the crosslinking yield in the sulphur vulcanization of the hydrogenated nitrile rubbers. In principle, the crosslinking can also be effected with sulphur or sulphur donors alone.

Suitable additions which can help to increase the crosslinking yield are, for example, dithiocarbamates, thiurams, thiazoles, sulphenamides, xanthogenates, guanidine derivatives, caprolactams and thiourea derivatives.

Dithiocarbamates used may be, for example: ammonium dimethyldithiocarbamate, sodium diethyldithiocarbamate (SDEC), sodium dibutyldithiocarbamate (SDBC), zinc dimethyldithiocarbamate (ZDMC), zinc diethyldithiocarbamate (ZDEC), zinc dibutyldithiocarbamate (ZDBC), zinc ethylphenyldithiocarbamate (ZEPC), zinc dibenzyldithiocarbamate (ZBEC), zinc pentamethylenedithiocarbamate (Z5MC), tellurium diethyldithiocarbamate, nickel dibutyldithiocarbamate, nickel dimethyldithiocarbamate and zinc diisononyldithiocarbamate.

Thiurams used may be, for example, tetramethylthiuram disulphide (TMTD), tetramethylthiuram monosulphide (TMTM), dimethyldiphenylthiuram disulphide, tetrabenzylthiuram disulphide, dipentamethylenethiuram tetrasulphide or tetraethylthiuram disulphide (TETD).

Thiazoles used may be, for example, 2-mercaptobenzothiazole (MBT), dibenzothiazyl disulphide (MBTS), zinc mercaptobenzothiazole (ZMBT) or copper 2-mercaptobenzothiazole.

Sulphenamide derivatives used may be, for example, N-cyclohexyl-2-benzothiazylsulphenamide (CBS), N-tert-butyl-2-benzothiazylsulphenamide (TBBS), N,N′-dicyclohexyl-2-benzothiazylsulphenamide (DCBS), 2-morpholinothiobenzothiazole (MBS), N-oxydiethylenethiocarbamyl-N-tert-butylsulphenamide or oxydiethylenethiocarbamyl-N-oxyethylenesulphenamide.

Xanthogenates used may be, for example, sodium dibutylxanthogenate, zinc isopropyldibutylxanthogenate or zinc dibutylxanthogenate.

Guanidine derivatives used may be, for example, diphenylguanidine (DPG), di-o-tolylguanidine (DOTG) or o-tolylbiguanide (OTBG).

Dithiophosphates used may be, for example; zinc di(C₂-C₁₆)alkyldithiophosphates, copper di(C₂-C₁₆)alkyldithiophosphates and dithiophosphoryl polysulphide.

A caprolactam used may be, for example, dithiobiscaprolactam.

Thiourea derivatives used may be, for example, N,N′-diphenylthiourea (DPTU), diethylthiourea (DETU) and ethylenethiourea (ETU).

Crosslinking is also possible with crosslinkers having at least two isocyanate groups—either in the form of at least two free isocyanate groups (—NCO) or else in the form of protected isocyanate groups from which the —NCO groups are released in situ under the crosslinking conditions.

Equally suitable as additions are, for example, zinc diaminodiisocyanate, hexamethylenetetramine, 1,3-bis(citraconimidomethyl)benzene and cyclic disulphanes.

The additions and crosslinking agents mentioned can be used either individually or in mixtures. Preference is given to using the following substances for the crosslinking of the inventive hydrogenated nitrile rubbers; sulphur, 2-mercaptobenzothiazole, tetramethylthiuram disulphide, tetramethylthiuram monosulphide, zinc dibenzyldithiocarbamate, dipentamethylenethiuram tetrasulphide, zinc dialkyldithiophosphate, dimorpholyl disulphide, tellurium diethyldithiocarbamate, nickel dibutyldithiocarbamate, zinc dibutyldithiocarbamate, zinc dimethyldithiocarbamate and dithiobiscaprolactam.

The crosslinking agents and aforementioned additions can each be used in amounts of about 0.05 to 10 phr, preferably 0.1 to 8 phr, especially 0.5 to 5 phr (single dose, based in each case on the active substance).

In the case of sulphur crosslinking, it is possible, in addition to the crosslinking agents and abovementioned additions, also to use further inorganic or organic substances as well, such as zinc oxide, zinc carbonate, lead oxide, magnesium oxide, saturated or unsaturated organic fatty acids and zinc salts thereof, polyalcohols, amino alcohols, for example triethanolamine, and amines, for example dibutylamine, dicyclohexylamine, cyclohexylethylamine and polyether amines.

If the inventive hydrogenated nitrile rubbers are those including repeating units of one or more termonomers containing carboxyl groups, crosslinking can also be effected via the use of a polyamine crosslinker, preferably in the presence of a crosslinking accelerator. The polyamine crosslinker is not restricted, provided that it is either (1) a compound that contains two or more amino groups (optionally also in salt form) or (2) a species that forms a compound that forms two or more amino groups in situ during the crosslinking reaction. Preference is given to using an aliphatic or aromatic hydrocarbon compound in which at least two hydrogen atoms are replaced either by amino groups or else by hydrazide structures (the latter being a “—C(═O)NHNH₂” structure).

Examples of such polyamine crosslinkers (ii) are:
aliphatic polyamines, preferably hexamethylenediamine, hexamethylenediamine carbamate, tetramethylenepentamine, hexamethylenediamine-cinnamaldehyde adduct or hexamethylenediamine dibenzoate;
aromatic polyamines, preferably 2,2-bis(4-(4-aminophenoxy)phenyl)propane, 4,4′-methylenedianiline, m-phenylenediamine, p-phenylenediamine or 4,4′-methylenebis(o-chloroaniline);
compounds having at least two hydrazide structures, preferably isophthalic dihydrazide, adipic dihydrazide or sebacic dihydrazide.

Particular preference is given to hexamethylenediamine and hexamethylenediamine carbamate.

The amount of the polyamine crosslinker in the vulcanizable mixture is typically in the range from 0.2 to 20 parts by weight, preferably in the range from 1 to 15 parts by weight and more preferably in the range from 1.5 to 10 parts by weight, based on 100 parts by weight of the hydrogenated nitrile rubber.

Crosslinking accelerators used in combination with the polyamine crosslinker may be any known to those skilled in the art, preferably a basic crosslinking accelerator. Usable examples include, for example, tetramethylguanidine, tetraethylguanidine, diphenylguanidine, di-o-tolylguanidine (DOTG), o-tolylbiguanidine and di-o-tolylguanidine salt of dicatecholboric acid. Additionally usable are aldehyde amine crosslinking accelerators, for example n-butylaldehydeaniline. More preferably at least one bi- or polycyclic aminic base is used as crosslinking accelerator. These are known to those skilled in the art. The following are especially suitable: 1,8-diazabicyclo[5.4.0]undec-7-ene (DBU), 1,5-diazabicyclo[4.3.0]-5-nonene (DBN), 1,4-diazabicyclo[2.2.2]octane (DABCO), 1,5,7-triazabicyclo[4.4.0]dec-5-ene (TBD), 7-methyl-1,5,7-triazabicyclo[4.4.0]dec-5-ene (MTBD).

The amount of the crosslinking accelerator in this case is typically within a range from 0.5 to 10 parts by weight, preferably 1 to 7.5 parts by weight, especially 2 to 5 parts by weight, based on 100 parts by weight of the hydrogenated nitrile rubber.

The vulcanizable mixture based on the inventive hydrogenated nitrile rubber may in principle also contain scorch retardants, which differ between vulcanization with sulphur and with peroxides:

In the case of vulcanization with sulphur, the following are used: cyclohexylthiophthalimide (CTP), N,N′-dinitrosopentamethylenetetramine (DNPT), phthalic anhydride (PTA) and diphenylnitrosamine. Preference is given to cyclohexylthiophthalimide (CTP).

In the case of vulcanization with peroxides, scorch is retarded using compounds as specified in WO-A-97/01597 and U.S. Pat. No. 4,857,571. Preference is given to sterically hindered p-dialkylaminophenols, especially Ethanox 703 (Sartomer).

The further customary rubber additives include, for example, the typical substances known to those skilled in the art, such as fillers, filler activators, antiozonants, ageing stabilizers, antioxidants, processing aids, extender oils, plasticizers, reinforcing materials and mould release agents.

Fillers used may, for example, be carbon black, silica, barium sulphate, titanium dioxide, zinc oxide, calcium oxide, calcium carbonate, magnesium oxide, aluminium oxide, iron oxide, aluminium hydroxide, magnesium hydroxide, aluminium silicates, diatomaceous earth, talc, kaolins, bentonites, carbon nanotubes, Teflon (the latter preferably in powder form), or silicates. The fillers are typically used in amounts in the range from 5 to 350 parts by weight, preferably from 5 to 300 parts by weight, based on 100 parts by weight of the hydrogenated nitrile rubber.

Useful filler activators include organic silanes in particular, for example vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane or (octadecyl)methyldimethoxysilane. Further filler activators are, for example, interface-active substances such as triethanolamine and ethylene glycols with molecular weights of 74 to 10 000 g/mol. The amount of filler activators is typically 0 to 10 phr, based on 100 phr of the inventive hydrogenated nitrile rubber.

Ageing stabilizers added to the vulcanizable mixtures may, for example, be the following: polymerized 2,2,4-trimethyl-1,2-dihydroquinoline (TMQ), 2-mercaptobenzimidazole (MBI), methyl-2-mercaptobenzimidarole (MMBI) or zinc methylmercaptobenzimidazole (ZMMBI).

Alternatively, it is also possible to use the following, though less preferred, ageing stabilizers: aminic ageing stabilizers, for example in the form of mixtures of diaryl-p-phenylenediamines (DTPD), octylated diphenylamine (ODPA), phenyl-α-naphthylamine (PAN) and/or phenyl-β-naphthylamine (PBN). Preference is given to using those based on phenylenediamine. Examples of phenylenediamines are N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD) and N,N′-bis-1,4-(1,4-dimethylpentyl)-p-phenylenediamine (7PPD).

The ageing stabilizers are typically used in amounts of up to 10 parts by weight, preferably up to 5 parts by weight, more preferably 0.25 to 3 parts by weight, especially 0.4 to 1.5 parts by weight, based on 100parts by weight of the hydrogenated nitrile rubber.

Examples of useful mould release agents include saturated or partly unsaturated fatty acids and oleic acids and derivatives thereof (fatty acid esters, fatty acid salts, fatty alcohols, fatty acid amides), which are preferably used as a mixture constituent, and also products applicable to the mould surface, for example products based on low molecular weight silicone compounds, products based on fluoropolymers and products based on phenol resins.

The mould release agents are used as a mixture constituent in amounts from about 0 to 10 phr, preferably 0.5 to 5 phr, based on 100 phr of the inventive hydrogenated nitrile rubber.

Another possibility is reinforcement with strengthening agents (fibres) made of glass, according to the teaching of U.S. Pat. No. 4,826,721, and another is reinforcement by cords, woven fabrics, fibres made of aliphatic and aromatic polyamides (Nylon®, Aramid®), polyesters and natural fibre products.

The mixing of the components for the purpose of producing the vulcanizable mixtures is typically effected either in an internal mixer or on a roll. Internal mixers used are typically those having what is called an intermeshing rotor geometry. At the starting point, the internal mixer is charged with the inventive hydrogenated nitrile rubber. This is typically in bale form and in that case is first comminuted. After a suitable period, which can be fixed by the person skilled in the art without difficulty, the addition of the additives and typically, at the end, of the crosslinking system is effected. The mixing is effected under temperature control, with the proviso that the mixture remains at a temperature in the range from 100 to 150° C. for a suitable time. After a suitable mixing period, the internal mixer is vented and the shaft is cleaned. After a further period, the internal mixer is emptied to obtain the vulcanizable mixture. All the aforementioned periods are typically in the region of a few minutes and can be fixed by the person skilled in the art without difficulty as a function of the mixture to be produced. If rolls are used as mixing units, it is possible to proceed in an analogous manner and sequence in the metered addition.

The invention further provides a process for producing vulcanizates based on the inventive hydrogenated nitrile rubbers, characterized in that the vulcanizable mixture comprising the inventive hydrogenated nitrile rubber is subjected to vulcanization. Typically, the vulcanization is effected at temperatures in the range from 100°C to 200° C., preferably at temperatures of 120° C. to 190° C. and most preferably of 130 C. to 180° C.

The vulcanization is preferably effected in a shaping process.

For this purpose, the vulcanizable mixture is processed further by means of extruders, injection moulding systems, rolls or calenders. The preformed mass thus obtainable is typically then vulcanized to completion in presses, autoclaves, hot air systems, or in what are called automatic mat vulcanization systems, and useful temperatures have been found to be in the range from 100° C. to 200° C., preferably 140° C. to 190° C. The vulcanization time is typically 1 minute to 24 hours and preferably 2 minutes to 1 hour. Depending on the shape and size of the vulcanizates, a second vulcanization by reheating may be necessary to achieve complete vulcanization.

The invention accordingly provides the vulcanizates thus obtainable, based on the inventive hydrogenated nitrile rubbers.

These vulcanizates may take the form of a drive belt, of roller coverings, of a seal, of a cap, of a stopper, of a hose, of floor covering, of sealing mats or sheets, profiles or membranes. Specifically, the vulcanizates may be an O-ring seal, a flat seal, a shaft sealing ring, a gasket sleeve, a sealing cap, a dust protection cap, a connector seal, a thermal insulation hose (with or without added PVC), an oil cooler hose, an air suction hose, a power steering hose, a shoe sole or parts thereof, or a pump membrane.

Surprisingly, the phosphine oxides or diphosphine oxides formed in the hydrogenated nitrile rubber in the process according to the invention by the reaction of phosphines or diphosphines with the specific sulphur compounds disrupt neither the vulcanization characteristics thereof nor the vulcanizate properties of the hydrogenated nitrile rubber. In this respect, the present invention makes it possible to conduct the catalytic hydrogenation of nitrile rubber with a high reaction rate and simultaneously small amounts of catalyst and at lower pressure with hydrogenation catalysts having at least one phosphine or diphosphine ligand, and/or with phosphines/diphosphines as cocatalysts, and nevertheless to obtain hydrogenated nitrile rubbers and hence vulcanizates having the desired profile of properties.

### EXAMPLES

### Determination of the Triphenylphosphine (“TPP”) Content and Triphenylphosphine Oxide (“TPP═O”) Content

The triphenylphosphine and triphenylphosphine oxide contents in the hydrogenated nitrile rubber were determined by means of gas chromatography using an internal standard. For the determination, 2 to 3 g±0.01 g of HNBR in each case were weighed into a small test tube and dissolved with 25 ml of acetone, a known amount of an internal standard (docosane from Sigma-Aldrich; Calif.: 629-97-0) was added and, after mixing thoroughly, precipitation was effected by adding 50 ml of methanol. The precipitation serum was separated by means of gas chromatography using a capillary column (e.g.: HP-5, 0.25 μm film, 30 m×0.32 mm ID).
Injection volume: 1 μl
Injection temperature: 300° C.
Oven temperature programme: Adjustment to 150° C.; then heating to 300° C. within 10 min, and maintaining this temperature for 5 min.
Detector temperature: 300° C.

For detection, a flame ionization detector (FID) was used.

Under the given conditions, TPP, TPP═O and the internal standard have the following retention times:
TPP: 8.47 min
Docosane: 8.65 min
TPP═O: 11.40 min

For quantitative determination of the amounts of TPP and TPP═O present in HNBR, response factors of TPP/n-docosane and of TPP═O/docosane were used, which had been determined beforehand in independent measurements relating to the linear calibration range.

Where “<0.01% by wt.” is reported under TPP contents in the tables which follow, this means that (any) TPP content was below the analytical detection limit.

### Determination of the Total Halogen Content to DIN 51408, Part 2

The hydrogenated nitrile rubber (amount between 2 mg and 10 mg, according to the halogen content) is weighed into a quartz crucible, which is pushed into a hot quartz tube using a solids module and combusted therein under an oxygen stream (ultrapure oxygen) (combustion tube temperature about 1000° C.). The combustion gases are introduced into a titration cell which has been initially charged with 75% by volume acetic acid, first through a trap filled with concentrated sulphuric add (ultrapure) for drying, and then through a bubble breaker, and subsequently through a wash bottle filled with concentrated sulphuric acid to scavenge nitrogen oxides. In the titration cell, the halide ions are titrated with Ag+ ions which are produced by a silver anode up to the original cell equilibrium. The result in equivalents of Ag+ is converted to equivalents of halide and this result is reported hereinafter as “total halogen content” (based on chloride).

### Determination of the Hydrogenation Level

The exact hydrogenation level was determined after the hydrogenation of the nitrile rubber had ended by the methods described in Kautschuk+Gummi. Kunststoffe, vol. 42 (1989), no. 2, 107-110 and Kautschuk+Gummi. Kunststoffe, vol. 42 (1989), no. 3,194-197.

### I Production of the Nitrile Rubbers A and B

In the first step, two nitrile rubber latices A and B were produced on the basis of the polymer formulations specified in Tables Ia and Ib,

TABLE Ia
Production of nitrile rubber latex A

| Latex A | parts by wt. |
|---|---|
| Butadiene | 65.5 |
| Acrylonitrile | 33.5/1* |
| Total amount of water | 200 |
| Erkantol ® BXG¹⁾ | 3.67 |
| Baykanol ® PQ²⁾ | 1.10 |
| K salt of coconut fatty acid | 0.73 |
| KOH | 0.05 |
| t-DDM⁶⁾ | 0.25/0.24* |
| potassium peroxodisulphate³⁾ | 0.39/0.20* |
| tris(α-hydroxyethyl)amine⁴⁾ | 0.57 |
| Polymerization temperature [° C.] | 18 |
| Polymerization conversion [%] | 79 |
| Polymerization time [h] | 10 |
| Stoppers: | |
| Na dithionite⁵⁾ | 1.0 |
| diethylhydroxylamine | 0.5 |
| potassium hydroxide | 1.28 |

*addition at polymerization conversion 15%
¹⁾sodium salt of a mixture of mono- and disulphonated naphthalenesulphonic acids with isobutylene oligomer substituents (Erkantol ® BXG)
²⁾sodium salt of methylene bis(naphthalenesulphonate) (Baykanol ® PQ, Lanxess Deutschland GmbH)
³⁾Aldrich catalogue number: 21.622-4
⁴⁾Aldrich catalogue number: T5,830-0
⁵⁾Aldrich catalogue number: 15.795-3
⁶⁾t-DDM (tertiary dodecyl mercaptan): C₁₂ mercaptan mixture from Lanxess Deutschland GmbH

TABLE Ib
Production of the nitrile rubber latex B

| NBR latex B | | B |
|---|---|---|
| butadiene | parts by wt. | 66 |
| acrylonitrile | parts by wt. | 30/04* |
| Total amount of water | parts by wt. | 220 |
| Partly hydrogenated fatty acid¹⁾ | parts by wt. | 2.0 |
| potassium hydroxide | parts by wt. | 0.394 |
| potassium chloride | parts by wt. | 0.139 |
| trisodium phosphate²⁾ | parts by wt. | 0.0088/0.0077* |
| ethylenediaminetetraacetic acid³⁾ | parts by wt. | 0.0058/0.0056* |
| iron(II) sulphate heptahydrate | parts by wt. | 0.0024/0.0024* |
| sodium formaldehydesulphoxylate 2- | parts by wt. | 0.0069/0.0067* |
| hydrate⁴⁾ | | |
| p-menthane hydroperoxide⁵⁾ | parts by wt. | 0.035 |
| tert-dodecyl mercaptan 6) | parts by wt. | 0.348/0.183* |
| Polymerization temperature | ° C. | 13 |
| Polymerization conversion | % | 77 |
| Polymerization time | h | 8 |
| Stoppers: | | |
| diethylhydroxylamine | parts by wt. | 0.125 |

*addition at conversion 36%
¹⁾Edenor ® HTiCT N (Oleo Chemicals)
²⁾trisodium phosphate*12 H₂O (Acros, item number 206520010) - calculation excluding water of crystallization
³⁾ethylenediaminetetraacetic acid (Fluka, item number 03620)
⁴⁾sodium formaldehydesulphoxylate 2-hydrate (Merck-Schuchardt, item number 8.06455), calculation excluding water of crystallization
⁵⁾Trigonox ® NT 50 (Akzo-Degussa), calculated to 100%
⁶⁾isomer mixture of tert-dodecyl mercaptans (Lanxess Deutschland GmbH)

After the removal of the unconverted monomers by means of steam distillation, the nitrile rubber latices A and B had the properties listed in Table Ic.

TABLE Ic
Properties of the nitrile rubber latices A and B

| NBR latex type | A | B |
|---|---|---|
| Solids content | 23.9 | 27.5 |
| pH | 11.7 | 11.5 |

### II Stabilization, Coagulation and Workup of the Nitrile Rubber Latices

The nitrile rubber latices A and B were admixed prior to (latex A) or during (latex B) coagulation with 0.35% by weight of Vulkanox®BKF (2,2-methylenebis(4-methyl-6-tert-butylphenol) from Lanxess Deutschland GmbH) in the form of an aqueous dispersion.

The aqueous Vulkanox® BKF dispersion was based on the following formulation, prepared at 95 to 98° C. by mixing with the aid of an Ultraturrax;

| | |
|---|---|
| 3.6 kg | deionized water (DW water) |
| 0.4 kg | alkylphenol polyglycol ether (NP ® 10 emulsifier from Lanxess |
| | Deutschland GmbH) |
| 4 kg | Vulkanox ® BKF from Lanxess Deutschland GmbH |

In the case of latex A, the Yulkanox® BKF dispersion was added prior to coagulation. Nitrile rubber latex A was coagulated with magnesium chloride/gelatin as per Example 10 from EP-A-2 238 177. The washing and drying of the rubber crumbs was likewise effected as described in EP-A-2 238 177.

Nitrite rubber latice B was coagulated according to Example 2 from EP-A-1 369 436. For this purpose, the latex was diluted to a solids concentration of 16.5% by weight with deionized water prior to coagulation. The aqueous dispersion of Vulkanox® BKF was added in the precipitation nozzle. The washing and drying were effected like Example 2 of EP 1369436.

The properties of the nitrile rubbers A and B obtained in this way are summarized in Table II.

TABLE II
Properties of nitrile rubbers A and B

| NBR type | | A | B |
|---|---|---|---|
| acrylonitrile content | % by wt. | 34.4 | 34.8 |
| ML 1 + 4 (100° C.) | MU | 36 | 34 |
| sodium | ppm | 136 | 162 |
| potassium | ppm | 22 | 68 |
| calcium | ppm | 94 | 2 |
| magnesium | ppm | 163 | <1 |

### III Metathesis

Before the performance of the hydrogenation, exclusively the nitrile rubber B used in Experiment Series 4 was subjected to a metathesis. The metathesis was conducted in analogy to the examples of WO-A02/100905, using 0.05 phr of Grubbs II catalyst (Materia/Pasadena) and 2.0 phr of 1-hexene in chlorobenzene solution at a solids concentration of 12% by weight at 80° C. The metathesis degradation reduced the Mooney viscosity (ML 1+4 at 100° C.) from 34 MU to 19 MU.

### IV Hydrogenations

### IV.1 Overview of Experiment Series 1 to 6

6 experiment series were conducted; an overview of them is given in Table 1,

TABLE 1
Overview of Experiment Series 1 to 6

| | NBR rubbers | | | | | | | | |
|---|---|---|---|---|---|---|---|---|---|
| | | | ML 1 + 4 | | | HNBR production | | | |
| | | | (100° C.) | | | and properties | | | |
| | Based | ACN | before | after | | Hydro- | | ML 1 + 4 | Method |
| | on | content | meta- | meta- | TPP | genation | Noble | at | of mono- |
| Experiment | latex | [% by | thesis | thesis | [% by | level | metal | 100° C. | sulphide |
| Series | type | wt.] | [MU] | [MU] | wt.] | [%] | removal | [MU] | addition |
| 1a, 1b | A | 34.4 | 36 | — | 0-2.0 | 99.5 ± 0.2 | − | 65-74 | — |
| 2 | A | 34.4 | 36 | — | 1 | 97 | − | 70 | MCB* |
| 3 | A | 34.4 | 36 | — | 1 | 97 | + | 68 | MCB* |
| 4 | B | 34.8 | 34 | 19 | 2 | 94.5 | + | 39 | roll |
| 5a, 5b | B | 34.8 | 34 | — | 3 | 95.0 | + | 65 | roll |
| 6a, 6b | A | 34.4 | 36 | — | 0 | 99.5 | − | | — |

*MCB = monochlorobenzene

In Experiment Series 1a, 1b, 6a and 6b, hydrogenated nitrile rubbers which had been obtained by hydrogenating nitrile rubber A in 16.67% chlorobenzene solution at a hydrogen pressure of 190 bar and a temperature of 120° C. to 130° C. were used. In each of the hydrogenations, 5 kg of the abovementioned nitrile rubber were dissolved in 24.5 kg of chlorobenzene in a 40 l autoclave. Before the hydrogenation, each polymer solution was successively contacted once with nitrogen (20 bar) and twice with hydrogen (20 bar) while stirring, and then decompressed. After injecting hydrogen to 190 bar, the amounts of triphenylphosphine specified in the tables (Merck Schuchardt OHG; cat. no. 8.08270) were metered in as a solution in 250 g of chlorobenzene. The hydrogenation was started by adding, as a catalyst, 0.075% by weight (based on nitrile rubber) of tris(triphenylphosphine)rhodium(I) chloride (Evonik-Degussa) as a solution in 250 g of chlorobenzene. The course of the hydrogenation was monitored online by determining the hydrogen absorption. The hydrogenations were stopped at hydrogenation levels of 99.5±0.2% by cooling the reaction mixture. Subsequently, the mixtures were decompressed. Residual amounts of hydrogen were removed by passing nitrogen through.

For Experiment Series 2 and 3, hydrogenated nitrile robbers produced on the basis of nitrile rubber A were used. The hydrogenations were carried out under the following boundary conditions:
NBR concentration in chlorobenzene: 12% by weight
Hydrogen pressure: 80 bar
Stirrer speed: 600 mm⁻¹
Reaction temperature; 138° C.
Tris(triphenylphosphine)rhodium(I) chloride: 0.08 phr
Triphenylphosphine: 1 % by weight
Hydrogenation stopped at: hydrogenation level of 97%

For the production of the hydrogenated nitrile rubber used in Experiment Series 4, and 5a and 5b, the nitrile rubber B was hydrogenated under the following boundary conditions:
NBR concentration in chlorobenzene: 12% by weight
Hydrogen pressure: 80 bar
Stirrer speed: 600 min⁻³
Reaction temperature: 138° C.
Tris(triphenylphosphine)rhodium(I) chloride: 0.065 phr
Triphenylphosphine: 2% by weight in Experiment Series 4)
Triphenylphospine: 3% by weight in Experiment Series 5a) and 5b)
Hydrogenation stopped at: hydrogenation level=94.5% (Experiment Series 4) and hydrogenation level=95% (Experiment Series 5a and 5b)

### V Catalyst Recovery

In Experiment Series 1a and 1b, 2, and also 6a and 6b, there was no removal of the rhodium catalyst used in the hydrogenation. In Experiment Series 3, 4, and also 5a and 5b, the noble metal was removed after the hydrogenation as described in Example 5 of U.S. Pat. No. 4,985,540, using the thiourea-containing ion exchange resin from this Example 5. For the removal of rhodium, the polymer solution was diluted to a solids concentration of 5% by weight.

### VI Reaction with a Sulphur Compound

The sulphur compounds listed in Table VI were used in the inventive examples:

TABLE VI
Sulphur compounds used

| | | Molar mass |
|---|---|---|
| Sulphur compound | Manufacturer | [g/mol] |
| tert-dodecyl mercaptan | Sulfole ® 120 Mercaptan | 202 |
| (abbreviated hereinafter | (Chevron Phillips | |
| as “TDDM”) | Chemical Co.) | |
| 2-mercaptobenzothiazole | Vulkacit ® Merkapto | 167 |
| (abbreviated hereinafter | (Lanxess Deutschland | |
| as “MBT”) | GmbH) | |
| N-cyclohexyl-2-benzo- | Vulkacit ® CZ | 264.4 |
| thiazylsulphenamide | (Lanxess Deutschland | |
| (abbreviated hereinafter | GmbH) | |
| as “CBS”) | | |
| N-tert-buytl-2-benzo- | Vulkacit ® NZ | 238.4 |
| thiazylsulphenamide | (Lanxess Deutschland | |
| (abbreviated hereinafter | GmbH) | |
| as “TBBS”) | | |
| N,N-dicyclohexylbenzo- | Vulkacit ® DZ | 346 |
| thiazylsulphenamide | (Lanxess Deutschland | |
| (abbreviated hereinafter | GmbH) | |
| as “DCBS”) | | |
| 2-morpholinobenzothiazole | Vulkacit ® MOZ | 252 |
| (abbreviated hereinafter | (Lanxess Deutschland | |
| as “MBS”) | GmbH) | |

### Addition of the Sulphur Compound

In Experiment Series 2 sand 3, the sulphur compound was added, respectively, after the hydrogenation and after hydrogenation and catalyst recovery to the chlorobenzene solution prior to the isolation of the hydrogenated nitrile rubber by steam distillation, by adding the sulphur compound as a solution in chlorobenzene (MCB) to the chlorobenzene solution of the hydrogenated nitrile rubber and initially charging it together with distilled water in the stripping vessel.

In Experiment Series 4, 5a and 5b, the sulphur compound was added in the solid state on a roll mill (detailed description in Experiment Series 4).

### VII Isolation of the Hydrogenated Nitrile Rubber from Chlorobenzene Solution

The steam distillation was effected batchwise. The mixture was heated to 90° C. while stirring, without introduction of steam. On attainment of this temperature, the introduction of steam was commenced (at standard pressure) via a ring nozzle at the base of the stripping vessel. In the course of this, the vapours consisting of chlorobenzene and steam distilled off at a top temperature of 102° C. The vapours were condensed and separated into a chlorobenzene phase and an aqueous phase. As soon as chlorobenzene no longer separated out of the vapours (after about 3 h), the steam distillation was stopped. The hydrogenated nitrile rubber, which was in the form of relatively coarse lumps, was isolated, cut into small pieces and dried to constant weight in a vacuum drying cabinet at 70° C. and a gentle air stream.

### VIII Production of Rubber Mixtures and Vulcanizates

To assess the technological properties of the hydrogenated nitrile rubbers obtained in the experiment series, rubber mixtures and vulcanizates were produced. The rubber mixtures had the composition specified in Table VIII.

TABLE VIII
Composition of the rubber mixtures

| | | Amount |
|---|---|---|
| | Commercial product | [parts |
| Mixture constituent | (manufacturer) | by wt.] |
| hydrogenated nitrile rubber | | 100 |
| zinc oxide | Zinc oxide active | 2.0 |
| | (Lanxess Deutschland | |
| | GmbH) | |
| magnesium oxide | Maglite ® DE (Merck & | 2.0 |
| | Co. Inc. USA) | |
| octylated diphenylamine | Rhenofit ® DDA-70 | 1.43 |
| | (RheinChemie Deutschland | |
| | GmbH) | |
| zinc salt of | Vulkanox ® ZMB-2 | 0.4 |
| 2-mercaptobenzimidazole | (Lanxess Deutschland | |
| | GmbH) | |
| carbon black | Corax ® N 550 (Evonik | 45 |
| | Industries AG) | |
| triallyl isocyanurate | Kettlitz ® TAIC 50 | 3.0 |
| | (Kettlitz ® Chemie GmbH) | |
| bis(tert-butylperoxy- | Perkadox ® 14-40 K-PD | 7 |
| isopropyl)benzene (40%) | (Akzo-Nobel Chemicals | |
| | GmbH) | |

The mixture was produced in a laboratory kneader of capacity 1.5 l (GK 1,5 from Werner & Pfleiderer, Stuttgart, with intermeshing kneading elements (PS 5A—paddle geometry)), which had been preheated to 50° C. The mixture constituents were added in the sequence specified in Table 5.

### Properties of the Unvulcanized Rubber Mixtures

To assess the processing characteristics of the unvulcanized rubber mixtures, Mooney viscosities at 100° C. (ML1+4@10° C.), and at 120° C. (ML1+4@120° C.), were determined to ASTM D1646.

### Vulcanization Characteristics of the Rubber Mixtures

The vulcanization characteristics of the mixtures were determined to ASTM D 5289-95 at 180° C., using both a Bayer-Frank vulcameter (from Agfa) and a moving die rheometer (MDR 2000 from Alpha Technology) (see experiment series). Characteristic vulcameter values such as F_{min.}, Fₘₐₓ, Fₘₐₓ−F_{min.} are obtained in the dimension cN in the case of the Bayer-Frank vulcameter, and in the dimension dNm in the case of the moving die rheometer. Characteristic times such as t₁₀, t₅₀, t₉₀ and t₉₅ are determined in min or see irrespective of the test method.

According to DIN 53 529, Part 3, the following characteristics have the following meanings:
F_{min.}: vulcameter value at the minimum of the crosslinking isotherm
Fₘₐₓ: vulcameter value at the maximum of the crosslinking isotherm
Fₘₐₓ−Fₘᵢₙ: difference in the vulcameter values between maximum and minimum
t₁₀: time at which 10% of the final conversion has been attained
t₅₀: time at which 50% of the final conversion has been attained
t₉₀: time at which 90% of the final conversion has been attained
t₉₅: time at which 95% of the final conversion has been attained
t₉₀-t₁₀: gives an indication of the vulcanization rate

For good processing characteristics, long t10 times (high processing reliability) are required. High vulcanization rates are apparent from small differences of t₉₀-t₁₀.

The specimens used for the vulcanizate characterization were produced in a press at 180° C. at a hydraulic pressure of 120 bar (times according to tables below). In Experiment Series 1 and 6, the specimens were subjected to thermal storage (6 h at 150° C.) prior to the characterization.

Using the vulcanizates, the following properties were determined to the following standards:
DIN 53505: Shore A hardness at 23° C. and 70° C.
DIN 53512: Resilience at 23° C. and 70° C.
DIN 53504: Stress values at 10%, 25%, 50%, 100%, 200% and 300% strain (σ₅₀, σ₁₀₀, σ₂₀₀ and σ₃₀₀), tensile strength and elongation at break (ε_{b})

The compression set (CS) was determined to DIN 53517, by compressing a cylindrical specimen by 25% and storing it in the compressed state for the periods and at the temperatures specified in the tables (e.g. 70 h/23° C. or 70 h/150° C.). After relaxation of the samples, the lasting deformation (compression set) of the sample was determined. For the determination, cylindrical specimens having the following dimensions were used:
Specimen 1: height: 6.3; diameter: 13 mm
Specimen 2: height: 12.7; diameter: 28.7 mm.

Irrespective of the sample geometry, a lasting deformation (or compression set) of 0% is very good and of 100% is very poor.

To demonstrate the effects of the invention, the following experiment series were conducted:

### Experiment Series 1a and 1b (Noninventive)

It is shown that increasing the amount of TPP (cocatalyst) used reduces the hydrogenation times (Experiment Series 1a). With increasing amount of TPP, the modulus level and compression set of the vulcanizates produced on the basis of the hydrogenated nitrile rubbers deteriorate (Experiment Series 1b). The noninventive hydrogenated nitrile rubbers obtained with this Experiment Series had TPP contents up to 1.72% by weight and TPP═O contents up to 0.13% by weight.

### Experiment Series 2 (Inventive)

In Experiment Series 2, various monosulphides were added to aliquots of the chlorobenzene solution of the hydrogenated nitrile rubber (1% by weight of triphenylphosphine=3.81 mmol based on 100 g of NBR) prior to the removal of the chlorobenzene by means of steam distillation. The rhodium-containing hydrogenation catalyst was left in the solution.

In Experiment Series 2, it is shown that the addition of the particular sulphur compound to the chlorobenzene solution of the hydrogenated nitrile rubber prior to the isolation of the hydrogenated nitrile rubber by means of steam distillation achieves a reduction in the TPP content. At the same time as the reduction in the TPP content, there is an increase in the TPP═O content. The inventive hydrogenated nitrile rubbers had TPP contents up to 0.57% by weight, TPP═O contents of 0.41 to 1.07% by weight and total halogen contents of 570 to 820 ppm.

### Experiment Series 3 (Inventive)

In Experiment Series 3, as in Experiment Series 2, various sulphur compounds were added to aliquots of the chlorobenzene solution of the hydrogenated nitrile rubber (1% by weight of triphenylphosphine=3.81 mmol based on 100 g of NBR) prior to the removal of the chlorobenzene by means of steam distillation. In this Experiment Series, in contrast to Experiment Series 2, the rhodium-containing hydrogenation catalyst was removed prior to the addition of the sulphur compound.

In Experiment Series 3, it is shown that the addition of the particular specific sulphur compound to the chlorobenzene solution of the hydrogenated nitrile rubber prior to the isolation of the hydrogenated nitrile rubber by means of steam distillation achieves a reduction in the TPP content. At the same time as the reduction in the TPP content, there is an increase in the TPP═O content. The inventive hydrogenated nitrile rubbers had TPP contents up to 0.74% by weight, TPP═O contents of 0.37 to 0.99% by weight and total halogen contents of 570 to 710 ppm.

A comparison of Experiment Series 2 and 3 shows that the results achieved do not depend on whether the catalyst used in the hydrogenation was left in the solution or removed.

### Experiment Series 4 (Inventive)

In Experiment Series 4, the hydrogenation was preceded by a metathesis degradation of the nitrile rubber. In addition, the hydrogenation catalyst was separated from the chlorobenzene solution prior to the isolation of the hydrogenated nitrile rubber. The reaction of TPP with the particular sulphur compound was effected after the isolation of the hydrogenated nitrile rubber from the chlorobenzene solution on a roll. The addition of the particular sulphur compound to the hydrogenated nitrile rubber, which contained 2.0 parts by weight of TPP (7.63 mmol/100 g HNBR), was effected in solid form. For this purpose, a thermostatable roll mill having two contra-rotating rolls (from Schwabenthan; model: Poly mix 110; roll diameter 110 mm) was used. For the incorporation of the sulphur compound, the roll was heated up and kept constant at 80-85° C. On attainment of the temperature, 200 g of hydrogenated nitrile rubber in each case was applied to the roll and rolled out at a roll nip of 3 mm until a continuous milled sheet was formed. Thereafter, the sulphur compound was added in solid form and incorporated at a friction ratio of 25 to 30 min⁻¹ for 8 min, by cutting into the milled sheet and folding it over. Thereafter, the milled sheet was cooled to room temperature and the analytical studies detailed in Experiment Series 4 were conducted.

The addition of the particular sulphur compound achieved a reduction in the content of TPP by formation of TPP═O. The inventive hydrogenated nitrile rubbers had TPP contents in the range of 0.05 to 0.55% by weight, TPP═O contents of 1.57 to 2.17% by weight and total halogen contents of 44 to 48 ppm.

### Experimental Series 5a and 5b (Inventive)

In Experiment Series 5, partly hydrogenated nitrile rubber which contained 3 phr of triphenylphosphine (11.44 mmol/100 g HNBR) was used. The incorporation of the sulphur compound in Experiments 5.2*-5.7* was effected as described in Experiment Series 4 on a roll mill. In Experiment 5.8*, the sulphur compound was added prior to the performance of the steam distillation.

It was found that reduction of the TPP contents achieves an improvement in the modulus level and compression set of vulcanizates of the hydrogenated nitrile rubber. The improvements achieved are independent of whether the sulphur compound is added on the roll (Experiments 5.2*-5.6*) or prior to the steam distillation (Experiment 5.8*). The inventive hydrogenated nitrile rubbers had contents of TPP up to 0.76% by weight, of TPP═O of 2.35 to 3.2% by weight, and of total halogen of 51 to 110 ppm.

### Experiment Series 6a and 6b: (Inventive)

In Experiment Series 6a and 6b, the influence of TPP═O on the properties of the rubber mixtures and of the vulcanizates was examined. For this purpose, different amounts of TPP═O (see Experiment Series 6a) were added to the hydrogenated nitrile rubber front Experiment Series 1.1=6.1 on a temperature-controllable roll mill with two contra-rotating rolls (from Schwabenthan; model: Polymix 110; roll diameter: 110 mm). Each experimental setting was conducted twice with 450 g of rubber each time. The incorporation of TPP═O was effected at a roll nip of 3 mm (rotational speeds 25 and 30 min⁻¹) at a roll temperature of 20° C. and a milled sheet temperature of 40° C., by repeatedly folding over and cutting into the milled sheet within a period of 5 min. After the incorporation of the TPP═O, the two milled sheets each having the same experimental setting were mixed on the roll, such that a total amount of 900 g was obtained for each experimental setting. Using these samples, the contents of TPP and TPP═O (Experiment Series 6a), and the properties of the rubber mixtures and vulcanizates summarized in Experiment Series 6b, were determined.

It was shown that the modulus level and compression set of HNBR vulcanizates are improved by additions of TPP═O. The TPP═O contents of the inventive hydrogenated nitrile rubbers were in the range up to 2.01% by weight.

All of the results of the experiment series described above are summarized in the tables which follow. The inventive examples are each indicated by “*”.

TABLE 1a
Experiment Series 1a (noninventive)
Variation of the TPP amount in the hydrogenation and contents
of TPP and TPP═O in the hydrogenated nitrile rubber

| Experiment No. | | 1.1 | 1.2 | 1.3 | 1.4 | 1.5 |
|---|---|---|---|---|---|---|
| TPP added in | [% by | 0 | 0.3 | 0.50 | 1.0 | 2.0 |
| hydrogenation | wt.] | | | | | |
| Hydrogenation time | [h] | 5.0 | 4.5 | 4.3 | 4.0 | 3.8 |
| Hydrogenation level | [%] | 99.3 | 99.3 | 99.5 | 99.6 | 99.7 |
| TPP content in the | [% by | <0.01 | 0.25 | 0.41 | 0.83 | 1.72 |
| hydrogenated | wt.] | | | | | |
| NBR after workup | | | | | | |
| TPP═O content in the | [% by | <0.01 | 0.04 | 0.08 | 0.11 | 0.13 |
| hydrogenated | wt.] | | | | | |
| NBR after workup | | | | | | |
| ML1 + 4 @100° C. | [MU] | 74 | 72 | 70 | 66 | 65 |

Using the hydrogenated nitrile rubbers obtained in Experiment Series 1a, rubber mixtures having the composition specified in Table VIII were produced and vulcanized. The values which follow were determined in the vulcanizates (Experiment Series 1b).

TABLE 1b
Experiment Series 1b (noninventive)
Influence of TPP on the mixture and vulcanizate properties
of peroxidically vulcanized hydrogenated nitrile rubbers
from Experiment Series 1a

| | | | | | |
|---|---|---|---|---|---|
| Experiment No. | 1.1 | 1.2 | 1.3 | 1.4 | 1.5 |

Mixture properties

| | | | | | | |
|---|---|---|---|---|---|---|
| ML1 + 4 @ 100° C. | MU | 125 | 125 | 124 | 124 | 119 |
| ML1 + 4 @ 120° C. | MU | 84 | 86 | 84 | 84 | 82 |

Vulcameter at 180° C. (Bayer-Frank vulcameter)

| | | | | | | |
|---|---|---|---|---|---|---|
| t₁₀ | min | 1.4 | 1.5 | 1.5 | 1.4 | 1.4 |
| t₉₀ | min | 7.1 | 7.2 | 7.3 | 7.2 | 7.5 |
| t₉₀ − t₁₀ | min | 5.7 | 5.7 | 5.8 | 5.8 | 6.1 |
| Fₘᵢₙ | cN | 236 | 253 | 244 | 253 | 236 |
| Fₘₐₓ | cN | 5107 | 5065 | 4930 | 4618 | 3792 |
| Fₘₐₓ − Fₘᵢₙ | cN | 4871 | 4812 | 4686 | 4365 | 3556 |

Vulcanizate properties (vulcanization at 180° C. for 15 min;
heat treatment at 150° C. for 6 h)

| | | | | | | |
|---|---|---|---|---|---|---|
| Shore A hardness (23° C.) | | 73 | 73 | 73 | 72 | 71 |
| Shore A hardness (70° C.) | | 71 | 72 | 71 | 70 | 68 |
| Resilience at 23° C. | % | 35 | 34 | 35 | 35 | 35 |
| Resilience at 70° C. | % | 56 | 56 | 56 | 56 | 52 |
| σ₅₀ | MPa | 2.5 | 2.4 | 2.3 | 2.3 | 2.1 |
| σ₁₀₀ | MPa | 6.1 | 6.3 | 5.7 | 5.7 | 4.3 |
| σ₂₀₀ | MPa | 18.7 | 17.8 | 17.4 | 16.1 | 12.7 |
| σ₃₀₀ | MPa | 26.9 | 25.7 | 25.7 | 23.8 | 20.2 |
| Tensile strength | MPa | 27.3 | 26.5 | 26.4 | 26.2 | 25.7 |
| ε_{b} | % | 310 | 310 | 315 | 360 | 425 |
| CS (70 h/23° C.) specimen 1 | % | 30.3 | 30.5 | 32.2 | 32.8 | 35.7 |
| CS (70 h/150° C.) specimen 2 | % | 19.3 | 20.3 | 20.4 | 22.6 | 24.8 |

TABLE 2
Experiment Series 2 (inventive examples apart from Example 2.1)
Influence of the addition of a sulphur compound on the
TPP and TPP═O contents of HNBR in the case of addition
to the HNBR solution in chlorobenzene prior to steam
distillation; without prior rhodium removal

| | Addition of sulphur compound | | | | Contents in HNBR | | |
|---|---|---|---|---|---|---|---|
| | | | | Molar ratio | after workup | | |
| | | Amount per | | of TPP/ | TPP | TPP═O | Total |
| | | 100 g HNBR | | sulphur | % by | % by | halogen |
| No. | Type | mg | mg | compound | wt. | wt. | ppm |
| 2.1 | — | — | — | — | 0.83 | 0.16 | |
| 2.2* | CBS | 124 | 0.47 | 8/1 | 0.57 | 0.41 | 750 |
| 2.3* | CBS | 254 | 0.96 | 4/1 | 0.44 | 0.56 | 710 |
| 2.4* | CBS | 502 | 1.9 | 2/1 | 0.2 | 0.73 | 820 |
| 2.5* | CBS | 1005 | 3.8 | 1/1 | <0.01 | 1.1 | 570 |
| 2.6* | TBBS | 908 | 3.8 | 1/1 | <0.01 | 1.07 | 700 |

TABLE 3
Experiment Series 3 (inventive apart from Example 3.1)
Influence of the addition of a sulphur compound on the TPP
and TPP═O contents of hydrogenated nitrile rubber in the
case of addition to the HNBR solution in chlorobenzene
prior to steam distillation; with prior rhodium removal

| | Addition of sulphur compound | | | | Contents in HNBR | | |
|---|---|---|---|---|---|---|---|
| | | | | Molar ratio | after workup | | |
| | | Amount per | | of TPP/ | TPP | TPP═O | Total |
| | | 100 g HNBR | | sulphur | % by | % by | halogen |
| No. | Type | [mg] | [mg] | compound | wt. | wt. | ppm |
| 3.1 | — | — | — | — | 0.82 | 0.18 | 710 |
| 3.2* | TDDM | 770 | 3.8 | 1/1 | 0.74 | 0.37 | 580 |
| 3.3* | MBT | 635 | 3.8 | 1/1 | 0.59 | 0.50 | 570 |
| 3.4* | CBS | 1005 | 3.8 | 1/1 | <0.01 | 0.99 | 600 |
| 3.5* | TBBS | 908 | 3.8 | 1/1 | <0.01 | 0.95 | 580 |

TABLE 4
Experiment Series 4 (inventive apart from Example 4.1)
Influence of the addition of a sulphur compound on the contents of
TPP and TPP═O of hydrogenated nitrile rubber in the case of prior
rhodium removal (incorporation of the sulphur compound on the roll)

| | Addition of sulphur compound | | | | Contents in HNBR | | |
|---|---|---|---|---|---|---|---|
| | | | | Molar ratio | after workup | | |
| | | Amount per | | of TPP/ | TPP | TPP═O | Total |
| | | 100 g HNBR | | sulphur | % by | % by | halogen |
| No.: | Type | mg | mg | compound | wt. | wt. | ppm |
| 4.1 | — | — | — | — | 1.73 | 0.16 | 46 |
| 4.2* | CBS | 2016 | 7.63 | 1/1 | 0.05 | 1.77 | 48 |
| 4.3* | CBS | 1008 | 3.81 | 2/1 | 0.48 | 1.57 | 45 |
| 4.4* | TBBS | 1815 | 7.61 | 1/1 | 0.08 | 2.17 | 48 |
| 4.5* | TBBS | 907 | 3.80 | 2/1 | 0.55 | 1.67 | 45 |
| 4.6* | MOZ | 1922 | 7.63 | 1/1 | 0.20 | 1.90 | 44 |
| 4.7* | MOZ | 961 | 3.81 | 2/1 | 0.45 | 1.70 | 45 |

TABLE 5a
Experiment Series 5a (inventive apart from Example 5.1)
Contents of TPP and TPP═O of hydrogenated nitrile rubber
(hydrogenated nitrile rubber with 3% by weight of TPP
(11.44 mmol/100 g HNBR) with rhodium removal

| | Sulphur compound | | | | | | | |
|---|---|---|---|---|---|---|---|---|
| | | | | Molar ratio | | Contents in HNBR | | |
| | | Amount per | | of TPP/ | | TPP | TPP═O | Total |
| | | 100 g HNBR | | sulphur | Mode of | % by | % by | halogen |
| No. | Type | mg | mmol | compound | addition | wt. | wt. | ppm |
| 5.1 | — | — | — | — | — | 2.45 | 0.19 | 49 |
| 5.2* | CBS | 3.327 | 12.60 | 0.9/1 | roll | <0.01 | 2.35 | 59 |
| 5.3* | CBS | 3.024 | 11.45 | 1/1 | roll | <0.01 | 2.42 | 52 |
| 5.4* | CBS | 2.722 | 10.31 | 1.1/1 | roll | <0.01 | 2.48 | 55 |
| 5.5* | TBBS | 2.727 | 11.46 | 1/1 | roll | <0.01 | 3.20 | 53 |
| 5.6* | TBBS | 1.364 | 5.73 | 2/1 | roll | 0.76 | 2.37 | 51 |
| 5.7* | MOZ | 2.822 | 10.29 | 1/1 | stripping | <0.01 | 3.16 | 110 |

The hydrogenated nitrile rubbers of Experiment Series 5a were used to produce rubber mixtures, which were subsequently vulcanized. The properties of the rubber mixtures and of the vulcanizates are summarized in Experiment Series 5b.

TABLE 5b
Experiment Series 5b (inventive apart from Example 5.1)
Mixture and vulcanizate properties of the hydrogenated
nitrile rubbers from Experiment Series 5a

| Product from Example | | 5.1 | 5.2* | 5.3* | 5.4* | 5.5* | 5.6* | 5.7* |
|---|---|---|---|---|---|---|---|---|
| TPP addition in hydrogenation | phr | 3.0 | 3.0 | 3.0 | 3.0 | 3.0 | 3.0 | 3.0 |

Mixture properties

| | | | | | | | | |
|---|---|---|---|---|---|---|---|---|
| ML1 + 4 @ 100° C. | MU | 106 | 107 | 111 | 116 | 112 | 107 | 104 |

Vulcameter at 180° C. (moving die rheometer)

| | | | | | | | | |
|---|---|---|---|---|---|---|---|---|
| t₁₀ | sec | 36 | 35 | 34 | 33 | 36 | 35 | 37 |
| t₅₀ | sec | 116 | 93 | 94 | 96 | 99 | 106 | 102 |
| t₉₀ | sec | 369 | 280 | 287 | 292 | 300 | 308 | 301 |
| 301t₉₅ | sec | 493 | 370 | 380 | 385 | 402 | 398 | 395 |
| t₉₀ − t₁₀ | sec | 333 | 245 | 253 | 259 | 264 | 273 | 264 |
| Fₘᵢₙ | dNm | 2.06 | 2.03 | 2.18 | 2.34 | 2.22 | 2.16 | 2.04 |
| Fₘₐₓ | dNm | 24.3 | 26.3 | 26.5 | 26.6 | 28.6 | 27.1 | 26.6 |
| Fₘₐₓ − Fₘᵢₙ | dNm | 22.24 | 24.27 | 24.32 | 24.26 | 26.38 | 24.94 | 24.56 |

Vulcanization at 14 min/180° C. (without thermal storage
prior to vulcanizate characterization)

| | | | | | | | | |
|---|---|---|---|---|---|---|---|---|
| Shore A hardness (23° C.) | | 68.5 | 69.6 | 69.9 | 70.2 | 70.7 | 70.7 | 69.6 |
| Shore A hardness (70° C.) | | 64 | 65.5 | 66 | 65.8 | 67 | 67.7 | 66 |
| Resilience at 23° C. | % | 45.5 | 42.8 | 42.7 | 42.8 | 43.0 | 43.2 | 43.2 |
| Resilience at 70° C. | % | 56.6 | 57.8 | 58.2 | 57.9 | 59.5 | 57.7 | 57.7 |
| σ₅₀ | MPa | 1.9 | 2.0 | 2.0 | 2.0 | 2.1 | 2.0 | 1.9 |
| σ₁₀₀ | MPa | 4.4 | 5.0 | 5.0 | 5.1 | 5.6 | 5.3 | 5.0 |
| σ₂₀₀ | MPa | 15.1 | 15.9 | 16.0 | 16.4 | 17.5 | 17.5 | 16.7 |
| σ₃₀₀ | MPa | 23.5 | 25.0 | 25.1 | 25.4 | 26.2 | 26.9 | 25.3 |
| Tensile strength | MPa | 25.5 | 27.5 | 27.7 | 27.8 | 26.1 | 27.8 | 27.8 |
| ε_{b} | % | 334 | 342 | 340 | 335 | 295 | 319 | 345 |
| CS (70 h/23° C.) DIN 53517; | % | 13.5 | 12.0 | 11.2 | 11.1 | 10.5 | 10.1 | 11.4 |
| specimen 1 | | | | | | | | |

TABLE 6a
Experiment Series 6a (inventive apart from Example 6.1)
Addition of TPP═O to hydrogenated nitrile rubber (addition on the roll)

| Experiment No. | | 6.1 = 1.1 | 6.2* | 6.3* | 6.4* | 6.5* |
|---|---|---|---|---|---|---|
| TPP added in | phr | 0 | 0 | 0 | 0 | 0 |
| hydrogenation | | | | | | |
| TPP═O addition | phr | 0 | 0.3 | 0.5 | 1.0 | 2.0 |
| in mixture | | | | | | |
| production | | | | | | |
| Analytically | % by wt. | <0.01 | <0.01 | <0.01 | <0.01 | <0.01 |
| determined | | | | | | |
| TPP content | | | | | | |
| Analytically | % by wt. | <0.01 | 0.29 | 0.48 | 0.99 | 2.01 |
| determined | | | | | | |
| TPP═O content | | | | | | |

TABLE 6b
Experiment Series 6b (inventive examples apart from Example 6.1)
Vulcanizate properties of the hydrogenated nitrile
rubbers produced in Experiment Series 6a

| | | | | | |
|---|---|---|---|---|---|
| Experiment No. | 6.1 = 1.1 | 6.2* | 6.3* | 6.4* | 6.5* |

Mixture properties

| | | | | | | |
|---|---|---|---|---|---|---|
| ML1 + 4 @ 100° C. | MU | 125 | 118 | 121 | 121 | 119 |
| ML1 + 4 @ 120° C. | MU | 84 | 84 | 87 | 86 | 84 |

Vulcameter at 180° C. (Bayer-Frank vulcameter)

| | | | | | | |
|---|---|---|---|---|---|---|
| t₁₀ | min | 1.4 | 1.4 | 1.4 | 1.4 | 1.4 |
| t₉₀ | min | 7.1 | 7.2 | 7.1 | 6.9 | 7.4 |
| t₉₀ − t₁₀ | min | 5.7 | 5.8 | 5.7 | 5.5 | 6.0 |
| Fₘᵢₙ | cN | 236 | 230 | 209 | 209 | 197 |
| Fₘₐₓ | cN | 5107 | 5015 | 4898 | 4866 | 4939 |
| Fₘₐₓ − Fₘᵢₙ | cN | 4871 | 4785 | 4689 | 4657 | 4742 |

Vulcanizate properties (vulcanization at 15 min/180° C.;
heat treatment at 6 h/150° C.)

| | | | | | | |
|---|---|---|---|---|---|---|
| Shore A hardness (23° C.) | | 73 | 72 | 72 | 73 | 72 |
| Shore A hardness (70° C.) | | 71 | 71 | 70 | 71 | 70 |
| Resilience at 23° C. | % | 35 | 35 | 34 | 34 | 34 |
| Resilience at 70° C. | % | 56 | 53 | 52 | 54 | 54 |
| σ₅₀ | MPa | 2.5 | 2.3 | 2.4 | 2.4 | 2.3 |
| σ₁₀₀ | MPa | 6.1 | 6.2 | 6.6 | 6.8 | 6.4 |
| σ₂₀₀ | MPa | 18.7 | 19.4 | 20 | 19.9 | 19.5 |
| Tensile strength | MPa | 27.3 | 28.8 | 29.1 | 29.1 | 28.5 |
| ε_{b} | % | 310 | 305 | 300 | 300 | 295 |
| CS (70 h/150° C.); specimen 1 | % | 30.5 | 28.5 | 27.0 | 27.2 | 26.9 |
| CS (70 h/150° C.); specimen 2 | % | 19.3 | 19.1 | 18.3 | 18.9 | 18.5 |

1. Hydrogenated nitrile rubber comprising:
i) 0 to 1.0 wt % of phosphines, diphosphines or mixtures thereof, based on the hydrogenated nitrile rubber,
ii) 0.25 to 6 wt % of phosphine oxides, diphosphine oxides or mixtures thereof, based on the hydrogenated nitrile rubber, and
iii) 25 to 10,000 ppm total halogen content.

2. The hydrogenated nitrile rubbers according to claim 1, wherein:
a) the nitrile rubber contains no phosphines or diphosphines; or
b) the nitrile rubber comprises greater than 0 to 1.0 wt % of the phosphines, the diphosphines, or the mixture thereof, and the nitrile rubber comprises, as component (i):
a phosphine of the general formula (1-a), 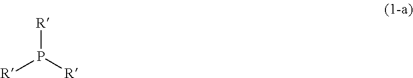
in which
R′ are the same or different and are each alkyl, alkenyl, alkadienyl, alkoxy, aryl, heteroaryl, cycloalkyl, cycloalkenyl, cycloalkadienyl, halogen or trimethylsilyl, and/or
a diphosphine of the general formula (1-b), 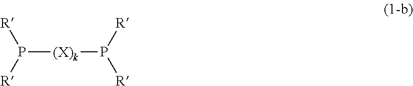
in which
R′ are the same or different and are each alkyl alkenyl, alkadienyl, alkoxy, aryl, heteroaryl, cycloalkyl, cycloalkenyl, cycloalkadienyl, halogen or trimethylsilyl,
k is 0 or 1, and
X is a straight-chain or branched alkanediyl, alkenediyl or alkynediyl group.

3. The hydrogenated nitrile rubbers according to claim 2, wherein:
the phosphines of the general formula (1-a) are selected from the group consisting of PPH₃, P(p-Tol)₃, P(o-Tol)₃, PPH(CH₃)₂, P(CF₃)₃, P(p-FC₆H₄)₃, P(p-CF₃C₆H₄)₃, P(C₈H₄—SO₃Na)₃, P(CH₂C₆H₄—SO₃Na)₃, P(iso-Pr)₃, P(CHCH₃(CH₂CH₃))₃, P(cyclopenlyl)₃, P(cyclohexyl)₃, P(neopentyl)₃, P(C₆H₅CH₂)(C₆H₅)₂, P(NCCH₂CH₂)₂(C₆H₅), P[(CH₃)₃C]₂Cl, P[(CH₃)₃C]₂(CH₃), P(tert-Bu)₂(biph), P(C₆H₁₁)₂Cl, P(CH₃)(OCH₂CH₃)₂, P(CH₂═CHCH₂)₃, P(C₄H₃O)₃P(CH₂OH)₃, (m-CH₃OC₆H₄)₃, P(C₆F₅)₃, or P[(CH₃)₃Si]₃, P[(CH₃O)₃C₆H₂]₃, and
the diphosphine of the general formula (1-b) are selected from the group consisting of Cl₂PCH₂CH₂PCl₂, (C₂H₁₁)₂PCH₂P(C₆H₁₁),(CH₃)₂PCH₂CH₂P(CH₃)₂, (C₆H₅)₂PCCP(C₆H₅)₂, (C₆H₅)₂PCH═CHP(C₆H₅)₂, (C₆F₅)₂P(CH₂)₂P(C₆F₅)₂, (C₆H₅)₂P(CH₂)₂P(C₆H₅)₂, (C₆H₅)₂P(CH₂)₃P(C₆H₅)₂, (C₆H₅)₂P(CH₂)₄P(C₆H₅)₂, or (C₆H₅)₂P(CH₂)₅P(C₅H₅)₂, (C₆H₅)₂PCH(CH₃)CH(CH₃)P(C₆H₅)₂ or (C₆H₅)₂PCH(CH₃)CH₂P(C₆H₅)₂,
where Ph is phenyl, Tol is tolyl, biph is bisphenyl, Bu is butyl and Pr is propyl.

4. The hydrogenated nitrile rubbers according to claim 1, wherein the phosphine component (i) is triphenylphosphine.

5. The hydrogenated nitrile rubbers according to claim 1, wherein the phosphine oxide or diphosphine oxide component (ii) comprises;
oxides of phosphines of the general formula
(1-a) 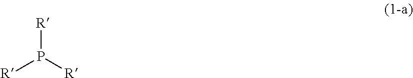
in which
R are the same or different and are each alkyl, alkenyl, alkadienyl, alkoxy, aryl, heteroaryl, cycloalkyl, cycloalkenyl, cycloalkadienyl, halogen or trimethylsilyl, and/or
oxides of diphosphines of the general formula (1-b), 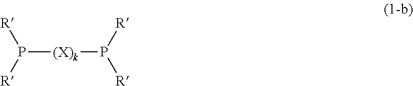
in which
R are the same or different and are each alkyl, alkenyl, alkadienyl, alkoxy, aryl, heteroaryl, cycloalkyl, cycloalkenyl, cycloalkadienyl, halogen or trimethylsilyl,
k is 0 or 1, and
X is a straight-chain or branched alkanediyl, alkenediyl or alkynediyl group.

6. The hydrogenated nitrile rubbers according to claim 1 wherein the phosphine oxide component (ii) triphenylphosphine oxide.

7. The hydrogenated nitrile rubbers according to claim 1 wherein the nitrile rubber comprises repeating units derived from at least acrylonitrile and 1,3-butadiene.

8. A process for producing the hydrogenated nitrile rubbers according to claim 1, the process comprising contacting a hydrogenated nitrile rubber having 0.15 to 5 wt % of phosphines, diphosphines or mixtures thereof based on the hydrogenated nitrile rubber, and at least one sulphur compound which does not have two sulphur atoms covalently bonded directly to one another.

9. The process according to claim 8, wherein the at least one sulphur compound comprises at least one Sulphur compound of the general formulae (1)-(10) 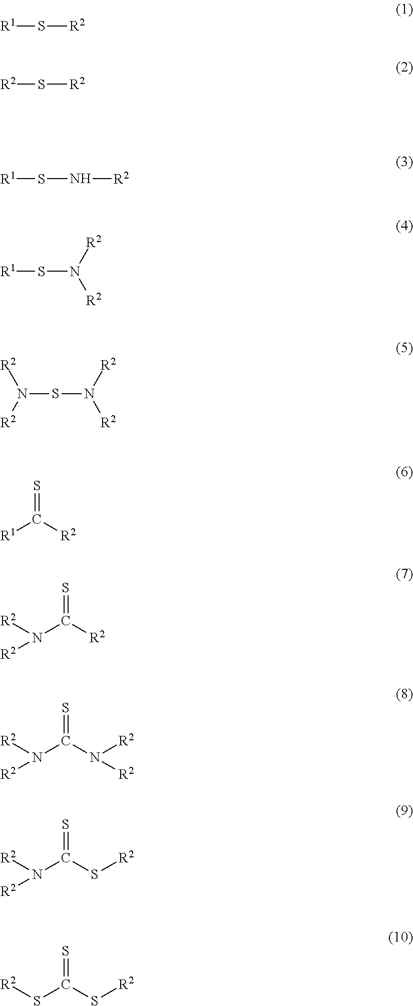
in which
R¹ may be a linear or branched, aliphatic, cycloaliphatic or aromatic radical which may contain up to 10 heteroatoms selected from the group consisting of nitrogen, oxygen, sulphur and phosphorus, with the proviso that, when sulphur is present as heteroatom, it does not directly adjoin any further sulphur atom in the compound,
R² is the same or different and is hydrogen, an alkali metal, alkaline earth metal, ammonium or substituted ammonium, phosphonium or substituted phosphonium, or a linear, branched, aliphatic, cycloaliphatic or aromatic radical which may contain up to 10 heteroatoms selected from the group consisting of nitrogen, oxygen, sulphur and phosphorus, likewise with the proviso that, when sulphur is present as heteroatom, it does not directly adjoin any further sulphur atom in the compound, or alternatively
R¹ and R² or else two R² may form a cyclic system incorporating the atoms to which they are bonded.

10. The process according to claim 8, wherein the at least one sulphur compound which does not have two sulphur atoms bonded directly to one another is selected from the group consisting of n-butyl mercaptan, tert-butyl mercaptan, n-hexyl mercaptan, n-dodecyl mercaptan, tert-dodecyl mercaptan, benzyl mercaptan, dibenzyl sulphide, 2-mercaptobenzethiazole, 2-morpholinobenzothiazole, N-cyclohexyl-2-benzothiazylsulphenamide, N,N-dicyclohexylbenzothiazylsulphenamide, N-tert-butyl-2-benzothiazylsulphenamide and N-cyclohexylthiophthallimide.

11. The process according to claim 8, wherein the molar amount of sulphur compound (calculated as S) is 5 to 300% of the phosphine or diphosphine.

12. The process according to claim 8, wherein at least 50 mol % of the phosphines or diphosphines are converted to phosphine oxides or diphosphine oxides.

13. The process according to claim 8, further comprising:
(1) catalytically hydrogenating a nitrile rubber in organic solution and in the presence of a phosphine or diphosphine, wherein the phosphine or diphosphine (a) is present as a ligand in the hydrogenation catalyst without further addition of phosphine or diphosphine as a cocatalyst, or (b) is present as a ligand in the hydrogenation catalyst and additionally is added as a cocatalyst, or (c) is added as a cocatalyst, but with no phosphine or diphosphine present as ligand(s) in the hydrogenation catalyst, and
(2) contacting the hydrogenated nitrile rubber obtained, before, during or after isolation of the hydrogenated nitrile rubber, with the at least one sulphur donor in a separate mixing operation.

14. The process according to claim 13, wherein the hydrogenation is done in the presence of a hydrogenation catalyst selected from the group consisting of tris(triphenylphosphine)rhodium(I) chloride, tris(triphenylphosphine)rhodium(III) chloride, tris(dimethyl sulphoxide)rhodium(III) chloride, hydridorhodiumtetrakis(triphenylphosphine) or the corresponding compounds in which triphenylphosphine has been replaced wholly or partly by tricyclohexylphosphine.

15. Vulcanizable mixtures comprising at least one hydrogenated nitrile rubber according to claim 1 and at least one crosslinking system comprising at least one crosslinker and optionally one or more crosslinking accelerators.

16. A process for producing vulcanizates, the process comprising vulcanizing a vulcanizable mixture according to claim 15 in the course of a shaping process at a temperature of 100° C. to 200° C.

17. Vulcanizates obtained by the process according to claim 16.

18. The hydrogenated nitrile rubber according to claim 1, wherein the nitrile rubber contains no phosphines or diphosphines as component (i).

19. The hydrogenated nitrile rubber according to claim 2, wherein:
the nitrile rubber comprises greater than 0 to 0.9 wt % of component (i), and 0.3 to 5 wt % of component (ii), based on the hydrogenated nitrile rubber, and 35 to 1000 ppm halogen;
the phosphines of component (i) and the phosphine portion of the phosphine oxides of component (ii) are selected from the group consisting of PPh₃, P(p-Tol)₃, P(o-Tol)₃, PPh(CH₃)₂, P(CF₃)₃, P(p-FC₆H₄)₃, P(p-CF₃C₆H₄)₃, P(C₆H₄—SO₃Na)₃, P(CH₂C₆H₄—SO₃Na)₃, P(iso-Pr)₃, P(CHCH₃(CH₂CH₃))₃, P(cyclopentyl)₃, P(cyctohexyl)₃, P(neopentyl)₃, P(C₆H₅CH₂)(C₆H₅)₂, P(NCCH₂CH₂)₂(C₆H₅), P[(CH₃)₃C]₂Cl, P[(CH₃)₃C]₂(CH₃), P(tert-Bu)₂(biph), P(C₆H₁₁)₂Cl, P( CH₃)( OCH₂CH₃)₂, P(CH₂═CHCH₂)₃, P(C₄H₃O)₃, P(CH₂OH)₃, P(m-CH₃OC₆H₄)₃, P(C₆F₅)₃, P[(CH₃)₃Si]₃, and P[(CH₃O)₃C₆H₂]₃, and
the diphosphines of component (i) and the diphosphine portion of the diphosphine oxides of component (ii) are selected from the group consisting of Cl₂PCH₂CH₂PCl₂, (C₆H₁₁)₂PCH₂P(C₆H₁₁), (CH₃)₂PCH₂CH₂P(CH₃)₂(C₆H₅)₂PCCP(C₆H₅)₂, (C₆H₅)₂PCH═CHP(C₆H₅)₂, (C₈F₅)₂P(CH₂)₂P(C₆F₅)₂, (C₆H₅)₂P(CH₂)₂P(C₆H₅)₂, (C₆H₅)₂P(CH₂)₃P(C₆H₅)₂, (C₆H₅)₂P(CH₂)₄P(C₈H₅)₂, (C₆H₅)₂(CH₂)₅P(C₆H₅)₂, (C₆H₅)₂PCH(CH₃)CH(CH₃)P(C₆H₅)₂, and (C₆H₅)₂PCH(CH₃)CH₂P(C₆H₅)₂,
where Ph is phenyl, Tol is tolyl, biph is biphenyl, Bu is butyl and PR is propyl

20. The hydrogenated nitrile rubber according to claim 2, wherein;
the nitrile rubber comprises greater than 0 to 0.85 wt % of component (i), and 0.35 to 4 wt % of component (ii), based on the hydrogenated nitrile rubber, and 40 to 850 ppm halogen;
the phosphine component (s) is triphenylphosphine;
the phosphine oxide component (ii) is triphenylphosphine oxide; and
the nitrile rubber comprises repeating units derived from;
acrytonitrile and 1,3-butadiene, or
acrylonitrile, 1,3-butadiene, and one or more alkyl esters of an α,β-unsaturated carboxylic acid selected from the group consisting of methyl (meth)acrylate, ethyl (meth)acrylate, propyl (meth)acrylate, n-butyl (meth)acrylate, t-butyl (methacrylate, hexyl (meth)acrylate, 2-ethylhexyl (meth)acrylate, octyl (meth)acrylate and lauryl (meth)acrylate.
